(19) United States
(12) Patent Application Publication
(10) Pub. No.: US 2026/0147698 A1
(43) Pub. Date: May 28, 2026

(54) Artificial Intelligence (AI) Assisted Automation of Testing in Software Environments

(71) Applicant: Istari Digital, Inc., Charleston, SC (US)

(72) Inventors: William Roper, Jr., Charleston, SC (US); Christopher Lee Benson, Arlington, VA (US); Sriram Krishnan, Cambridge, MA (US); Najem Aldeen Abu Rmaileh, Amman (JO); Moaath A. M. Shalabi, Amman (JO); Antoine M. Baqain, Boppard (DE); James C. Pavur, Arlington, VA (US); Baha aldeen E. A. Abunojaim, Roslindale, MA (US)

(21) Appl. No.: 19/376,934

(22) Filed: Nov. 1, 2025

Related U.S. Application Data
(63) Continuation of application No. PCT/US24/42768, filed on Aug. 16, 2024.
(60) Provisional application No. 63/520,643, filed on Aug. 20, 2023.

(51) Int. Cl. G06F 11/3668

(52) U.S. Cl. CPC G06F 11/3688

(57) ABSTRACT

Methods and systems for artificial intelligence (AI) assisted automation of testing of a software functionality related to a user intent on a software platform is provided. In one embodiment, the method includes receiving user action data indicating the user intent related to a software platform and generating a human-readable test scenario. The test scenario, which includes a sequence of human-readable testing steps and an expected outcome, is generated using a scenario machine learning (ML) model. The method includes generating an interpretable test script based on the test scenario using a script ML model. The test script is interpreted to implement testing steps on the software platform, generating a test outcome. A human-readable test report is also generated to evaluate the test scenario on the software platform, based on the test outcome and the expected outcome.

### REFERENCE TO RELATED APPLICATIONS

If an Application Data Sheet (“ADS”) or PCT Request Form (“Request”) has been filed on the filing date of this application, it is incorporated by reference herein. Any applications claimed on the ADS or Request for priority under 35 U.S.C. §§ 119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

Furthermore, this application is related to the U.S. patent applications listed below, which are incorporated by reference in their entireties herein, as if fully set forth herein:
PCT application No. PCT/US24/40624 (Docket No. IST-03.003PCT), filed on Aug. 1, 2024, entitled “Machine Learning Engine for Workflow Enhancement in Digital Workflows,” describes workflow enhancement for digital software platforms.
PCT application No. PCT/US24/40468 (Docket No. IST-03.004PCT), filed on Jul. 31, 2024, entitled “Multimodal User Interfaces for Interacting with Digital Model Files,” describes multimodal user interfaces for digital software platforms.
PCT application No. PCT/US24/38878 (Docket No. IST-03.002PCT), filed on Jul. 19, 2024, entitled “Generative Artificial Intelligence (AI) for Digital Workflows,” describes efficient AI-assisted script generation methods that preserve customer data sovereignty.
PCT application No. PCT/US24/35885 (Docket No. IST-02.002PCT), filed on Jun. 27, 2024, entitled “Artificial Intelligence (AI) Assisted Integration of New Digital Model Types and Tools into Integrated Digital Model Platform,” describes the enhancement of model splicer technology through AI-assistance.
PCT application No. PCT/US24/27912 (Docket No. IST-02.003PCT), filed on May 5, 2024, entitled “Secure and Scalable Sharing of Digital Engineering Documents,” describes secure and scalable document splicing technology.
PCT application No. PCT/US24/27898 (Docket No. IST-03.001PCT), filed on May 4, 2024, entitled “Digital Twin Enhancement using External Feedback within Integrated Digital Model Platform,” describes digital and physical twin management and the integration of external feedback within a DE platform.
PCT application No. PCT/US24/19297 (Docket No. IST-01.002PCT), filed on Mar. 10, 2024, entitled “Software-Code-Defined Digital Threads in Digital Engineering Systems with Artificial Intelligence (AI) Assistance,” describes AI-assisted digital threads for digital engineering platforms.
PCT application No. PCT/US24/18278 (Docket No. IST-02.001PCT), filed on Mar. 3, 2024, entitled “Secure and Scalable Model Splicing of Digital Engineering Models for Software-Code-Defined Digital Threads,” describes model splicing for digital engineering platforms.
PCT application No. PCT/US24/14030 (Docket No. IST-01.001PCT), filed on Feb. 1, 2024, entitled “Artificial Intelligence (AI) Assisted Digital Documentation for Digital Engineering,” describes AI-assisted documentation for digital engineering platforms.
U.S. provisional patent application No. 63/442,659 (Docket No. IST-01.001P), filed on Feb. 1, 2023, entitled “AI-Assisted Digital Documentation for Digital Engineering with Supporting Systems and Methods,” describes AI-assistance tools for digital engineering (DE), including modeling and simulation applications, and the certification of digitally engineered products.
U.S. provisional patent application No. 63/451,545 (Docket No. IST-01.002P), filed on Mar. 10, 2023, entitled “Digital Threads in Digital Engineering Systems, and Supporting AI-Assisted Digital Thread Generation,” describes model splicer and digital threading technology.
U.S. provisional patent application No. 63/451,577 (Docket No. IST-02.001P1), filed on Mar. 11, 2023, entitled “Model Splicer and Microservice Architecture for Digital Engineering,” describes model splicer technology.
U.S. provisional patent application No. 63/462,988 (Docket No. IST-02.001P2), filed on Apr. 29, 2023, also entitled “Model Splicer and Microservice Architecture for Digital Engineering,” describes model splicer technology.
U.S. provisional patent application No. 63/511,583 (Docket No. IST-02.002P), filed on Jun. 30, 2023, entitled “AI-Assisted Model Splicer Generation for Digital Engineering,” describes model splicer technology with AI-assistance.
U.S. provisional patent application No. 63/516,624 (Docket No. IST-02.003P), filed on Jul. 31, 2023, entitled “Document and Model Splicing for Digital Engineering,” describes document splicer technology.
U.S. provisional patent application No. 63/520,643 (Docket No. IST-02.004P), filed on Aug. 20, 2023, entitled “Artificial Intelligence (AI)-Assisted Automation of Testing in a Software Environment,” describes software testing with AI-assistance.
U.S. provisional patent application No. 63/590,420 (Docket No. IST-02.005P), filed on Oct. 14, 2023, entitled “Commenting and Collaboration Capability within Digital Engineering Platform,” describes collaborative capabilities.
U.S. provisional patent application No. 63/586,384 (Docket No. IST-02.006P), filed on Sep. 28, 2023, entitled “Artificial Intelligence (AI)-Assisted Streamlined Model Splice Generation, Unit Testing, and Documentation,” describes streamlined model splicing, testing and documentation with AI-assistance.
U.S. provisional patent application No. 63/470,870 (Docket No. IST-03.001P), filed on Jun. 3, 2023, entitled “Digital Twin and Physical Twin Management with Integrated External Feedback within a Digital Engineering Platform,” describes digital and physical twin management and the integration of external feedback within a DE platform.
U.S. provisional patent application No. 63/515,071 (Docket No. IST-03.002P), filed on Jul. 21, 2023, entitled “Generative Artificial Intelligence (AI) for Digital Engineering,” describes an AI-enabled digital engineering task fulfillment process within a DE software platform.
U.S. provisional patent application No. 63/517,136 (Docket No. IST-03.003P), filed on Aug. 2, 2023, entitled “Machine Learning Engine for Workflow Enhancement in Digital Engineering,” describes a machine learning engine for model splicing and DE script generation.
U.S. provisional patent application No. 63/516,891 (Docket No. IST-03.004P), filed on Aug. 1, 2023, entitled “Multimodal User Interfaces for Digital Engineering,” describes multimodal user interfaces for DE systems.
U.S. provisional patent application No. 63/580,384 (Docket No. IST-03.006P), filed on Sep. 3, 2023, entitled “Multimodal Digital Engineering Document Interfaces for Certification and Security Reviews,” describes multimodal user interfaces for certification and security reviews.
U.S. provisional patent application No. 63/613,556 (Docket No. IST-03.008P), filed on Dec. 21, 2023, entitled “Alternative Tool Selection and Optimization in an Integrated Digital Engineering Platform,” describes tool selection and optimization.
U.S. provisional patent application No. 63/584,165 (Docket No. IST-03.010P), filed on Sep. 20, 2023, entitled “Methods and Systems for Improving Workflows in Digital Engineering,” describes workflow optimization in a DE platform.
U.S. provisional patent application No. 63/590,456 (Docket No. IST-04.001P), filed on Oct. 15, 2023, entitled “Data Sovereignty Assurance for Artificial Intelligence (AI) Models,” relates to data sovereignty assurance during AI model training and evaluation.
U.S. provisional patent application No. 63/606,030 (DocketNo. IST-04.001P2), filed on Dec. 4, 2023, also entitled “Data Sovereignty Assurance for Artificial Intelligence (AI) Models,” further details data sovereignty assurances during AI model training and evaluation.
U.S. provisional patent application No. 63/419,051, filed on Oct. 25, 2022, entitled “Interconnected Digital Engineering and Certification Ecosystem.”
U.S. non-provisional patent application Ser. No. 17/973,142 (Docket No. 54332-0057001) filed on Oct. 25, 2022, entitled “Interconnected Digital Engineering and Certification Ecosystem.”
U.S. non-provisional patent application Ser. No. 18/383,635 (Docket No. 54332-0059001), filed on Oct. 25, 2023, entitled “Interconnected Digital Engineering and Certification Ecosystem.”
U.S. provisional patent application No. 63/489,401, filed on Mar. 9, 2023, entitled “Security Architecture for Interconnected Digital Engineering and Certification Ecosystem.”

### NOTICE OF COPYRIGHTS AND TRADE DRESS

A portion of the disclosure of this patent document contains material which is subject to copyright protection. This patent document may show and/or describe matter which is or may become traders of the owner. The copyright and tradedress owner has no objection to the facsimile reproduction by anyone of the patent disclosure as it appears in the U.S. Patent and Trademark Office files or records, but otherwise reserves all copyright and tradedress rights whatsoever.

ISTARI DIGITAL is a trademark name carrying embodiments of the present invention, and hence, the aforementioned trademark name may be interchangeably used in the specification and drawings to refer to the products/process offered by embodiments of the present invention. The terms ISTARI and ISTARI DIGITAL may be used in this specification to describe the present invention, as well as the company providing said invention.

### FIELD OF THE INVENTION

This disclosure relates to software testing. Specifically, this disclosure relates to the application of artificial intelligence (AI) in the testing of software in complex systems.

### BACKGROUND OF THE INVENTION

The statements in the background of the invention are provided to assist with understanding the invention and its applications and uses, and may not constitute prior art.

Software testing generally is a complex endeavor that is manually performed by expensive teams of software experts. Recent developments in artificial intelligence (AI) and machine learning (ML) have opened new doors for process automation, generative design, and data analytics in software testing. Despite the latest advances in natural language processing, the applicability of transformer-based Large Language Models (LLMs) in testing over a software platform is yet unproven.

One area of application of software testing is in the field of digital engineering (DE), which is an integrated digital approach to systems engineering. In DE, using authoritative sources of system data and models as a continuum across disciplines supports lifecycle activities from conception through disposal. Disparate engineering tools from multiple disciplines are necessary to enable DE, from design to validation, verification, manufacturing, to certification of complex systems, yet these DE tools and the models they generate are siloed in different engineering software platforms. Robust and efficient integration of data and models from the siloed tools is one of the largest expenses in DE and requires massive teams of highly-specialized engineers and software developers, while cross-platform collaboration is often impeded by the mismatch of software skill sets among highly expensive subject matter experts (SMEs), given the sheer number of different DE model types in use today. Furthermore, large-scale multidisciplinary integration for system-level assessment is far from maturing to efficiently model intricate interactions in large complex systems.

In the realm of DE, testing plays a pivotal role in ensuring the functionality and reliability of digital engineering systems. Testing involves the process of executing software scripts within a system with the intent of finding errors or discrepancies. This process leverages clearly defined scenarios to pinpoint root causes and subsequently deploy the appropriate software engineering scripts. It serves to verify remedial solutions implemented within the digital engineering system. Testing methodologies range from unit testing, where individual system components are tested independently, to integration testing, which assesses interactions between various components. The primary aim is to unearth any oversights from the design and development stages, thereby enhancing the overall system's quality. Testing in digital engineering encompasses quality assurance (QA) testing, quality control (QC) testing, usability testing, and end-to-end testing. Testing in digital engineering also encompasses performance testing, which assesses how a system performs under a particular workload, and security testing, which checks for vulnerabilities that could be exploited by attackers.

Quality assurance (QA) testing is a systematic process that ensures a product or service meets specified requirements. It is a proactive process that focuses on improving the development and test processes to prevent defects before they occur. On the other hand, quality control (QC) testing is a reactive process and focuses on identifying and correcting defects in the finished product before it is released.

Usability testing employs a user-based evaluation approach to assess a product or service. Often viewed as a form of black box testing, the focus is primarily on the user interface and overall product experience rather than stringent technical aspects. On the contrary, end-to-end testing is a thorough evaluation method of the entire software system including its integration with external interfaces. This testing approach, carried out under real-world scenarios from initiation to completion, ensures that all interconnected system components function seamlessly as expected. These tests are integral to ensuring that the system can handle real-world demands and protect sensitive data. With the increasing complexity of digital systems, the importance of comprehensive and rigorous testing cannot be overstated. It is a proactive measure to mitigate risks, enhance user experience, and ultimately, ensure the success of the digital product.

Therefore, in view of the aforementioned difficulties, there is an unsolved need to provide a software platform that integrates a plethora of tools to enable streamlined testing of software and complex systems. Accordingly, it would be an advancement in the state of the art to enable AI-assistance in testing.

It is against this background that various embodiments of the present invention were developed.

### BRIEF SUMMARY OF THE INVENTION

This summary of the invention provides a broad overview of the invention, its application, and uses, and is not intended to limit the scope of the present invention, which will be apparent from the detailed description when read in conjunction with the drawings.

The advent of model splicing as described below, and as further described in PCT applications No. PCT/US24/35885 (Docket No. IST-02.002PCT), PCT/US24/27912 (Docket No. IST-02.003PCT), PCT/US24/27898 (Docket No. IST-03.001PCT), PCT/US24/19297 (Docket No. IST-01.002PCT), PCT/US24/18278 (Docket No. IST-02.001PCT), and PCT/US24/14030 (Docket No. IST-01.001PCT), enables the scripting of digital workflow operations encompassing disparate software tools into a corpus of normative program code. As a consequence, a large space of digital workflows can be threaded into program code, including digital model generation, model modification, model data sharing, digital thread generation, thread modification, thread data extraction, thread data sharing, digital twin generation, digital twin modification, digital twin data extraction, digital twin sharing, etc. In turn, the transformation of digital workflow operations into code enables the generation and training of AI modules for the purpose of manipulating digital models, digital threads, and digital twins.

The methods and systems described herein enable AI-assisted cross-tool scripting of any digital workflow task for the creation, manipulation, and testing of digital model files, digital threads, and digital twins, thus potentially leading to dramatic reductions in cost and delays throughout digital workflows and all phases of any digitally engineered product's lifecycle.

An Artificial Intelligence (AI)-assisted approach to the creation, manipulation, linking, sharing, and modification of the data encompassed within digital model files may utilize a combination of machine learning (ML) techniques to create orchestration scripts that analyze and extract relevant information, implement appropriate operations, functions and parameters, control software tools, and implement the optimal sequence of steps for creating or modifying a digital twin, a digital thread, or an underlying digital model file. This allows for efficient, programmable, machine-learnable, and dynamic changes to the model files, and ultimately to the entire digital workflow.

“Model splicer generation” creates input and output schema for model splices, as well as a library or pipeline of scripts that can be selectively integrated into any particular model splice. A “model splicer” for a given DE model type, when applied to a specific digital model file of the DE model type, extracts model data from the model file, instantiates API endpoints according to input/output schemas, and encapsulates a set of selected scripts that allow access and modification of the model data.

The advent of model splicing thus enables the scripting of DE model operations encompassing disparate DE tools into a corpus of normative program code. That is, both DE models and DE tool interfaces are written as code, which in turn can be universally customized and automated within a unified DE platform for the creation, manipulation, and testing of complex systems comprising digital models, digital threads, and digital twins. This enables powerful AI tools to be applied to model splicing, as described in PCT application No. PCT/US24/35885 (Docket No. IST-02.002PCT) and PCT application No. PCT/US24/27912 (Docket No. IST-02.003PCT), as well as to cross-tool scripting of any DE testing operation involving digital engineering model files, digital threads, and digital twins, as described in PCT application No. PCT/US24/38878 (Docket No. IST-03.002PCT).

Such effortless, AI-assisted integration of new DE tools and components into a code-based DE development platform enhances the platform's capabilities and performance while minimizing disruptions and delays, potentially leading to dramatic reductions in cost and time throughout all phases of any digitally-engineered product's lifecycle.

An artificial intelligence (AI)-assisted approach to the testing within a DE platform may utilize a combination of machine learning (ML) techniques to create scripts that carry out key testing steps. This allows for programmable, machine-learnable, and dynamic changes to the testing scripts, and ultimately to a programmable and streamlined testing process across the various siloed DE tools.

Broadly, the methods and systems described herein are directed to the training and use of ML models for test scenario generation, test script creation, and preparation of test reports upon execution of test scripts.

Accordingly, various methods, processes, systems, and non-transitory storage medium storing program code for executing processes for artificial intelligence (AI)-assisted testing of a software functionality related to user intent, are provided.

In a first aspect or in one embodiment, a non-transitory physical storage medium storing program code is provided. The program code is executable by a processor. The program code when executed by the processor causes the processor to execute a computerized process for artificial intelligence (AI)-assisted testing of a software functionality related to user intent. The program code may include code to receive a user action data indicating a user intent related to a software platform. The user action data may comprise one or more operations performed by a user on the software platform to achieve the user intent. The user intent may comprise an outcome desired by the user when interacting with the software platform. The program code may include code to generate a test scenario based on the user action data, using a scenario machine learning (ML) model. The test scenario may be human-readable. The test scenario may comprise a sequence of human-readable testing steps and an expected outcome that are related to the user intent. The sequence of human-readable testing steps may be carried out on the software platform to evaluate a performance of the software platform in accomplishing the user intent. The scenario ML model may have been trained on a scenario training data set comprising a plurality of sample scenario pairs. Each scenario pair may consist of sample user action data indicating a sample user intent, and a corresponding sample test scenario related to the sample user intent. The program code may include code to generate a test script based on the test scenario using a script machine learning (ML) model. The test script may be interpretable on the software platform. The test script, when interpreted on the software platform, may implement at least one testing step of the sequence of human-readable testing steps. The script ML model may have been trained on a script training data set comprising a plurality of sample script pairs. Each sample script pair may consist of a sample test scenario and a corresponding sample test script implementing the sample test scenario. The program code may include code to generate a test outcome related to the human-readable test scenario by interpreting the test script on an interpreter operatively connected to the software platform. Interpreting the test script may comprise interpreting the at least one testing step and causing an implementation of the at least one testing step on the software platform. The program code may include code to generate a test report based on the test outcome and the expected outcome. The test report may be a human-readable report comprising an evaluation of the test scenario on the software platform from the at least one testing step.

In another embodiment, the software platform is an interconnected digital engineering platform (IDEP).

In another embodiment, the program code further comprises code to collect, on the IDEP, the user action data describing the user intent.

In another embodiment, the software functionality designated for testing is part of a software tool of the IDMP. The at least one testing step, when implemented, may interact with the software tool of the IDMP.

In another embodiment, the test script, when interpreted, takes an action selected from the group consisting of accessing a model representation, generating a model representation, and modifying a model representation.

In another embodiment, the at least one test step requires access to a digital artifact through the model representation. The test script may access the digital artifact.

In another embodiment, the model representation comprises a model splice connected to a digital model file. The model splice may comprise one or more splice data items and a splice function providing an Application Programming Interface (API) or Software Development Kit (SDK) endpoint to access the digital artifact.

In another embodiment, the human-readable test scenario is selected from the group consisting of a quality assurance (QA) test scenario, a quality control (QC) test scenario, a usability test scenario, an end-to-end test scenario, a performance test scenario, and a security test scenario.

In another embodiment, the user action data comprises one of a user action, a usage workflow, and an interface component pointer mapping.

In another embodiment, the usage workflow comprises one of a model type file, an instruction, a test script, and a test report.

In another embodiment, the user action data is collected using a collection script generated by a collection ML model.

In another embodiment, the collection ML model is trained on a data set comprising sample software tools and corresponding sample collection scripts.

In another embodiment, the collection script is inserted into a system page of the software platform.

In another embodiment, the collection script comprises scripting code.

In another embodiment, the test scenario is a usability test scenario. The user action data may comprise one of a bug report from the user, a troubleshooting step, a corrective action, and a final script used to rectify an issue.

In another embodiment, the user action data comprises one or more bug reports generated using a project management software tool.

In another embodiment, the scenario ML model is trained on a data set comprising sample prior bugs and corresponding sample human-readable test scenarios.

In another embodiment, the scenario ML model is trained on a data set comprising sample user bug reports and corresponding bug fixes generated using a project management software tool.

In another embodiment, the sequence of human-readable testing steps comprises a plurality of user actions.

In another embodiment, the test scenario is analyzed and approved by a human expert.

In another embodiment, the scenario ML model comprises a transformer.

In another embodiment, the scenario ML model comprises a large language model (LLM).

In another embodiment, the test scenario is a synthetic test scenario generated by the scenario ML model by varying parameters of an initial example test scenario across a broader test parameter set.

In another embodiment, the test script is analyzed and approved by a human expert.

In another embodiment, the script ML model comprises a transformer.

In another embodiment, the script ML model comprises a large language model (LLM).

In another embodiment, the test script is configured to mimic a human testing action. The mimicked human testing action may comprise one of clicking on a button, filling out a form, and navigating through a website.

In a second aspect or in another embodiment, a system for artificial intelligence (AI)-assisted testing of a software functionality related to user intent is provided. The system includes at least one processor and a non-transitory storage medium. The non-transitory storage medium stores program code, the program code executable by the at least one processor, to cause the at least one processor to execute a process artificial intelligence (AI)-assisted testing of a software functionality related to user intent. The program code may include code to receive a user action data indicating a user intent related to a software platform. The user action data may comprise one or more operations performed by a user on the software platform to achieve the user intent. The user intent may comprise an outcome desired by the user when interacting with the software platform. The program code may include code to generate a test scenario based on the user action data, using a scenario machine learning (ML) model. The test scenario may be human-readable. The test scenario may comprise a sequence of human-readable testing steps and an expected outcome that are related to the user intent. The sequence of human-readable testing steps may be carried out on the software platform to evaluate a performance of the software platform in accomplishing the user intent. The scenario ML model may have been trained on a scenario training data set comprising a plurality of sample scenario pairs. Each scenario pair may consist of sample user action data indicating a sample user intent, and a corresponding sample test scenario related to the sample user intent. The program code may include code to generate a test script based on the test scenario using a script machine learning (ML) model. The test script may be interpretable on the software platform. The test script, when interpreted on the software platform, may implement at least one testing step of the sequence of human-readable testing steps. The script ML model may have been trained on a script training data set comprising a plurality of sample script pairs. Each sample script pair may consist of a sample test scenario and a corresponding sample test script implementing the sample test scenario. The program code may include code to generate a test outcome related to the human-readable test scenario by interpreting the test script on an interpreter operatively connected to the software platform. Interpreting the test script may comprise interpreting the at least one testing step and causing an implementation of the at least one testing step on the software platform. The program code may include code to generate a test report based on the test outcome and the expected outcome. The test report may be a human-readable report comprising an evaluation of the test scenario on the software platform from the at least one testing step.

In a third aspect or in yet another embodiment, a computer-implemented method for artificial intelligence (AI)-assisted testing of a software functionality related to user intent is provided. The computer-implemented method may include receiving a user action data indicating a user intent related to a software platform. The user action data may comprise one or more operations performed by a user on the software platform to achieve the user intent. The user intent may comprise an outcome desired by the user when interacting with the software platform. The method may also include generating a test scenario based on the user action data, using a scenario machine learning (ML) model. The test scenario may be human-readable. The test scenario may comprise a sequence of human-readable testing steps and an expected outcome that are related to the user intent. The sequence of human-readable testing steps may be carried out on the software platform to evaluate a performance of the software platform in accomplishing the user intent. The scenario ML model may have been trained on a scenario training data set comprising a plurality of sample scenario pairs. Each scenario pair may consist of sample user action data indicating a sample user intent, and a corresponding sample test scenario related to the sample user intent. The method may also include generating a test script based on the test scenario using a script machine learning (ML) model. The test script may be interpretable on the software platform. The test script, when interpreted on the software platform, may implement at least one testing step of the sequence of human-readable testing steps. The script ML model may have been trained on a script training data set comprising a plurality of sample script pairs. Each sample script pair may consist of a sample test scenario and a corresponding sample test script implementing the sample test scenario. The method may also include generating a test outcome related to the human-readable test scenario by interpreting the test script on an interpreter operatively connected to the software platform. Interpreting the test script may comprise interpreting the at least one testing step and causing an implementation of the at least one testing step on the software platform. The method may also include generating a test report based on the test outcome and the expected outcome. The test report may be a human-readable report comprising an evaluation of the test scenario on the software platform from the at least one testing step.

In a fourth aspect or in yet another embodiment, a computer program product is provided. The computer program may be used for artificial intelligence (AI)-assisted testing of a software functionality related to user intent and may include a computer-readable storage medium having program instructions, or program code, embodied therewith, the program instructions executable by a processor to cause the processor to perform the aforementioned steps.

In a fifth aspect or in yet another embodiment, a system for artificial intelligence (AI)-assisted testing of a software functionality related to user intent is provided, the system including a memory that stores computer-executable components, and a hardware processor, operably coupled to the memory, and that executes the computer-executable components stored in the memory, where the computer-executable components may include components communicatively coupled with the processor that executes the aforementioned steps.

In a sixth aspect or in yet another embodiment, a system for artificial intelligence (AI)-assisted testing of a software functionality related to user intent is provided, the system including a user device having a processor, a display, a first memory; a server including a second memory and a data repository; a communications link between said user device and said server; and a plurality of computer codes embodied on said first and second memory of said user device and said server, said plurality of computer codes which when executed causes said server and said user device to execute a process including the steps described herein.

In a seventh aspect or in yet another embodiment, a computerized server is provided, including at least one processor, memory, and a plurality of computer codes embodied on said memory, said plurality of computer codes which when executed causes said processor to execute a process including the steps described herein. Other aspects and embodiments of the present invention include the methods, processes, and algorithms including the steps described herein, and include the processes and modes of operation of the systems and servers described herein.

In an eighth aspect or in yet another embodiment, an edge computerized system is provided, the edge computerized system running on a physical system or physical twin (PTw) with either access to, or dedicated, processing, memory, computer code stored on a non-transitory computer-readable storage medium of the physical system or PTw, and a plurality of sensor data being measured on said physical system or PTw, the computer code causing the processor to perform the aforementioned steps.

Features which are described in the context of separate aspects and/or embodiments of the invention may be used together and/or be interchangeable wherever possible. Similarly, where features are, for brevity, described in the context of a single embodiment, those features may also be provided separately or in any suitable sub-combination. Features described in connection with the non-transitory physical storage medium may have corresponding features definable and/or combinable with respect to a digital documentation system and/or method and/or system, or vice versa, and these embodiments are specifically envisaged.

Yet other aspects and embodiments of the present invention will become apparent from the detailed description of the invention when read in conjunction with the attached drawings.

### BRIEF DESCRIPTION OF THE DRAWINGS

The accompanying drawings, which are incorporated in and constitute part of this specification, illustrate embodiments of the invention and together with the description, serve to explain the principles of the disclosed embodiments. For clarity, simplicity, and flexibility, not all elements, components, or specifications are defined in all drawings. Not all drawings corresponding to specific steps or embodiments of the present invention are drawn to scale. Emphasis is instead placed on illustration of the nature, function, and product of the manufacturing method and devices described herein.

Embodiments of the present invention described herein are exemplary, and not restrictive. Embodiments will now be described, by way of examples, with reference to the accompanying drawings, in which:

### Interconnected Digital Model Platform

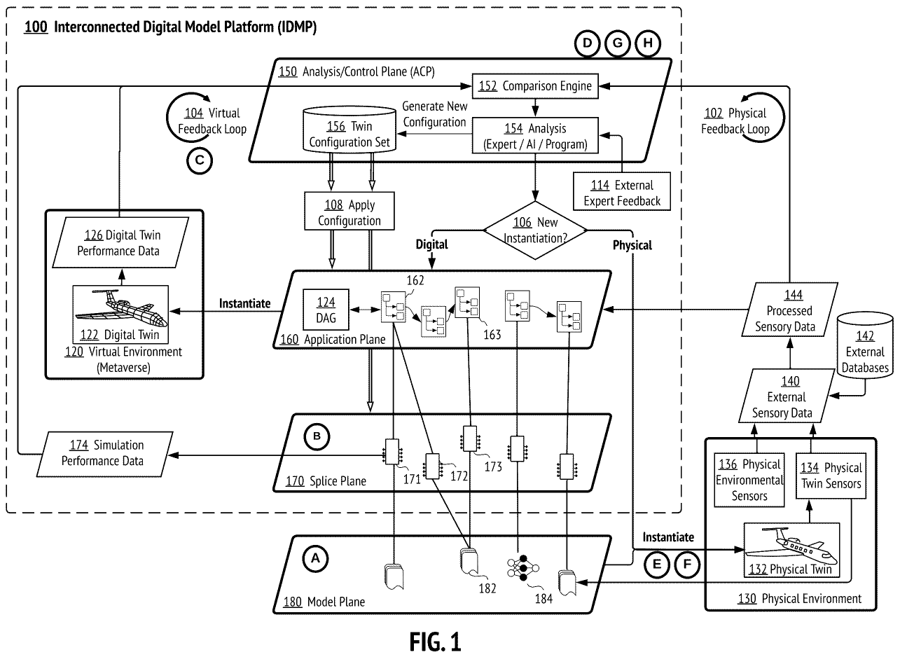

FIG. 1 shows an exemplary interconnected digital model platform (IDMP) architecture, in accordance with some embodiments of the present invention.

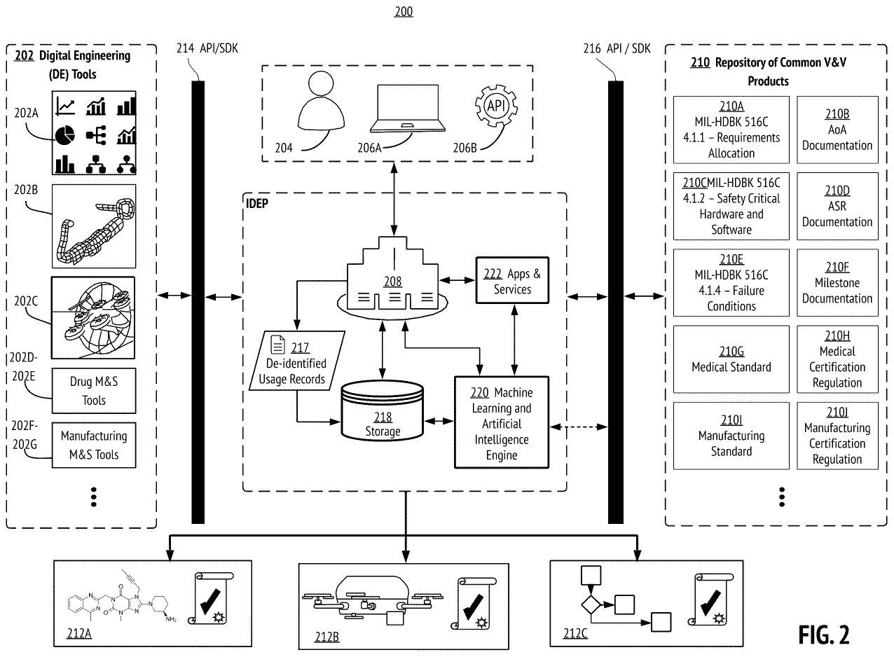

FIG. 2 shows an exemplary implementation of the IDMP as an interconnected digital engineering (DE) and certification ecosystem, and exemplary digitally certified products, in accordance with some embodiments of the present invention.

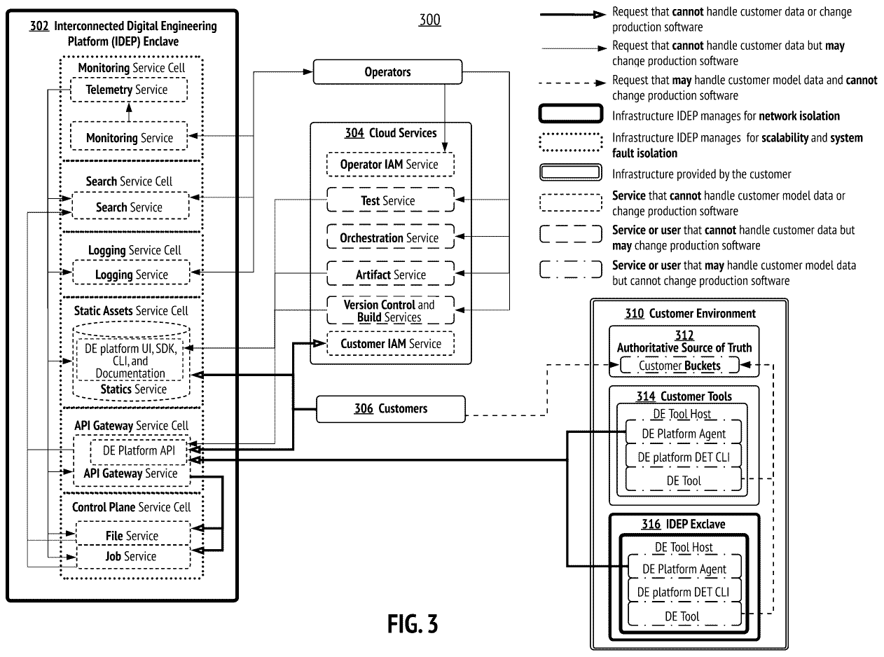

FIG. 3 shows another exemplary implementation of the interconnected digital engineering platform (IDEP) illustrating its offered services and features, in accordance with some embodiments of the present invention.

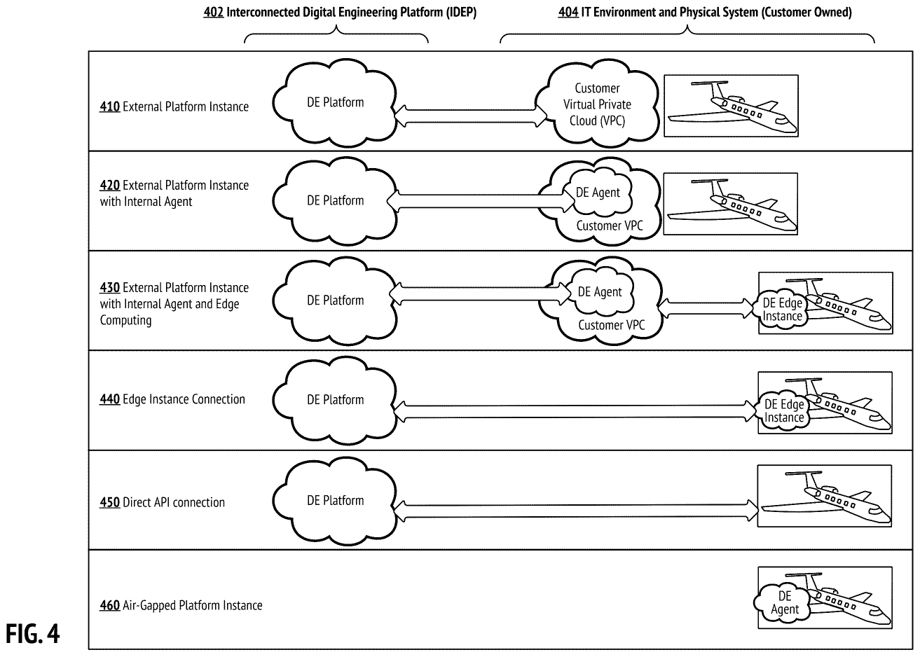

FIG. 4 shows potential scenarios for instantiating an IDEP in connection to a customer's physical system and IT environment, in accordance with some embodiments of the present invention.

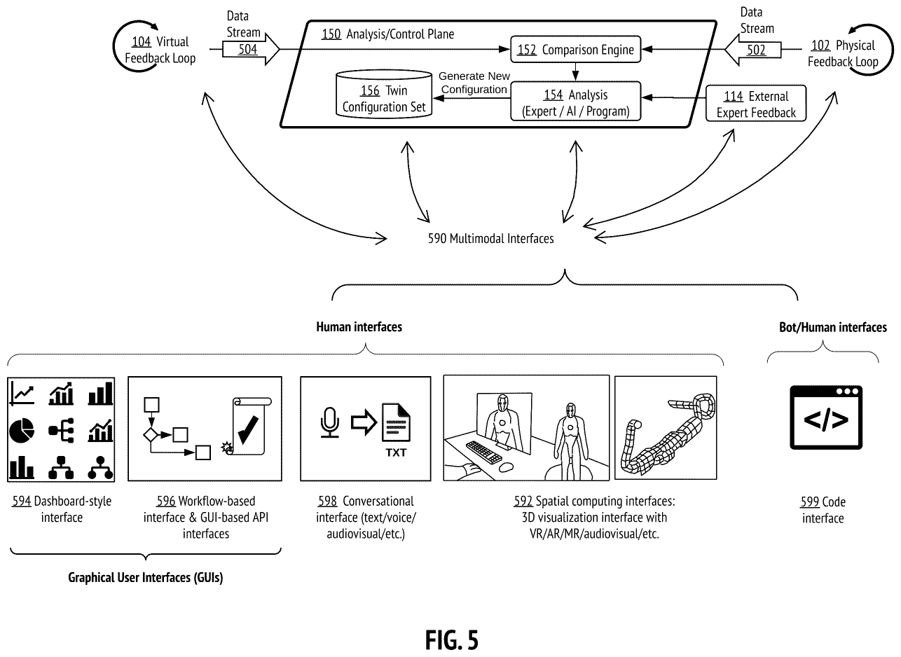

FIG. 5 shows exemplary multimodal interface designs for integration of feedback in an IDEP, in accordance with some embodiments of the present invention.

Digital Engineering Platform Links Digital Models into Digital Threads

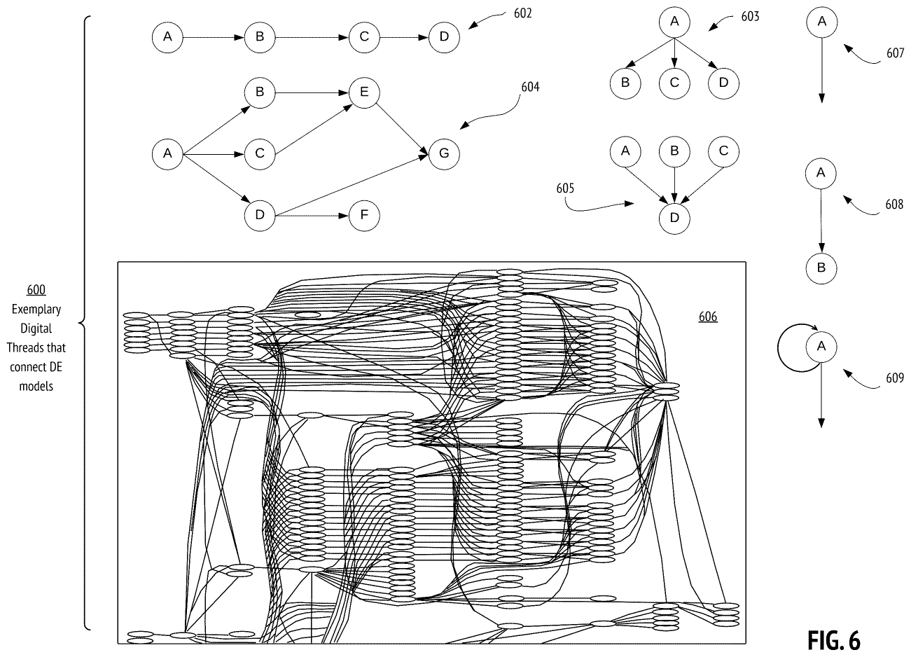

FIG. 6 is a schematic diagram comparing exemplary digital threads that connect DE models, in accordance with some embodiments of the present invention.

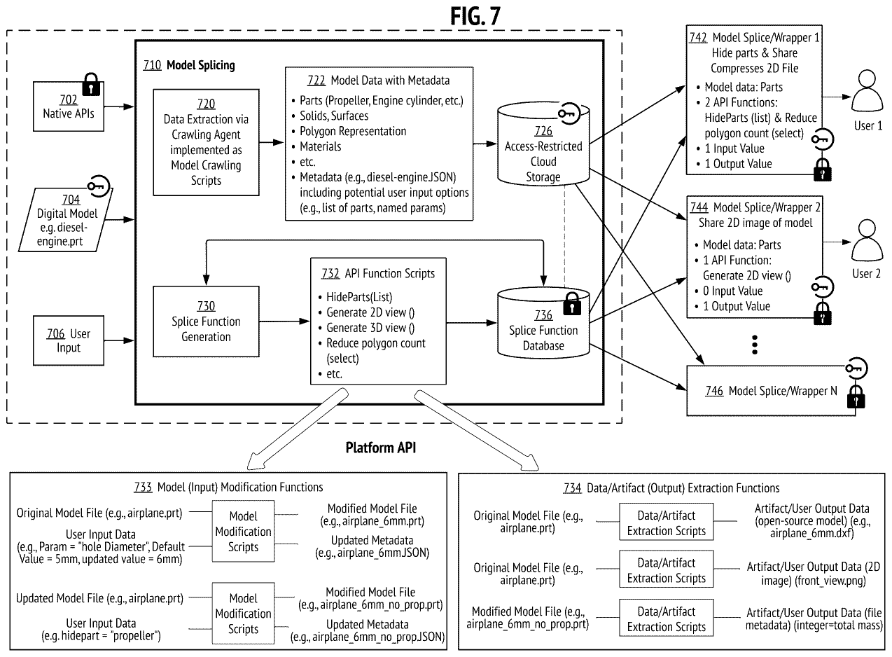

FIG. 7 is a schematic showing an exemplary DE model splicing setup, in accordance with some embodiments of the present invention.

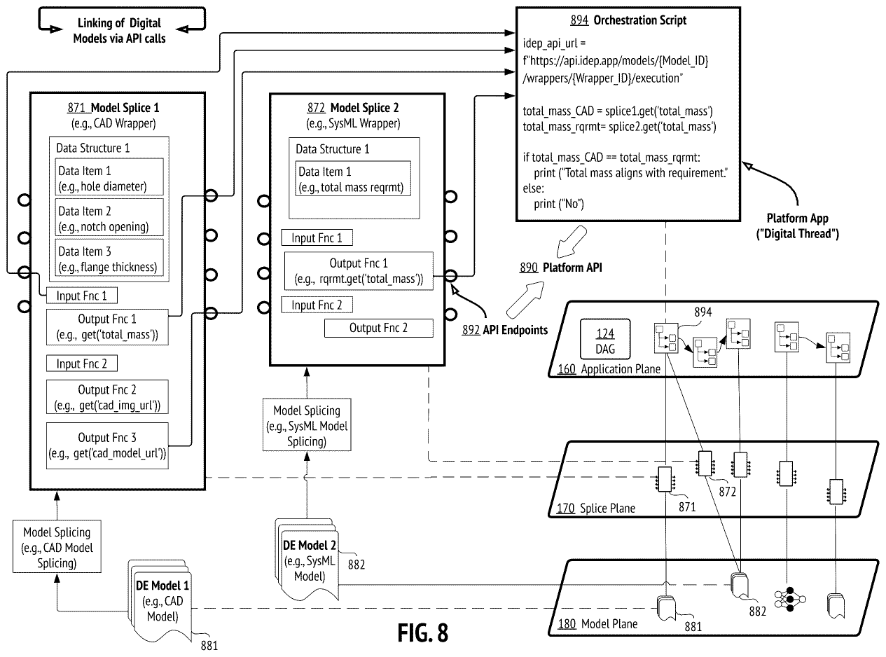

FIG. 8 is a schematic showing digital threading of DE models via model splicing, in accordance with some embodiments of the present invention.

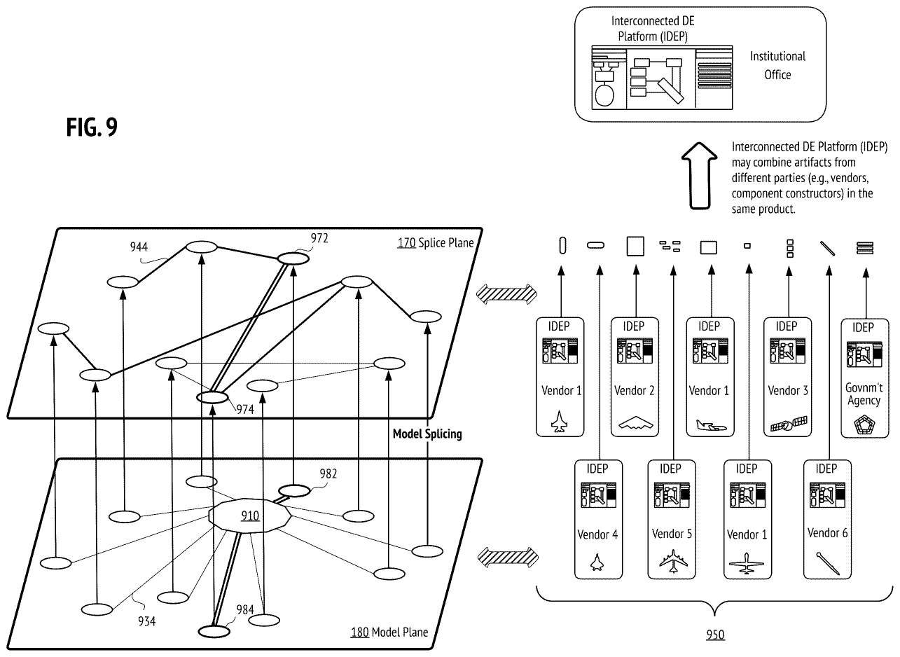

FIG. 9 is a schematic illustrating the linking of DE model splices in a splice plane and comparing digital threading with and without model splicing, in accordance with some embodiments of the present invention.

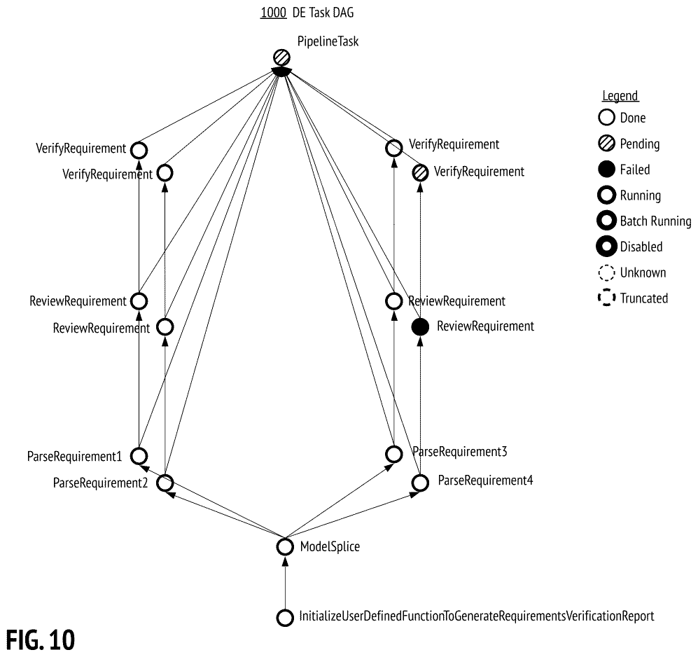

FIG. 10 shows an exemplary directed acyclic graph (DAG) representation of pipelined DE tasks related to digital threads, in accordance with some embodiments of the present invention.

### Digital Workflow Testing and AI-Assisted Testing Script Generation

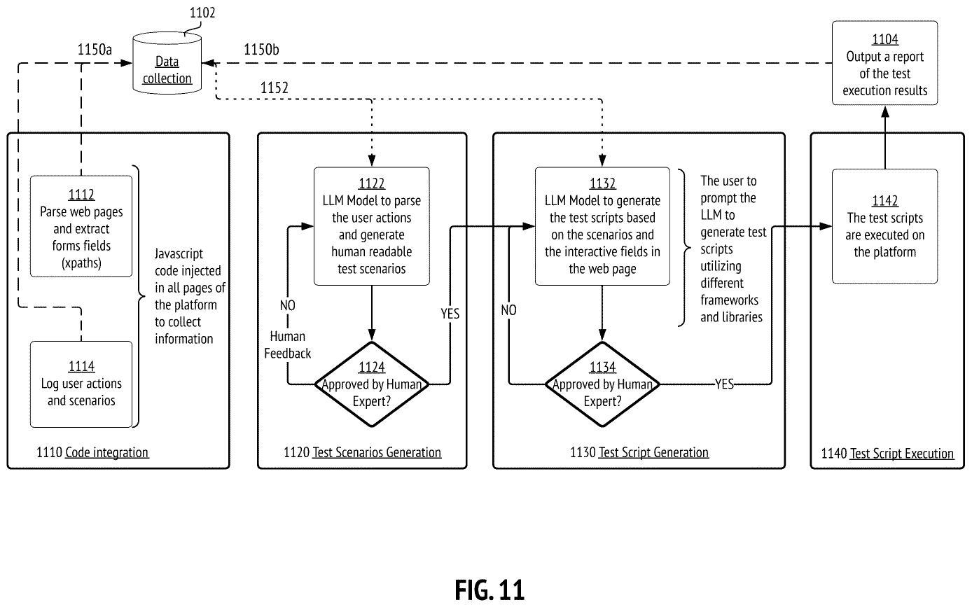

FIG. 11 illustrates a process for AI-assisted testing within a DE platform, according to some embodiments of the present invention.

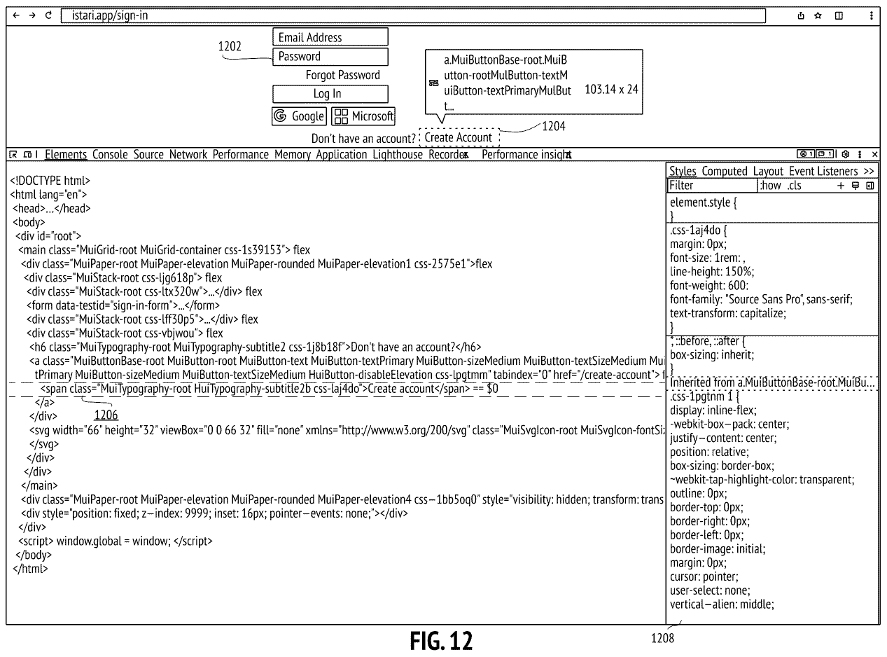

FIG. 12 shows a developer screen illustrating a user action (“Create Account”) interface and corresponding HTML code, according to an embodiment of the present invention.

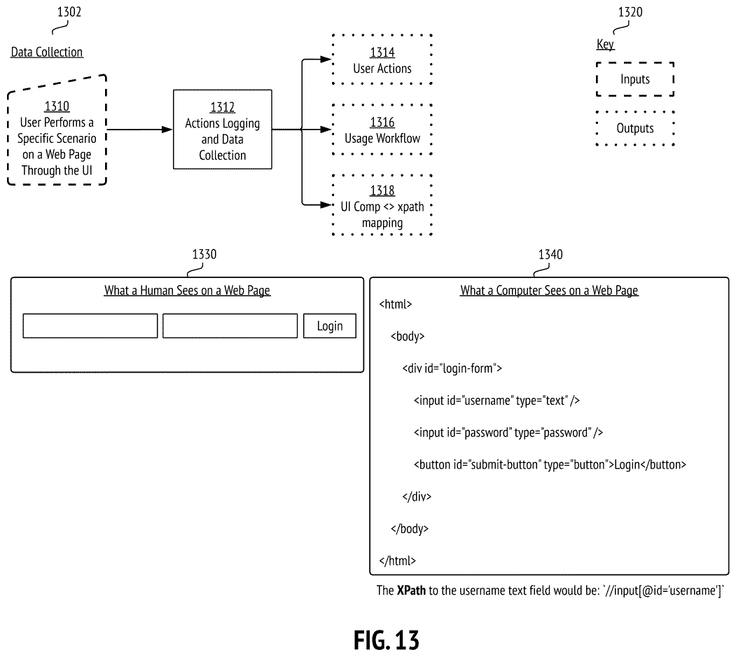

FIG. 13 illustrates data collection for AI-enabled testing, according to one embodiment of the present invention.

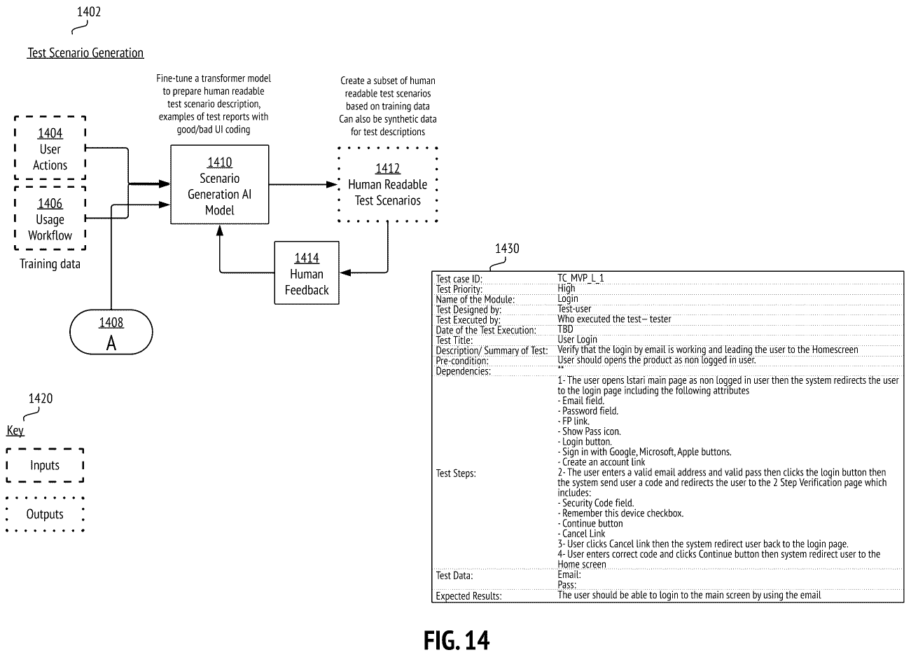

FIG. 14 illustrates an exemplary process for AI-enabled test scenario generation, according to one embodiment of the present invention.

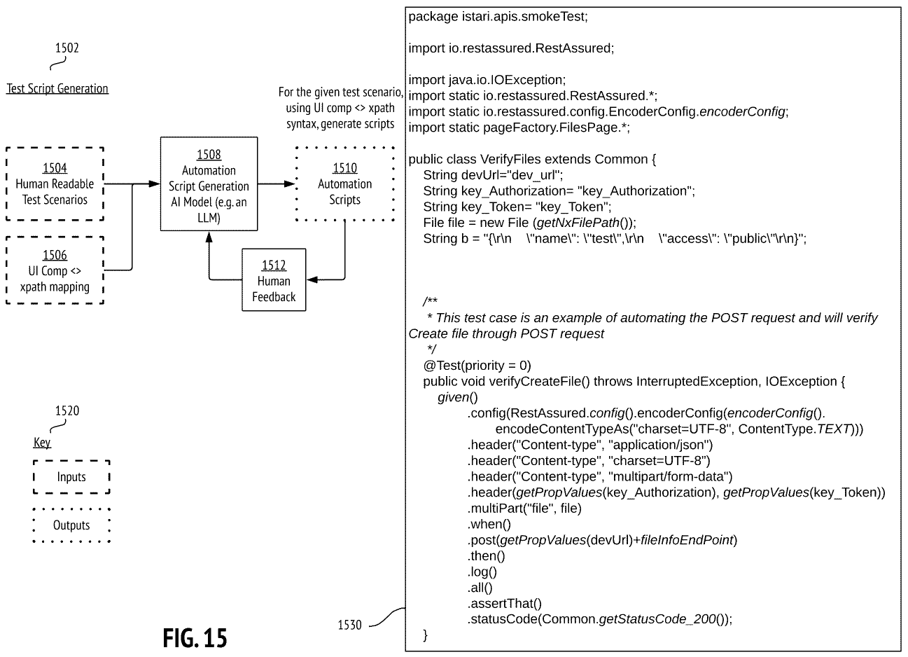

FIG. 15 shows an illustrative process for AI-assisted test script generation, in accordance with embodiments of the present invention.

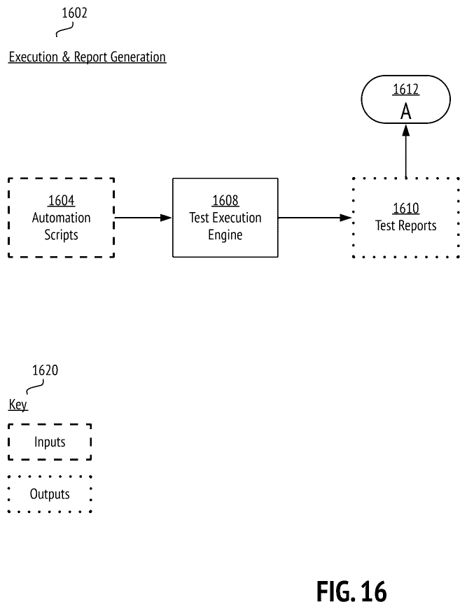

FIG. 16 illustrates test script execution and report generation, according to embodiments of the present invention.

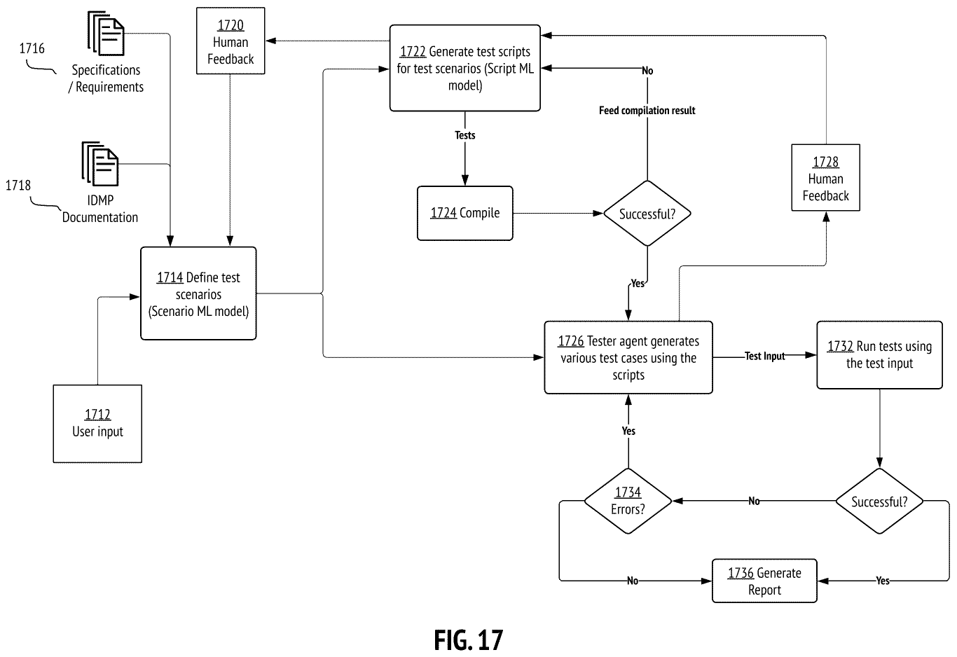

FIG. 17 shows an exemplary process for AI-assisted specification and/or feature testing script generation, in accordance with one embodiment of the present invention.

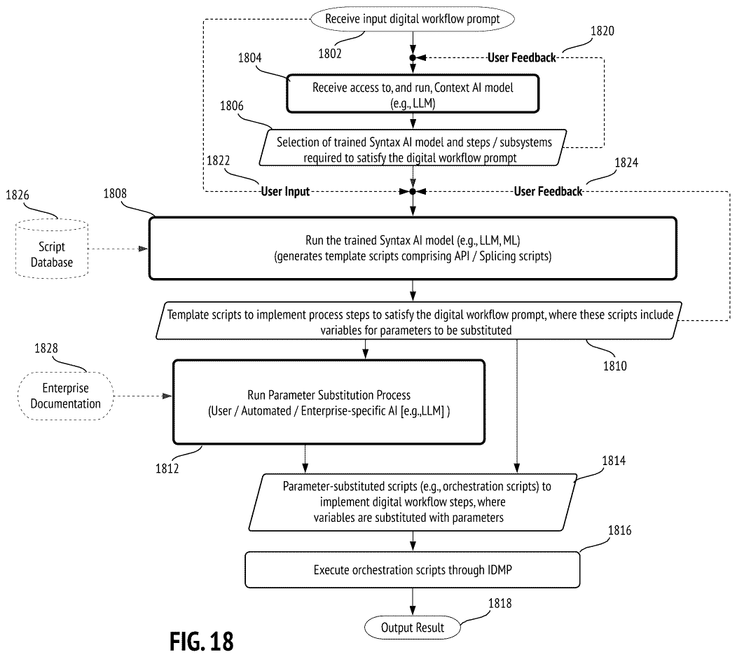

FIG. 18 shows a generalized AI-assisted design process over an Interconnected Digital Model Platform (IDMP), in accordance with one embodiment of the present invention.

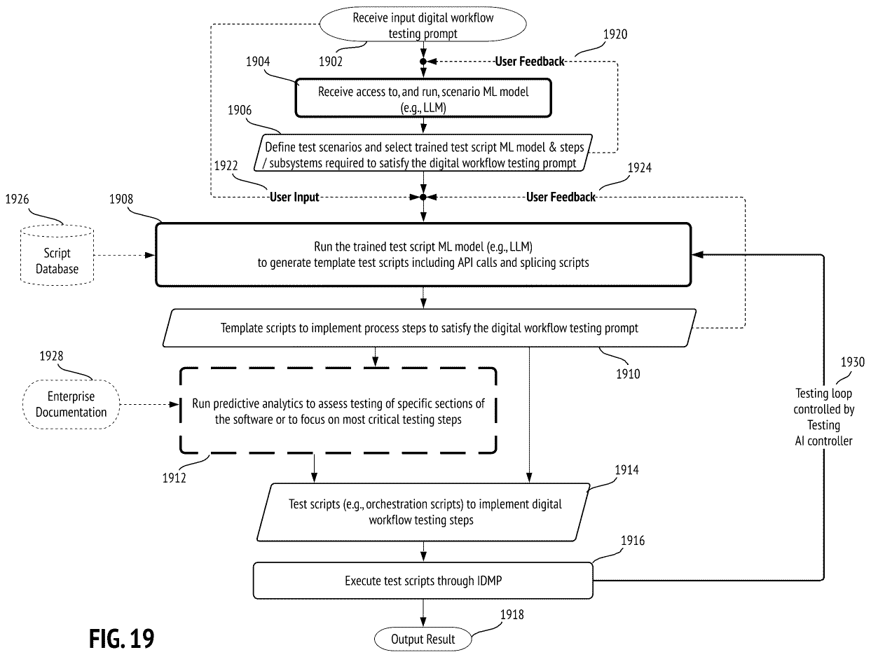

FIG. 19 shows a process for AI-assisted test script generation over an IDMP, in accordance with one embodiment of the present invention.

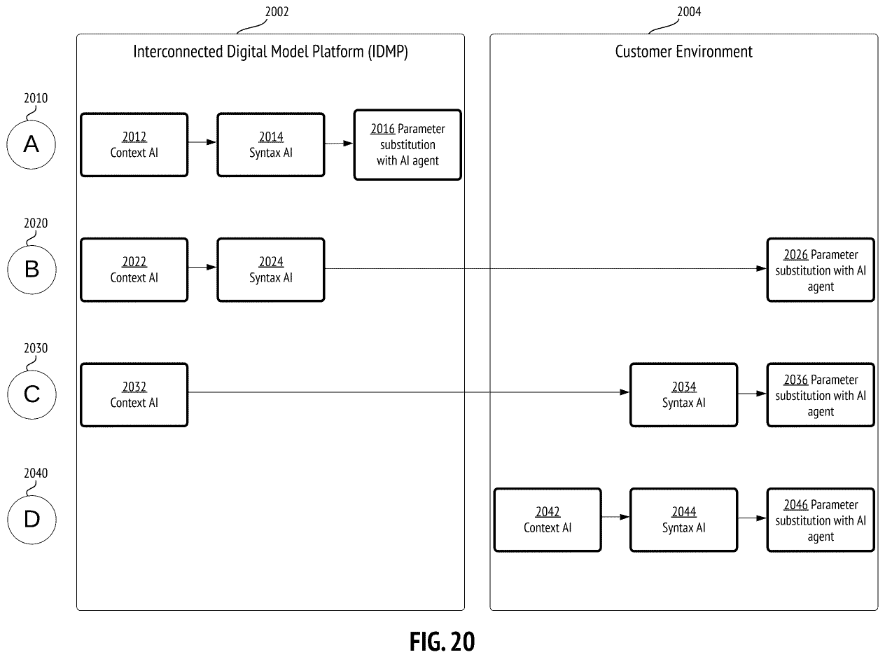

FIG. 20 shows potential scenarios for deploying the building blocks of a generalized AI-assisted design process in connection to a customer's physical system and IT environment, in accordance with some embodiments of the present invention.

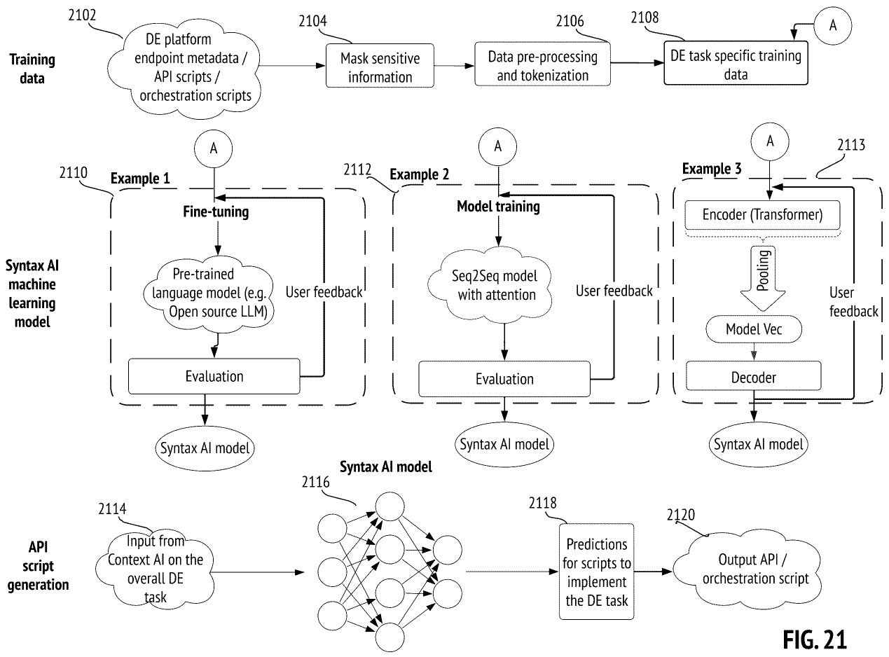

FIG. 21 describes the operation, training and implementation of a syntax AI model, in accordance with one embodiment of the present invention.

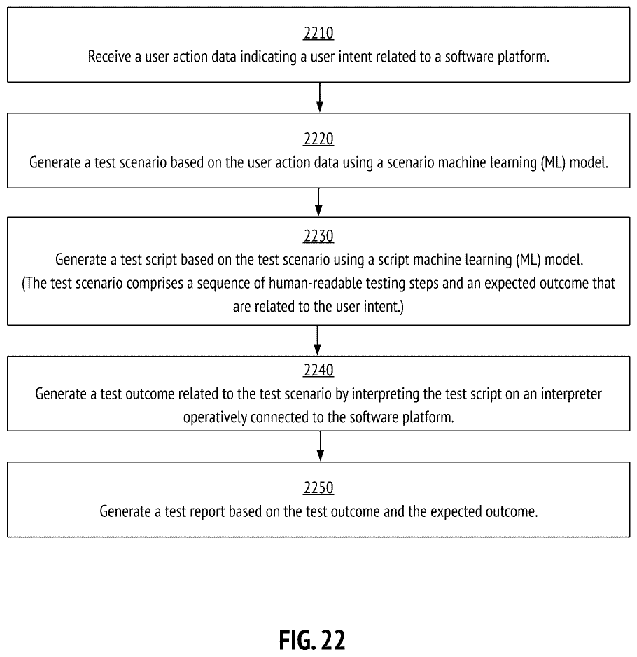

FIG. 22 shows an exemplary flow chart for AI-assisted testing of a software functionality related to user intent, in accordance with some embodiments of the present invention.

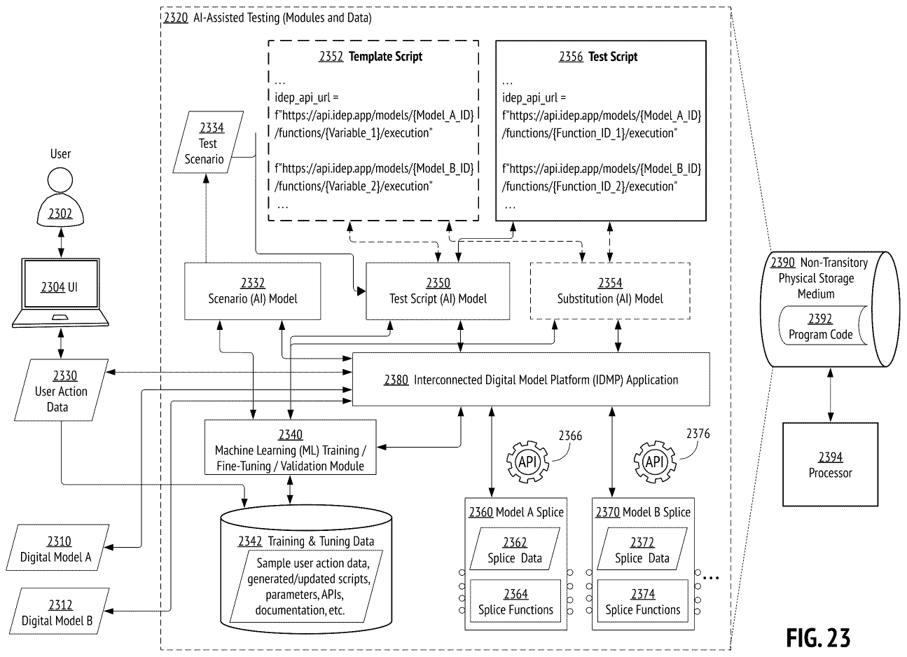

FIG. 23 is an exemplary system diagram showing a process for AI-assisted testing of a software functionality related to user intent, in accordance with some embodiments of the present invention.

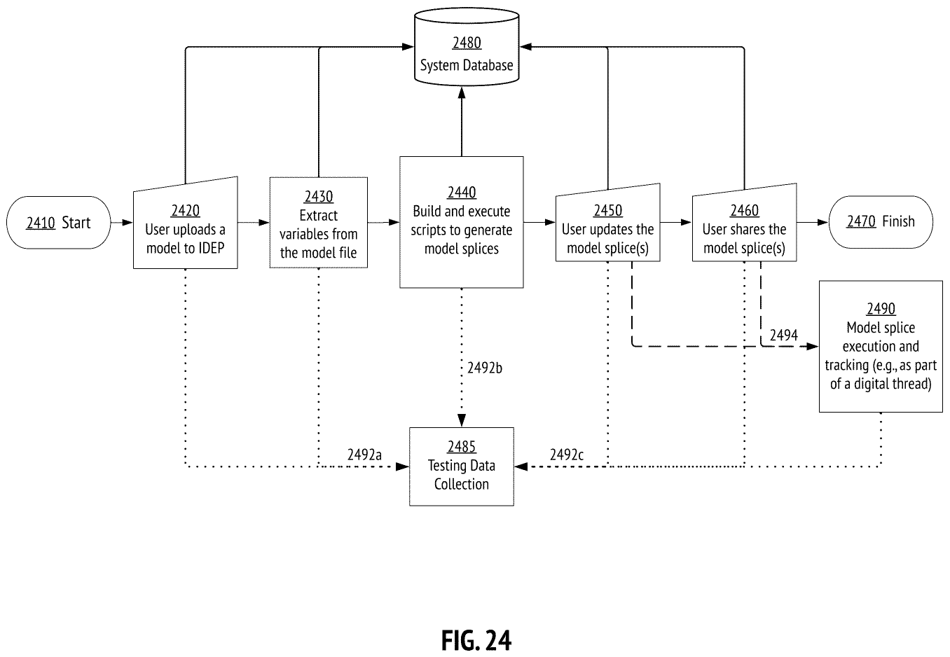

FIG. 24 shows a general process within the IDEP to perform model splicing and to generate model splices for all types of models, in accordance with some embodiments of the present invention.

### Machine Learning Implementation Architecture for IDMP Operations

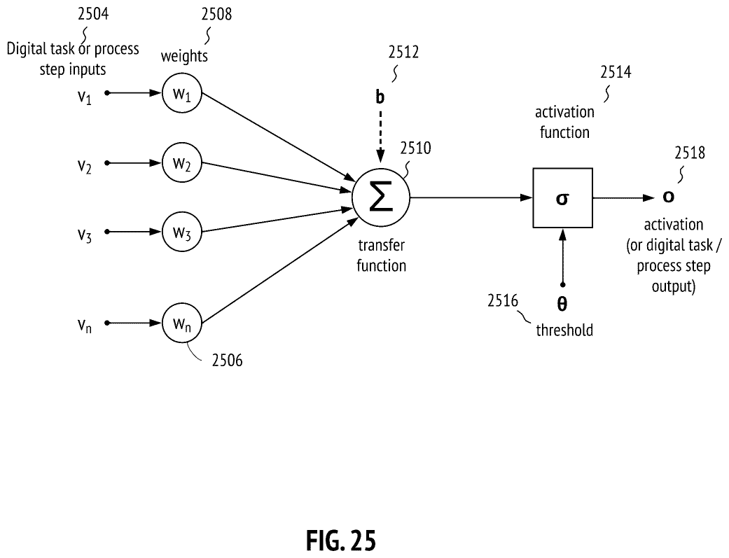

FIG. 25 describes neural network operation fundamentals, in accordance with some embodiments of the present invention.

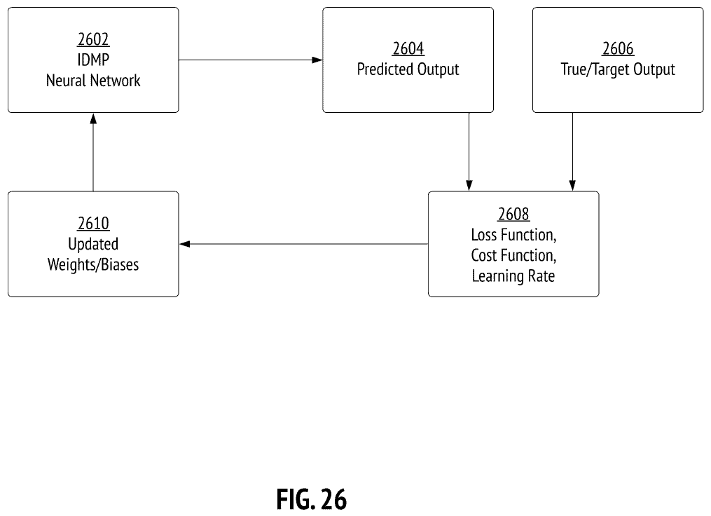

FIG. 26 shows an overview of an IDMP neural network training process, in accordance with some embodiments of the present invention.

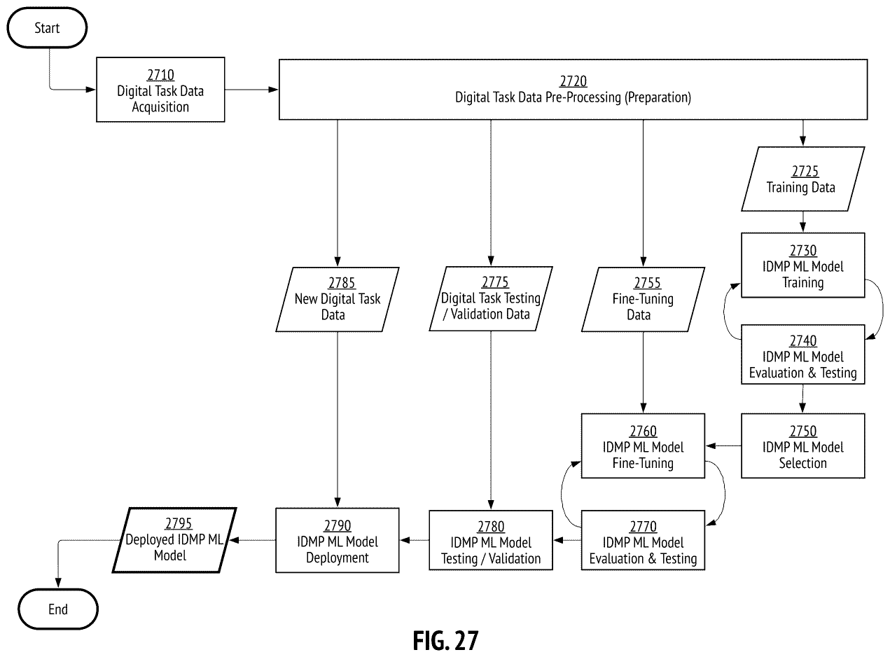

FIG. 27 is an illustrative flow diagram showing the different phases and datasets involved in training an IDMP machine learning model, in accordance with some embodiments of the present invention.

### Hardware and Software Architecture for IDMP Operations

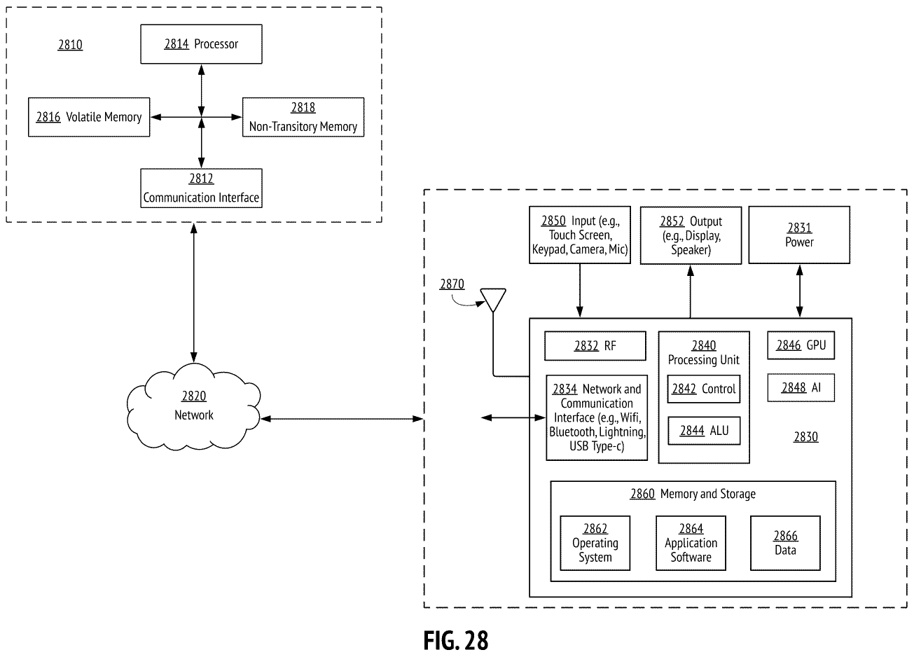

FIG. 28 provides illustrative schematics of a server (management computing entity) and a client (user computing entity) used for documentation within an IDMP, in accordance with some embodiments of the present invention.

### DETAILED DESCRIPTION OF THE INVENTION

In the following description, for purposes of explanation, numerous specific details are set forth in order to provide a thorough understanding of the invention. It will be apparent, however, to one skilled in the art that the invention can be practiced without these specific details. In other instances, structures, devices, activities, methods, and processes are shown using schematics, use cases, and/or diagrams in order to avoid obscuring the invention. Although the following description contains many specifics for the purposes of illustration, anyone skilled in the art will appreciate that many variations and/or alterations to suggested details are within the scope of the present invention. Similarly, although many of the features of the present invention are described in terms of each other, or in conjunction with each other, one skilled in the art will appreciate that many of these features can be provided independently of other features. Accordingly, this description of the invention is set forth without any loss of generality to, and without imposing limitations upon, the invention.

The methods and systems disclosed herein address the growing need for efficient and secure AI-assisted digital workflows in complex system design and management, specifically for testing within an integrated software platform that seeks to integrate a large variety of digital models and tools. Motivated by the challenges of integrating AI tools into fragmented software environments, ensuring data privacy, and improving scalability, the methods and systems disclosed herein introduce AI-assisted automation of testing of a software functionality over an interconnected digital model platform (IDMP). A scenario AI model generates human-readable test scenarios targeting the software functionality, and a test script AI model generates interpretable test scripts implementing testing steps in the human-readable test scenarios. A test report may be generated based on the test outcomes obtained from interpreting the test scripts on the IDMP. The human-readable test scenarios and the test reports allow for feedback to iteratively improve the test generation and testing processes.

With reference to the figures, embodiments of the present invention are now described in detail. First, the digital model platform (IDMP) and its digital engineering embodiment (IDEP) are explained in detail. Then, the digital splicing and threading operations enabling orchestration script generation are described in detail. Finally, the test script generation is detailed.

### Terminology

Some illustrative terminologies used herein are provided at the end of this document to assist in understanding the present invention, but these are not to be read as restricting the scope of the present invention. The terms may be used in the form of nouns, verbs, or adjectives, within the scope of the definition.

### Introduction

Broadly, the present invention relates to methods and systems for AI-assisted model splicer generation for any given DE model type, DE tool, or DE model type/DE tool combination. More specifically, embodiments of the present invention are directed to using machine learning (ML) and artificial intelligence (AI), especially Large Language Model (LLM)-based AI models, in identifying DE model data schemas, such as input and output schemas, and in creating scripts that either interface with the Application Programming Interfaces (APIs) of different DE tools or orchestrate the linking of individual digital model splices into digital threads. The terms Artificial Intelligence (AI), Machine Learning (ML), and equivalent terms, and abbreviations thereof, are used interchangeably herein. Numerous AI and ML algorithms are within the scope of the present invention, and any AI and ML algorithm that accomplishes the equivalent results could be used to implement the current invention.

Methods and systems thus described herein are further directed to AI-assisted cross-tool scripting of DE model operations encompassing disparate DE tools into a corpus of normative program code. That is, both DE models and DE tool interfaces are written as code, which in turn can be universally customized and automated within a unified DE platform for the creation, manipulation, and testing of complex systems comprising digital models, digital threads, and digital twins. Such effortless AI-assisted integration of new DE tools and components into a DE development platform enhances the platform's capabilities and performance while minimizing disruptions and delays, potentially leading to dramatic reductions in cost and time throughout all phases of any digitally-engineered product's lifecycle.

### Model Splicing, Digital Threading, and Digital Twinning

Model splicing, as described in U.S. provisional patent applications Nos. 63/451,545 (Docket No. IST-01002P), 63/451,577 (Docket No. IST-02001P), 63/462,988 (Docket No. IST-02001P2), and 63/470,870 (Docket No. IST-03001P), and as further disclosed herein, encapsulates and compartmentalizes digital engineering (DE) model data and model data manipulation and access functionalities.

A digital thread is intended to connect two or more digital engineering models for traceability across the systems engineering lifecycle, and collaboration and sharing among individuals performing digital engineering tasks. In a digital thread, appropriate outputs from a preceding digital model are provided as inputs to a subsequent digital model, allowing for information flow. That is, a digital thread may be viewed as a communication framework or data-driven architecture that connects traditionally siloed elements to enable the flow of information between digital models. Model splicing allows for making individual digital model files into executable splices that can be autonomously and securely linked, thus enabling the management of a large number of digital models as a unified digital thread (e.g., in a Directed Acyclic Graph (DAG) architecture). The extensibility of model splicing over many different types of digital models enables the scaling and generalization of digital threads to represent each and every stage of the digital engineering lifecycle.

Digital twins are real-time virtual replicas of physical objects or systems, with bi-directional information flow between the virtual and physical domains, allowing for monitoring, analysis, and optimization. In addition to linking digital models to create digital threads, model splicing further extends to the management and manipulation of digital twins, facilitating digital twin operations such as receiving external performance and sensor data streams (e.g., data that is aggregated from digital models or linked from physical sensor data), and calibrating digital twins with data streams from physical sensors outside of native digital twin environment or from expert feedback that provides opportunity to refine simulations and model parameters.

### The Model Splicing Process and Model Splicer Generation

A DE model type-specific model splicer stores model data extracted from a DE model file in a model type-specific data structure. A model splicer further generates Application Programming Interface (API) function scripts that can be applied to the model data. A “model splice” or “wrapper” for a given user application can be generated by wrapping model data and API function scripts that are specific to the user application, thus allowing only access to and enabling modifications of limited portions of the original engineering model file for collaboration and sharing with stakeholders of the given user application. In this disclosure, the term “model splicer” refers to a software module that can be used to generate model splices or model wrappers. “Model splicer generation” refers to the process of setting up a model splicer, or establishing an all-encompassing framework or template, from which individual model splices can be deduced. Furthermore, the terms “model splice,” “model wrapper,” “splice node,” “splicer node,” and “wrapper node” may be used interchangeably to represent a model splicing result.

A model splice or wrapper makes available a subset of a model file through a set of API endpoints. “API endpoints” generated via splicing provide access for inputs and/or outputs to one or more API scripts encapsulated in the model splice. Corresponding API endpoints can be linked between different model splices from different digital models, wherein output from a preceding digital model splice may be provided as inputs to a subsequent digital model splice, allowing for information flow, thus creating a digital thread to propagate requirement and/or design changes throughout a complex engineering system, and to enable seamless collaboration and sharing among individuals performing digital engineering tasks.

### AI-Assisted Model Splicer Generation

As described in the previous subsection, model splicer generation refers to the process of setting up a model splicer by establishing an all-encompassing framework, template, or collection of input/output schemas and scripts. Creation of model type-specific model splicers requires thorough knowledge of application and user demand, deep subject matter expertise in understanding specific model data and associated API libraries, as well complex software engineering skills in creating model type-specific API scripts for interfacing with individual digital model splices, and orchestration scripts for linking digital model splices of different model types.

An artificial intelligence (AI)-assisted approach to model splicer generation utilizes generative AI algorithms to assist in creating model splicers for new DE model types, based on existing model splicers created by subject matter experts (SME) and software engineers (SWE). Specifically, AI-assisted model splicer generation for a given DE model type creates input and output schema for model splices of the given DE model type, as well as a library or pipeline of DE tool API scripts and cross-tool orchestration scripts that can be selectively integrated into any particular model splice. The generated model splicer can then be applied to a specific digital model file of the given model type, to create a model splice by extracting model data from the model file, instantiating API endpoints according to input/output schemas, and encapsulating a set of selected scripts that allow access and modification of the model data.

One advantage of AI-assisted model splicer generation is the generalization of individual modular model splicers into a software engine that is universal, scalable, and adaptable to ever evolving advancements in DE. While no single or even groups of SMEs or SWEs are capable of creating individual model splicers for each of the hundreds and thousands of DE model types existing today, ISTARI's AI-supported DE platform is capable of standardizing data schema and modular model interfaces across various DE tools to enable seamless new tool integration, maximize efficiency and adaptability, minimize manual errors, avoid inconsistencies, and reduce complexity in managing digital model, digital threads, and digital twins.

In various embodiments of the present invention, AI-assistance may be provided by individual software modules to perform one or more of the following functions. “AI-assistance” broadly refers to the use of any ML and/or AI algorithms, models, and techniques to assist in the completion of DE tasks. This list is non-exhaustive and non-limiting in nature:
Generating input and output schema for a given DE model type, DE tool, use case, or any combinations thereof
Generating textual or visual illustrations for a model splicer mockup
Reviewing End User License Agreements to identify customer constraints
Reviewing DE model type and/or tool-specific documentations such as API libraries
Generating API scripts/function wrappers
Generating cross-tool orchestration or coordination scripts for use in digital threading and digital twinning
Enabling user-prompted customization and execution of the above functions. For example, generating user-defined API function wrappers, API scripts, or orchestration scripts
Generating digital threads (e.g., in a DAG architecture) that link DE model splices, using associated API and orchestration scripts created by the above functions
Suggesting DE models for linking with an existing DE model, into a digital thread

Several generative AI models are within the scope of the present invention with two illustrative examples being generative adversarial networks (GANs), and transformer-based Large Language Models (LLMs), such as Generative Pre-Trained (GPT) language models. In this disclosure, LLMs are considered as an illustrative example of generative AI models for implementing AI-assisted model splicer generation, but are not intended to be limiting in scope. Similarly, while there has been a recent explosion in LLM implementations and applications including BERT, ChatGPT (GPT-4), Claude, LaMDA, and LlaMA, with either proprietary or public licenses, discussion of any specific generative AI models in this present disclosure is for illustrative purposes only and is not intended to limit the scope of the invention.

In various embodiments, the ML and AI engines or modules thus disclosed may be trained and/or fine-tuned on datasets of user inputs, exemplary input and output schemas and scripts, exemplary user actions, corresponding exemplary test scenarios, and corresponding exemplary scripts, and exemplary additional relevant training data sets described herein. Fine-tuned LLMs may be further customized with enterprise documents and data when appropriate, to capture specific language and data dependencies within client databases.

In this document, FIGS. 1-5 introduce the DE platform, FIGS. 6-10 describe AI-assisted model splicing and model splice script generation, providing an important background for testing script generation. Finally, FIGS. 11-28 introduce and illustrate AI-assisted testing.

### An Interconnected Digital Model Platform (IDMP) Architecture

FIG. 1 shows an exemplary interconnected digital model platform (IDMP) architecture, in accordance with some embodiments of the present invention. In the context of digital engineering (DE), the IDMP 100 streamlines the process of product development from conception to production, by using a virtual representation or digital twin (DTw) 122 of the product to optimize and refine features before building a physical prototype or physical twin (PTw) 132, and to iteratively update DTw 122 until DTw 122 and PTw 132 are in sync to meet the product's desired performance goals. In the context of digital engineering (DE), the IDMP 100 may be identified as an Interconnected Digital Engineering Platform (IDEP).

Specifically, a product (e.g., airplane, spacecraft, exploration rover, missile system, automobile, rail system, marine vehicle, remotely operated underwater vehicle, robot, drone, medical device, biomedical device, pharmaceutical compound, drug, power generation system, smart grid metering and management system, microprocessor, integrated circuit, building, bridge, tunnel, chemical plants, oil and gas pipeline, refinery, etc.) manufacturer may use IDMP platform 100 to develop a new product. The engineering team from the manufacturer may create or instantiate digital twin (DTw) 122 of the product in a virtual environment 120, encompassing detailed computer-aided design (CAD) models and finite element analysis (FEA) or computational fluid dynamics (CFD) simulations of component systems such as fuselage, wings, engines, propellers, tail assembly, and aerodynamics. DTw 122 represents the product's design and performance characteristics virtually, allowing the team to optimize and refine features before building a physical prototype 132 in a physical environment 130. In some embodiments, PTw 132 may be an existing entity, while DTw 122 is a digital instance that replicates individual configurations of PTw 132, as-built or as-maintained. In the present disclosure, for illustrative purposes only, DTw 122 and PTw 132 are discussed in the context of building a new product, but it would be understood by persons of ordinary skill in the art that the instantiation of DTw 122 and PTw 132 may take place in any order, based on the particular use case under consideration.

Digital models (e.g., CAD models, FEA models, CFD models) used for creating DTw 122 are shown within a model plane 180 in FIG. 1. Also shown in model plane 180 is a neural network (NN) model 184, which may provide machine-learning based predictive modeling and simulation for a DE process. A DE model such as 182 may be spliced into one or more model splices, such as 172 and 173 within a splice plane 170. Individual DTws such as 122 are instantiated from splice plane 170 via an application plane 160. A model splice such as 172 may be linked to another model splice such as 171 by a platform script or application 162 on application plane 160 into a digital thread. Multiple digital threads such as 162 and 163 may be further linked across different stages or phases of a product life cycle, from concept, design, testing, to production. Digital threads further enable seamless data exchange and collaboration between departments and stakeholders, ensuring optimized and validated designs.

As model splicing provides input and output splice functions that can access and modify DE model data, design updates and DE tasks associated with the digital threads may be represented by scripted, interconnected, and pipelined tasks arranged in Directed Acyclic Graphs (DAGs) such as 124. A DE task DAG example is discussed in further detail with reference to FIG. 10.

To enhance the design, external sensory data 140 may be collected, processed, and integrated into application plane 160. This process involves linking data from different sources, such as physical sensors 134 on prototype 132, physical environmental sensors 136, and other external data streams such as simulation data from model plane 180. API endpoints provide access to digital artifacts from various environments (e.g., physical twin (PTw) sensor 134 data) and integrate them into the spliced plane 170 for the DTw 122. Model splices on the splice plane 170 enable autonomous data linkages and digital thread generation, ensuring DTw 122 accurately represents the product's real-world performance and characteristics.

To validate DTw 122's accuracy, the engineering team may build or instantiate PTw 132 based on the same twin configuration (i.e., digital design). Physical prototype 132 may be equipped with numerous sensors 134, such as accelerometers and temperature sensors, to gather real-time performance data. This data may be compared with the DTw's simulations to confirm the product's performance and verify its design.

Processed sensory data 144 may be used to estimate parameters difficult to measure directly, such as aerodynamic forces or tire contact patch forces. Such processed sensory data provide additional data for DTw 122, further refining its accuracy and reliability. Processed sensory data 144 may be generated from physical environment sensors 136 with physical environment 130, and may be retrieved from other external databases 142, as discussed below.

During development, feedback from customers and market research may be collected to identify potential improvements or adjustments to the product's design. At an analysis & control plane (ACP) 150, subject matter experts (SMEs) may analyze processed sensory data 144 and external expert feedback 114, to make informed decisions on necessary design changes. Such analysis may be done by an analysis module 154, and may be enhanced or entirely enabled by algorithms (i.e., static program code) or artificial intelligence (AI) modules. Linking of digital threads such as 162, physical sensors 134 and 136, processed sensory data 144, and expert feedback data 114 occurs at ACP 150, where sensor and performance data is compared, analyzed, leading to modifications of the underlying model files through digital threads. Within the ACP 150, the analysis module 154 may carry out testing of the product. Additionally, testing of the twin configuration set 156, which includes feature testing, may occur in the connection between the analysis module 154 and the twin configuration set 156.

In particular, sensory data 144 from physical environment 130 and performance data 126 from virtual environment 120 may be fed into a comparison engine 152. Comparison engine 152 may comprise tools that enable platform users to compare various design iterations with each other and with design requirements, identify performance lapses and trends, and run verification and validation (V&V) tools.

Model splicing is discussed in further detail with reference to FIGS. 7 to 9. Model splicing enables the scripting of any DE operation involving DE model files in model plane 180, where each DE model is associated with disparate and siloed DE tools. Codification of DE models and DE operations with a unified corpus of scripts enable IDMP 100 to become an aggregator where a large space of DE activities associated with a given product (e.g., airplane, spacecraft, exploration rover, missile system, automobile, rail system, marine vehicle, remotely operated underwater vehicle, robot, drone, medical device, biomedical device, pharmaceutical compound, drug, power generation system, smart grid metering and management system, microprocessor, integrated circuit, building, bridge, tunnel, chemical plants, oil and gas pipeline, refinery, etc.) may be threaded through program code. Thus, model splicing enables the linking and manipulation of all model files (e.g., 182, 184) associated with a given product within the same interconnected platform or DE ecosystem 100. As a consequence, the generation and training of AI modules for the purpose of manipulating DE models (e.g., 182), digital threads (e.g., 162), and digital twins (e.g., 122) become possible over the programmable and unified IDMP 100.

### Virtual and Physical Feedback Loops

FIG. 1 uses letter labels “A” to “H” to denote different stages of a product's lifecycle. At each stage, IDMP 100 enables feedback loops whereby data emanating from a PTw or a DTw is analyzed at ACP 150, leading to the generation of a new twin configuration based on design modifications. The new twin configuration may be stored in a twin configuration set and applied through the application and splice planes, yielding modified model files that are registered on the digital thread.

A virtual feedback loop 104 starts with a decision 106 to instantiate new DTw 122. A DAG of hierarchical tasks 124 allows the automated instantiation of DTw 122 within virtual environment 120, based on a twin configuration applied at a process step 108 from a twin configuration set 156. DTw 122 and/or components thereof are then tested in virtual environment 120, leading to the generation of DTw performance data 126. Concurrently, DTw 122 and/or components thereof may be tested and simulated in model plane 180 using DE software tools, giving rise to test and simulation performance data 174. Performance data 126 and 174 may be combined, compared via engine 152, and analyzed at ACP 150, potentially leading to the generation and storage of a new twin configuration. The eventual decision to instantiate a DTw from the new twin configuration completes virtual feedback loop 104.

A physical feedback loop 102 starts with a decision 106 to instantiate a new PTw 132. PTw 132 may be instantiated in a physical environment 130 from the model files of model plane 180 that are associated with an applied twin configuration from the twin configuration set 156. PTw 132 and/or components thereof are then tested in physical environment 132, leading to the generation of sensory data from PTw sensors 134 and environmental sensors 136 located in physical environment 130. This sensory data may be combined with data from external databases to yield processed sensory data 144. In one exemplary embodiment, temperature readings from environmental sensors located within the physical environment are completed, adjusted (e.g., shifted), and/or calibrated using data from external temperature databases.

Data from PTw sensors 134 may be directly added to the model files in model plane 180 by the DE software tools used in the design process of PTw 132. Alternatively, PTw sensor data may be added to digital thread 162 associated with PTw 132 directly via application plane 160. In addition, processed sensory data 144 may be integrated into IDMP 100 directly via application plane 160. For example, processed sensory data 144 may be sent to ACP 150 for analysis, potentially leading to the generation and storage of a new twin configuration. The eventual decision to instantiate a PTw from the new twin configuration completes physical feedback loop 102.

At each stage A to H of the product life cycle, the system may label one twin configuration as a current design reference, herein described as an “authoritative twin” or “authoritative reference”. The authoritative twin represents the design configuration that best responds to actual conditions (i.e., the ground truth). PCT application No. PCT/US24/27898 (Docket No. IST-03.001PCT) provides a more complete description of authoritative twins and their determination, and is incorporated by reference in its entirety herein.

With faster feedback loops from sensor data and expert recommendations, the system updates DTw 122 to reflect latest design changes. This update process may involve engineering teams analyzing feedback 154 and executing the changes through IDMP 100, or automated changes enabled by IDMP 100 where updates to DTw 122 are generated through programmed algorithms or AI modules. This iterative updating process continues until DTw 122 and PTw 132 are in sync and the product's performance meets desired goals. While IDMP 100 may not itself designate the authoritative reference between a DTw or a PTw, the platform provides configurable mechanisms such as policies, algorithms, voting schema, and statistical support, whereby agents may designate a new DTw as the authoritative DTw, or equivalently in what instances the PTw is the authoritative source of truth.

When significant design improvements are made, a new PTw prototype may be built based on the updated DTw. This new prototype undergoes further testing and validation, ensuring the product's performance and design align with project objectives.

Once DTw 122 and PTw 132 have been validated and optimized, the product is ready for production. A digital thread connecting all stages of development can be queried via splice plane 170 to generate documentation as needed to meet validation and verification requirements. The use of model splicing, along with the feedback architecture shown in FIG. 1, improves the efficiency of the overall product innovation process.

### Interconnected DE Platform and Product Lifecycle

In FIG. 1, letter labels “A” to “H” indicate the following major steps of a product lifecycle, according to some embodiments of the current invention:
A. Digital models reside within customer environments: a product may be originally represented by model files that are accessible via software tools located within customer environments. Model plane 180 encompasses all model files (e.g., 182) associated with the product.
B. Preparatory steps for design in the digital realm: splice plane 170 encompasses model splices (e.g., 172) generated from DE model file through model splicing. Model splicing enables the integration and sharing of DE model files within a single platform, as described in detail with reference to FIGS. 7 to 9.
C. Link threads as needed among model splices: to implement a product, model splices are linked through scripts within application plane 160. A digital twin (DTw) 122 englobing as-designed product features may be generated from application plane 160 for running in virtual environment 120. The complete twin configuration of a generated DTw is saved in twin configuration set 156 located at the analysis & control plane (ACP) 150. Features or parts of DTw 122 may be simulated in model plane 180, with performance data 174 accessed through splice plane 170. In one embodiment, features or parts of PTw 132 or DTw 122 configuration may be simulated outside the platform, where performance data is received by the ACP 150 for processing, in a similar way as performance data 126 received from DTw 122.
D. Finalize “As-designed”: performance data 126 from DTw 122 or simulation performance data 174 attained through model plane 180 and accessed through model splicing may be collected and sent to ACP 150 for analysis. Performance data from different iterations of DTw 122 may be compared via engine 152 to design requirements. Analysis of the differences may lead to the generation of new twin configurations that are stored at twin configuration set 156. Each twin configuration in twin configuration set 156 may be applied at application plane 160 and splice plane 170 via process step 108 to instantiate a corresponding DTw. Multiple DTws may be generated and tested, consecutively or simultaneously, against the design requirements, through comparison engine 152 and analysis module 154. Verification and validation tools may be run on the various DTw iterations.
E. Finalize “As-manufactured”: once a DTw 122 satisfies the design requirements, a corresponding PTw 132 prototype may be instantiated from the spliced model files (e.g., 172). Sensor data originating from the PTw 134 or from within the physical environment 136 may be collected, combined with other external data 142 (e.g., sensor data from other physical environments). The resulting processed sensory data 144 may be sent to the analysis & control plane 150 to be compared with performance data 126 from DTws and simulations (e.g., 174), leading to further DTw 122 and PTw 132 iterations populating the twin configuration set 156. Processed sensory data 144 may also be mapped to the digital threads (e.g., 164) and model splices (e.g., 172) governing the tested PTw 132 through the application plane 160.
F. Finalize “As-assembled”: once the manufacturing process is completed for the various parts, as a DTw and as a PTw, the next step is to finalize the assembled configuration. This involves creating a digital representation of the assembly to ensure it meets the specified requirements. The digital assembly takes into account the dimensions and tolerances of the “as-manufactured” parts. To verify the feasibility of the digital assembly, tests are conducted using the measured data obtained from the physical assembly and its individual components. Measurement data from the physical component parts may serve as the authoritative reference for the digital assembly, ensuring alignment with the real-world configuration. The digital assembly is compared with the actual physical assembly requirements for validation of the assembled configuration. Subsequently, the digital assembly tests and configurations serve as an authoritative reference for instructions to guide the physical assembly process and ensure accurate replication. IDMP 100 components described above may be used in the assembly process. In its authoritative iteration, DTw 122 ultimately captures the precise details of the physical assembly, enabling comprehensive analysis and control in subsequent stages of the process.
G. Finalize “As-operated”: to assess the performance of the physical assembly or its individual component parts, multiple digital twins 122 may be generated as needed. These digital twins are created based on specific performance metrics and serve as virtual replicas of the physical system. Digital twins 122 are continuously updated and refined in real-time using the operational data (e.g., 144) collected from monitoring the performance of the physical assembly or its components. This data may include, but are not limited to, processed sensory data, performance indicators, and other relevant information. By incorporating this real-time operational data, digital twins 122 stay synchronized with the actual system and provide an accurate representation of its operational performance. Any changes or improvements observed via sensory data 144 during the real-world operation of the assembly are reflected in DE models within the digital twins and recorded in the twin configuration set 156. This ensures that the digital twins remain up-to-date and aligned with the current state of the physical system.
H. Predictive analytics/Future performance: The design process may continue iteratively in virtual environment 120 through new DTw 122 configurations as the product is operated. Multiple digital twins may be created to evaluate the future performance of the physical assembly or its component parts based on specific performance metrics. Simulations are conducted with various control policies to assess the impact on performance objectives and costs. The outcome of these simulations helps in deciding which specific control policies should be implemented (e.g., tail volume coefficients and sideslip angle for an airplane product). The digital twin DE models (e.g., 182) are continuously updated and refined using the latest sensor data, control policies, and performance metrics to enhance their predictive accuracy. This iterative process ensures that the digital twins (e.g., 122, 156) provide reliable predictions of future performance and assist in making informed decisions.

The hardware components making up IDMP 100 (e.g., servers, computing devices, storage devices, network links) may be centralized or distributed among various entities, including one or more DE service providers and DE clients, as further discussed in the context of FIGS. 3 and 4. FIG. 4 shows an illustration of various potential configurations for instancing a DE platform within a customer's physical system and information technology (IT) environment, usually a virtual private cloud (VPC) protected by a firewall.

DE Documentation with Live or Magic Documents

The methods and systems described herein enable the updating and generation of DE documents using the full functionality of the IDEP shown in FIG. 1. In FIG. 1, the IDEP virtual feedback loop 104 allows the scripting of program code within a digital thread 162 for the generation, storing, and updating of digital twins 122 and twin configurations 156. Similarly, the IDEP virtual feedback loop 104 also allows the scripting of program code within a digital thread 162 for the generation, storing, and updating of DE documents. This enables the creation and maintenance of so-called live digital engineering documents.

Live DE documents are more akin to a DTw than a conventional static document in that they are configured, through a digital thread, to be continuously updated to reflect the most current changes within a particular twin configuration. In particular, an authoritative live DE document is configured to reflect the latest authoritative twin configuration. The “printing” of a live DE document corresponds to the generation of a frozen (i.e., static) time-stamped version of a live DE document. Therefore, “printing”—for a live DE document—is equivalent to “instantiation” for a DTw.

Live DE documents may also be known as magic documents as changes implemented within a twin configuration (e.g., through a modification of a model file) may appear instantaneously within the relevant data fields and sections of the live DE document. Similarly, authoritative live DE documents may also be known as authoritative magic documents as they continuously reflect data from the authoritative twin, thus always representing the authoritative source of truth.

Given the massive quantities of data and potential modifications that are carried out during a product's lifecycle, the scripts implementing live DE documentation may be configured to allow for a predefined maximum delay between the modification of a model file and the execution of the corresponding changes within a live DE document. Moreover, for similar reasons, the scripts implementing live DE documentation may be restricted to operate over a specified subset of model files within a DTw, thus reflecting changes only to key parameters and configurations of the DTw.

In one embodiment of the present invention, an IDEP script (e.g., an IDEP application) having access to model data via one or more model splices and DE document templates to create and/or update a live DE document may dynamically update the live DE document using software-defined digital threads over an IDEP platform. In such an embodiment, the IDEP script may receive user interactions dynamically. In response to the user updating data for a model and/or a specific parameter setting, the IDEP script may dynamically propagate the user's updates into the DE document through a corresponding digital thread.

In another embodiment of the present invention, the IDEP script may instantiate a DE document with sufficient specification to generate a physical twin (PTw). In such an embodiment, the IDEP script may receive a digital twin configuration of a physical twin, generate a live DE document associated with the digital twin configuration, receive a predetermined timestamp, and generate a printed DE document (i.e., a static, time-stamped version of the live DE document at the predetermined timestamp). Such an operation may be referred to as the “printing of a digital twin”.

In yet another embodiment of the present invention, an IDEP script may instantiate (i.e., “print”) a DE document specifying an updated digital twin upon detecting the update. In such an embodiment, the IDEP script may detect a modification of a DE model or an associated digital thread. In response to detecting the modification, the IDEP script may update relevant data fields and sections of the live DE document based on the detected modification, and generate an updated printed DE document with the updated relevant data fields and sections based on the always-updated live DE document.

In various embodiments, a software-defined digital thread can be associated with a companion magic document (or “magic doc”) that encompasses live updates for one or more core parameters of the digital thread. In one embodiment, the magic doc includes key parameters describing the implementation of a user's intent. For example, in one embodiment, a companion magic doc for a given digital thread may include key data points and key orchestration script examples illustrating a user's intent (e.g., “increase a drone's wingspan by 1%”). In one embodiment, a script-generating ML model receiving as input pseudocode or detailed user instructions derived from a user's intent is trained on prior IDEP digital threads and documents. In addition to generating a digital thread (with orchestration scripts and comments), the script-generating ML model is also configured to generate a magic doc that explains how the generated digital thread addresses the user intent.

In some embodiments, receiving user interactions with a DE model, modifications to a DE model, or modifications to an associated digital thread, may be carried out through a push configuration, where a model splicer or a script of the digital thread sends any occurring relevant updates to the IDEP script immediately or within a specified maximum time delay. In other embodiments, receiving user interactions with a DE model, modifications of a DE model, or modifications of an associated digital thread, may be carried out through a pull configuration, where a model splicer or a script of the digital thread flag recent modifications until the IDEP script queries relevant DE models (via their model splices) or associated digital threads, for flagged modification. In these embodiments, the IDEP script may extract the modified information from the modified DE models (via their model splices) or the modified digital threads, in order to update a live DE document. In yet other embodiments, receiving user interactions with a DE model, modifications of a DE model, or modifications of an associated digital thread, may be carried out through a pull configuration, where the IDEP script regularly checks relevant DE models (via their model splices) or associated digital threads, for modified data fields, by comparing the data found in the live DE document with regularly extracted model and digital thread data. In these embodiments, the IDEP script may use the modified data to update the live DE document.

### Dynamic Document Updates

Some embodiments described herein center around documentation, or document preparation and update and on document management (e.g., for reviews). As discussed, some embodiments of the system allow for dynamic updates to documents, which pertain to software-defined digital threads in the IDEP platform and the accompanying documentation.

Use of an ML engine with the model data and templates to create and/or update documents almost instantaneously as a one-time action have been presented. Furthermore, the digital engineering platform interacts dynamically with the user. As the user interacts with the system and updates data for a model or a specific parameter setting, these changes may be propagated through the corresponding digital threads and to the associated documentation. The AI architectures involved include locally-instanced large language model (LLMs, for data security reasons) as well as non-LLM approaches (e.g., NLP-based), in order to create, update, or predict documentation in the form of sentences, paragraphs, and whole documents. At the same time, trying to update the entire system of digital threads for every update may be prohibitively slow and may present security risks to the system. Generating live DE documents that are updated based on a subset of a system's DE models and within a maximum time delay may therefore be more efficient.

### Interconnected Digital Engineering and Certification Ecosystem

FIG. 2 shows an exemplary implementation of the IDEP as an interconnected digital engineering (DE) and certification ecosystem 200, and exemplary digitally certified products, in accordance with some embodiments of the present invention. Interconnected DE and certification ecosystem 200 may be viewed as a particular instantiation or implementation of IDEP 100 shown in FIG. 1. The IDEP may also be referred to as a “DE Metaverse.”

Interconnected DE and certification ecosystem 200 is a computer-based system that links models and simulation tools with their relevant requirements in order to meet verification, validation, and certification purposes. Verification refers to methods of evaluating whether a product, service, or system meets specified requirements and is fit for its intended purpose. For example, in the aerospace industry, a verification process may include testing an aircraft component to ensure it can withstand the forces and conditions it will encounter during flight. Verification also includes checking externally against customer or stakeholder needs. Validation refers to methods of evaluating whether the overall performance of a product, service, or system is suitable for its intended use, including its compliance with regulatory requirements and its ability to meet the needs of its intended users. Validation also includes checking internally against specifications and regulations. Interconnected DE and certification ecosystem 200 as disclosed herein is designed to connect and bridge large numbers of disparate DE tools and models from multitudes of engineering domains and fields, or from separate organizations who may want to share models with each other but have no interactions otherwise. In various embodiments, the system implements a robust, scalable, and efficient DE model collaboration platform, with extensible model splices having data structures and accompanying functions for widely distributed DE model types and DE tools, an application layer that links or connects DE models via APIs, digital threads that connect live engineering model files for collaboration and sharing, digital documentation management to assist with the preparation of engineering and certification documents appropriate for verification and validation (V&V) purposes, and AI-assistance with the functionalities of the aforementioned system components.

More specifically, FIG. 2 shows an example of an interconnected DE and certification ecosystem and examples of digitally certified products 212A, 212B, and 212C (collectively referred to as digitally certified products 212). For example, in some implementations, digitally certified product 212A may be an unmanned aerial vehicle (UAV) or other aircraft, digitally certified product 212B may be a drug or other chemical or biologic compound, and the digitally certified product 212C may be a process such as a manufacturing process. In general, the digitally certified products 212 can include any product, process, or solution that can be developed, tested, or certified (partially or entirely) using DE tools such as 202. In some implementations, digitally certified products 212 may not be limited to physical products, but can include non-physical products such as methodologies, processes and software, etc. While physical and physically-interacting systems often require multiple DE tools to assess for compliance with common V&V products simply by virtue of the need for modeling and simulation (M&S), many complex non-physical systems may also require multiple DE tools for product development, testing, and/or certification. With this in mind, various other possibilities for digitally certified products will be recognized by one of ordinary skills in the art. The inclusion of regulatory and certification standards, compliances, calculations, and tests (e.g., for the development, testing, and certification of products and/or solutions) enables users to incorporate relevant regulatory and certification standards, compliances, calculations, and test data directly into their DE workflow. Regulatory and certification standards, compliances, calculations, and tests are sometimes referred to herein as “common validation and verification (V&V) products.”

Digitally certified products 212 in FIG. 2 may be designed and/or certified using interconnected DE and certification ecosystem 200. Interconnected DE and certification ecosystem 200 may include a user device 206A, API 206B, or other similar human-to-machine, or machine-to-machine communication interfaces operated by a user. A user may be a human 204 of various skill levels, or artificial users such as algorithms, artificial intelligence, or other software that interface with ecosystem 200 through API 206B. Ecosystem 200 may further comprise a computing and control system 208 (“computing system 208” hereinafter) connected to and/or including a data storage unit 218, an artificial intelligence (AI) engine 220, and an application and service layer 222. In some embodiments, the artificial intelligence (AI) engine 220 is a machine learning (ML) engine. References to “machine learning engine 220” or “ML engine 220” may be extended to artificial intelligence (AI) engine 220 more generally. For the purposes of clarity, any user selected from various potential human or artificial users are referred to herein simply as the user 204. In some implementations, computing system 208 may be a centralized computing system; in some implementations, computing system 208 may be a distributed computing system. In some cases, user 204 may be considered part of ecosystem 200, while in other implementations, user 204 may be considered separately from ecosystem 200. Ecosystem 200 may include one or more DE tools 202, such as data analysis tool 202A, computer-aided design (CAD) and finite element analysis (FEA) tool 202B, simulation tool 202C, drug modeling and simulation (M&S) tools 202D-202E, manufacturing M&S tools 202F-202G, etc. Ecosystem 200 may also include a repository of common V&V products 210, such as regulatory standards 210A-210F related to the development and certification of a UAV, medical standard 210G (e.g., CE marking (Europe), FCC Declaration of Conformity (USA), IECEE CB Scheme (Europe, North America, parts of Asia & Australia), CDSCO (India), FDA (USA), etc.), medical certification regulation 210H (e.g., ISO 13485, ISO 14971, ISO 9001, ISO 62304, ISO 10993, ISO 15223, ISO 11135, ISO 11137, ISO 11607, IEC 60601, etc.), manufacturing standard 210I (e.g., ISO 9001, ISO 9013, ISO 10204, EN 1090, ISO 14004, etc.), and manufacturing certification regulation 210J (e.g., General Certification of Conformity (GCC), etc.), etc.

In FIG. 2, computing system 208 is centrally disposed within the architecture and is configured to communicate with (e.g., receive data from and transmit data to) user device 206A or API 206B such as an API associated with an artificial user, DE tools 202 via an API or software development kit (SDK) 214, and repository of common V&V products 210 via an API/SDK interface 216. For example, computing system 208 may be configured to communicate with user device 206A and/or API 206B to send or receive data corresponding to a prototype of a design, information about a user (e.g., user credentials), engineering-related inputs/outputs associated with DE tools 202, digitized common V&V products, an evaluation of a product design, user instructions (e.g., search requests, data processing instructions, etc.), and more. Computing system 208 may also be configured to communicate with one or more DE tools 202 to send engineering-related inputs for executing analyses, models, simulations, tests, etc. and to receive engineering-related outputs associated with the results. Computing system 208 may also be configured to communicate with repository of common V&V products 210 to retrieve data corresponding to one or more digitized common V&V products 210 and/or upload new common V&V products, such as those received from user 204, to repository of common V&V products 210. All communications may be transmitted and corroborated securely, for example, using methods relying on zero-trust security. In some implementations, the computing system of the ecosystem may interface with regulatory and/or certification authorities (e.g., via websites operated by the authorities) to retrieve digitized common V&V products published by the regulatory authorities that may be relevant for a product that a user is designing. In some implementations, the user may upload digitized common V&V products to the ecosystem themselves.

Computing and control system 208 may process and/or store the data that it receives to perform analysis and control functionalities, and in some implementations, may access machine learning engine 220 and/or application and service layer 222, to identify useful insights based on the data, as further described herein. The central disposition of computing system 208 within the architecture of the ecosystem has many advantages including reducing the technical complexity of integrating the various DE tools; improving the product development experience of user 204; intelligently connecting common V&V products such as standards 210A-210F to DE tools 202 most useful for satisfying requirements associated with the common V&V products; and enabling the monitoring, storing, and analysis of the various data that flows between the elements of the ecosystem throughout the product development process. In some implementations, the data flowing through and potentially stored by the computing system 208 can also be auditable to prevent a security breach, to perform data quality control, etc. Similarly, any analysis and control functions performed via computing system 208 may be tracked for auditability and traceability considerations.

Referring to one particular example shown in FIG. 2, user 204 may use the DE and certification ecosystem to produce a digitally certified UAV 212B. For example, user 204 may be primarily concerned with certifying the UAV as satisfying the requirements of a particular regulatory standard 210E relating to failure conditions of the UAV (e.g., “MIL-HDBK 516C 4.1.4—Failure Conditions”). In this usage scenario, user 204 may develop a digital prototype of the UAV on user device 206A or using API 206B and may transmit prototype data (e.g., as at least one of a CAD file, a MBSE file, etc.) to computing system 208. Along with the prototype data, user 204 can transmit, via user device 206A, additional data including an indication of the common V&V product that user 204 is interested in certifying the product for (e.g., regulatory standard 210E), user credential information for accessing one or more capabilities of computing system 208, and/or instructions for running one or more digital models, tests, and/or simulations using a subset of DE tools 202.

Referring to another example shown in FIG. 2, user 204 can use the DE and certification ecosystem to produce a digitally certified drug, chemical compound, or biologic 212A. For example, user 204 may be primarily concerned with certifying drug, chemical compound, or biologic 212A as satisfying the requirements of a particular medical standard 210G and medical certification regulation 210H. In this usage scenario, user 204 can develop a digital prototype of the drug, chemical compound, or biologic on user device 206A or using API 206B and can transmit the prototype data (e.g., as a molecular modeling file) to computing system 208. Along with the prototype data, user 204 can transmit, via user device 206A, additional data including an indication of the common V&V products that user 204 is interested in certifying the product for (e.g., medical standard 210G and medical certification regulation 210H), user credential information for accessing one or more capabilities of computing system 208, and/or instructions for running one or more digital models, tests, and/or simulations using a subset of DE tools 202 (e.g., drug M&S tools 202D-202E).

Referring to yet another example shown in FIG. 2, user 204 can use the digital engineering and certification ecosystem to produce a digitally certified manufacturing process 212C. For example, user 204 may be primarily concerned with certifying manufacturing process 212C as satisfying the requirements of a particular manufacturing standard 210I and manufacturing certification regulation 210J. In this usage scenario, user 204 can develop a digital prototype of the manufacturing process on user device 206A or using API 206B and can transmit the prototype data to computing system 208. Along with the prototype data, user 204 can transmit, via the user device 206A, additional data including an indication of the common V&V products that user 204 is interested in certifying the process for (e.g., manufacturing standard 210I and manufacturing certification regulation 210J), user credential information for accessing one or more capabilities of computing system 208, and/or instructions for running one or more digital models, tests, and/or simulations using a subset of DE tools 202 (e.g., manufacturing M&S tools 202F-202G).

In any of the aforementioned examples, computing system 208 can receive the data transmitted from user device 206A and/or API 206B and can process the data to evaluate whether the common V&V product of interest (e.g., regulatory standard 210E, medical standard 210G, medical certification regulation 210H, manufacturing standard 210I, manufacturing certification regulation 210J, etc.) is satisfied by the user's digital prototype, in the context of analysis and control plane 150 shown in FIG. 1. For example, this can involve communicating with the repository of common V&V products 210 via the API/SDK 216 to retrieve the relevant common V&V product of interest and processing the regulatory and/or certification data associated with the common V&V product to identify one or more requirements for the UAV prototype; the drug, chemical compound, or biologic prototype; the manufacturing process prototype; etc. In some implementations, repository of common V&V products 210 can be hosted by a regulatory and/or certification authority (or another third party), and retrieving the regulatory and/or certification data can involve using API/SDK 216 to interface with one or more data resources maintained by the regulatory and/or certification authority (or another third party). In some implementations, the regulatory and/or certification data can be provided directly by user 204 via user device 206A and/or API 206B (e.g., along with the prototype data).

Evaluating whether the common V&V product of interest is satisfied by the user's digital prototype can also involve processing the prototype data received from user device 206A or API 206B to determine if the one or more identified requirements are actually satisfied. In some implementations, computing system 208 can include one or more plugins, local applications, etc. to process the prototype data directly at the computing system 208. For example, model splicing and digital threading applications are discussed in detail later with reference to FIG. 6 to 9. In some implementations, the computing system can simply pre-process the received prototype data (e.g., to derive inputs for DE tools 202) and can then transmit instructions and/or input data to a subset of DE tools 202 via API/SDK 214 for further processing.

Not all DE tools 202 are necessarily required for the satisfaction of particular regulatory and/or certification standards. Therefore, in the UAV example provided in FIG. 2, computing system 208 may determine that only a data analysis tool 202A and a finite element analysis tool 202B are required to satisfy regulatory standard 210E for failure conditions. In the drug, chemical compound, or biologic example provided in FIG. 2, computing system 208 may determine that only drug M&S tools 202D-202E are required to satisfy medical standard 210G and medical certification regulation 210H. In the manufacturing process example provided in FIG. 2, computing system 208 may determine that only manufacturing M&S tools 202F-202G are required to satisfy manufacturing standard 210I and manufacturing certification regulation 210J. In other implementations, user 204 may themselves identify the particular subset of DE tools 202 that should be used to satisfy the common V&V product of interest, provided that user 204 is a qualified subject matter expert (SME). In other implementations, user 204 may input to computing system 208 some suggested DE tools 202 to satisfy a common V&V product of interest, and computing system 208 can recommend to user 204 a modified subset of DE tools 202 for final approval by user 204, provided that user 204 is a qualified SME. After a subset of DE tools 202 has been identified, computing system 208 can then transmit instructions and/or input data to the identified subset of DE tools 202 to run one or more models, tests, and/or simulations. The results (or “engineering-related data outputs” or “digital artifacts”) of these models, tests, and/or simulations can be transmitted back and received at computing system 208.

In still other implementations, user 204 may input a required DE tool such as 202F for meeting a common V&V product 210I, and the computing system 208 can determine that another DE tool such as 102G is also required to satisfy common V&V product 210I. The computing system can then transmit instructions and/or input data to both DE tools (e.g., 202F and 202G), and the outputs of these DE tools can be transmitted and received at computing system 208. In some cases, the input data submitted to one of the DE tools (e.g., 202G) can be derived (e.g., by computing system 208) from the output of another of the DE tools (e.g., 202F).

After receiving engineering-related data outputs or digital artifacts from DE tools 202, computing system 208 can then process the received engineering-related data outputs to evaluate whether or not the requirements identified in the common V&V product of interest (e.g., regulatory standard 210E, medical standard 2110G, medical certification regulation 210H, manufacturing standard 210I, manufacturing certification regulation 210J, etc.) are satisfied. For example, applications and services 222 may provide instructions for orchestrating validation or verification activities. In some implementations, computing system 208 can generate a report summarizing the results of the evaluation and can transmit the report to device 206A or API 206B for review by user 204. If all of the requirements are satisfied, then the prototype can be certified, resulting in digitally certified product 212 (e.g., digitally certified drug, chemical compound, or biologic 212A; digitally certified UAV 212B; digitally certified manufacturing process 212C, etc.). However, if some of the regulatory requirements are not satisfied, then additional steps may need to be taken by user 204 to certify the prototype of the product. In some implementations, the report that is transmitted to the user can include recommendations for these additional steps (e.g., suggesting one or more design changes, suggesting the replacement of one or more components with a previously designed solution, suggesting one or more adjustments to the inputs of the models, tests, and/or simulations, etc.). If the requirements of a common V&V product are partially met, or are beyond the collective capabilities of distributed engineering tools 202, computing systems 208 may provide user 204 with a report recommending partial certification, compliance, or fulfillment of a subset of the common V&V products (e.g., digital certification of a subsystem or a sub-process of the prototype). The process of generating recommendations for user 204 is described in further detail below.

In response to reviewing the report, user 204 can make design changes to the digital prototype locally and/or can send one or more instructions to computing system 208 via user device 206A or API 206B. These instructions can include, for example, instructions for computing system 208 to re-evaluate an updated prototype design, use one or more different DE tools 202 for the evaluation process, and/or modify the inputs to DE tools 202. Computing system 208 can, in turn, receive the user instructions, perform one or more additional data manipulations in accordance with these instructions, and provide user 204 with an updated report. Through this iterative process, user 204 can utilize the interconnected digital engineering and certification ecosystem to design and ultimately certify (e.g., by providing certification compliance information) the prototype (e.g., the UAV prototype, drug prototype, manufacturing process prototype, etc.) with respect to the common V&V product of interest. Importantly, since all of these steps occur in the digital world (e.g., with digital prototypes, digital models/tests/simulations, and digital certification), significant amount of time, cost, and materials can be saved in comparison to a process that would involve the physical prototyping, evaluation and/or certification of a similar UAV, drug, manufacturing process, etc. If the requirements associated with a common V&V product are partially met, or are beyond the collective capabilities of DE tools 202, computing system 208 may provide user 204 with a report recommending partial certification, compliance or fulfillment of a subset of the common V&V products (e.g., digital certification of a subsystem or a sub-process of the prototype).

While the examples described above focus on the use of the interconnected digital engineering and certification ecosystem by a single user, additional advantages of the ecosystem can be realized through the repeated use of the ecosystem by multiple users. As mentioned above, the central positioning of computing system 208 within the architecture of the ecosystem enables computing system 208 to monitor and store the various data flows through the ecosystem. Thus, as an increasing number of users utilize the ecosystem for digital product development, data associated with each use of the ecosystem can be stored (e.g., in storage 218), traced (e.g., with metadata), and analyzed to yield various insights, which can be used to further automate the digital product development process and to make the digital product development process easier to navigate for non-subject matter experts.

Indeed, in some implementations, user credentials for user 204 can be indicative of the skill level of user 204, and can control the amount of automated assistance the user is provided. For example, non-subject matter experts may only be allowed to utilize the ecosystem to browse pre-made designs and/or solutions, to use DE tools 202 with certain default parameters, and/or to follow a predetermined workflow with automated assistance directing user 204 through the product development process. Meanwhile, more skilled users may still be provided with automated assistance, but may be provided with more opportunities to override default or suggested workflows and settings.

In some implementations, computing system 208 can host applications and services 222 that automate or partially automate components of common V&V products; expected or common data transmissions, including components of data transmissions, from user 204; expected or common interfaces and/or data exchanges, including components of interfaces, between various DE tools 202; expected or common interfaces and/or data exchanges, including components of interfaces, with machine learning (ML) models implemented on computing system 208 (e.g., models trained and/or implemented by the ML engine 220); and expected or common interfaces and/or data exchanges between the applications and services themselves (e.g., within applications and services layer 222).

In some implementations, the data from multiple uses of the ecosystem (or a portion of said data) can be aggregated to develop a training dataset. For example, usage records 217 collected via computing system 208 may be de-identified or anonymized, before being added to the training set. Such usage records may comprise model parameters and metadata, tool configurations, common V&V product matching to specific models or tools, user interactions with the system including inputs and actions, and other user-defined or system-defined configurations or decisions in using the ecosystem for digital engineering and certification. For instance, an exemplary de-identified usage record may comprise the combination of a specific DE tool, a specific target metric, a specific quantity deviation, and a corresponding specific user update to a DE model under this configuration. Another exemplary de-identified usage record may comprise a user-identified subset of DE tools 202 that should be used to satisfy a common V&V product of interest.

This training dataset can then be used to train ML models (e.g., using ML engine 220) to learn the steps and actions for certification processes and to perform a variety of tasks including the identification of which of DE tools 202 to use to satisfy a particular common V&V product; the identification of specific models, tests, and/or simulations (including inputs to them) that should be performed using DE tools 202; the identification of the common V&V products that need to be considered for a product of a particular type; the identification of one or more recommended actions for user 204 to take in response to a failed regulatory requirement; the estimation of model/test/simulation sensitivity to particular inputs; etc. The outputs of the trained ML models can be used to implement various features of the interconnected digital engineering and certification ecosystem including automatically suggesting inputs (e.g., inputs to DE tools 202) based on previously entered inputs, forecasting time and cost requirements for developing a product, predictively estimating the results of sensitivity analyses, and even suggesting design changes, original designs or design alternatives (e.g., via assistive or generative AI) to a user's prototype to overcome one or more requirements (e.g., regulatory and/or certification requirements) associated with a common V&V product. In some implementations, with enough training data, ML engine 220 may generate new designs, models, simulations, tests, common V&V products and/or digital threads on its own based on data collected from multiple uses of the ecosystem. Furthermore, such new designs, models, simulations, tests, common V&V products and digital threads generated by ML engine 220, once approved and adjusted by a user, may be added to the training set for further fine-tuning of ML algorithms in a reinforcement learning setup.

As shall be discussed in the context of FIGS. 7 to 9, the aforementioned collection of training datasets and the training of ML and AI modules including ML engine 220 may be enabled by model splicing technologies. Model splicing, as described herein, allows the scripting of DE model operations encompassing disparate DE tools into a corpus of normative program code, and facilitates the code-defined digital threading of a large space of DE activities involving DE models across different disciplines. ML and AI techniques may be used to create scripts to carry out almost any DE task and to execute any digital thread, allowing for programmable, machine-learnable, and dynamic changes to DE model files, digital threads, and ultimately to digital or physical twins, throughout the product life cycle. For example, in the embodiment shown in FIG. 2, ML engine 220 may manage or orchestrate the interactions between spliced DE models, DE tools, and common V&V products (e.g., DE requirements), based on digital thread options specific to user's intent and input. Sample DE tasks that may be carried out by ML engine 220 include, but are not limited to, (1) aligning models/analysis to certification lifecycle requirement steps, (2) optimizing compute by determining the appropriate fidelity of each model, (3) optimizing compute resources for specific tools/models, or (4) optimizing compute resources across multiple models. ML-enabled executions of DE tasks are not limited to certification or resource optimization, but encompass the whole DE space of operations. Rather, ML engine 220 may act as an AI multiplexer for the DE platform.

In addition to storing usage data to enable the development of ML models, previous prototype designs and/or solutions (e.g., previously designed components, systems, models, simulations and/or other engineering representations thereof) can be stored within the ecosystem (e.g., in storage 218) to enable users to search for and build upon the work of others. For example, previously designed components, systems, models, simulations and/or other engineering representations thereof can be searched for by user 204 and/or suggested to user 204 by computing system 208 in order to satisfy one or more requirements associated with a common V&V product. The previously designed components, systems, models, simulations and/or other engineering representations thereof can be utilized by user 204 as is, or can be utilized as a starting point for additional modifications. This store, or repository, of previously designed components, systems, models, simulations and/or other engineering representations thereof (whether or not they were ultimately certified) can be monetized to create a marketplace of digital products, which can be utilized to save time during the digital product development process, inspire users with alternative design ideas, avoid duplicative efforts, and more. In some implementations, data corresponding to previous designs and/or solutions may only be stored if the user who developed the design and/or solution opts to share the data. In some implementations, the repository of previous designs and/or solutions can be containerized for private usage within a single company, team, organizational entity, or technical field for private usage (e.g., to avoid the unwanted disclosure of confidential information). In some implementations, user credentials associated with user 204 can be checked by computing system 208 to determine which designs and/or solutions stored in the repository can be accessed by user 204. In some implementations, usage of the previously designed components, systems, models, simulations and/or other engineering representations thereof may be available only to other users who pay a fee for a usage.

Exemplary IDEP Implementation Architecture with Services and Features

FIG. 3 shows another exemplary implementation of the IDEP illustrating its offered services and features, in accordance with some embodiments of the present invention. Specifically, an exemplary implementation architecture diagram 300 is shown in FIG. 3 to include multiple illustrative components: an IDEP enclave 302, cloud services 304, and a customer environment 310 which optionally includes an IDEP exclave 316. This exemplary architecture 300 for the IDEP is designed in accordance with zero-trust security principles and is further designed to support scalability as well as robust and resilient operations. IDEP enclave 302 and IDEP exclave 316 together instantiate IDEP 100 shown in FIG. 1, with IDEP exclave 316 implementing model splicing and splice plane 170 in some embodiments of the present invention. An enclave is an independent set of cloud resources that are partitioned to be accessed by a single customer (i.e., single-tenant) or market (i.e., multi-tenant) that does not take dependencies on resources in other enclaves. An exclave is a set of cloud resources outside enclaves managed by the IDEP, to perform work for individual customers. Examples of exclaves include virtual machines (VMs) and/or servers that the IDEP maintains to run DE tools for customers who need such services.

In particular, IDEP enclave or DE platform enclave 302 may serve as a starting point for services rendered by the IDEP, and may be visualized as a central command and control hub responsible for the management and orchestration of all platform operations. For example, enclave 302 may be implemented using computer system 208 of the interconnected DE and certification ecosystem shown in FIG. 2. DE platform enclave 302 is designed to integrate both zero-trust security models and hyperscale capabilities, resulting in a secure and scalable processing environment tailored to individual customer needs. Zero-trust security features include, but are not limited to, strict access control, algorithmic impartiality, and data isolation. Enclave 302 also supports an ML engine such as 220 for real-time analytics, auto-scaling features for workload adaptability, and API-based interoperability with third-party services. Security and resource optimization are enhanced through multi-tenancy support, role-based access control, and data encryption both at rest and in transit. DE platform enclave 302 may also include one or more of the features described below.

First, IDEP enclave 302 may be designed in accordance with zero-trust security principles. In particular, DE platform enclave 302 may employ zero-trust principles to ensure that no implicit trust is assumed between any elements, such as digital models, platform agents or individual users (e.g., users 204) or their actions, within the system. That is, no agent may be inherently trusted and the system may always authenticate or authorize for specific jobs. The model is further strengthened through strict access control mechanisms, limiting even the administrative team (e.g., a team of individuals associated with the platform provider) to predetermined, restricted access to enclave resources. To augment this robust security stance, data encryption is applied both at rest and in transit, effectively mitigating risks of unauthorized access and data breaches.

IDEP enclave 302 can also be designed to maintain isolation and independence. A key aspect of the enclave's architecture is its focus on impartiality and isolation. DE enclave 302 disallows cryptographic dependencies from external enclaves and enforces strong isolation policies. The enclave's design also allows for both single-tenant and multi-tenant configurations, further strengthening data and process isolation between customers 306 (e.g., users 204). Additionally, DE enclave 302 is designed with decoupled resource sets, minimizing interdependencies and thereby promoting system efficiency and autonomy.

IDEP enclave 302 can further be designed for scalability and adaptability, aligning well with varying operational requirements. For example, the enclave 302 can incorporate hyperscale-like properties in conjunction with zero-trust principles to enable scalable growth and to handle high-performance workloads effectively.

IDEP enclave 302 can further be designed for workflow adaptability, accommodating varying customer workflows and DE models through strict access control mechanisms. This configurability allows for a modular approach to integrate different functionalities ranging from data ingestion to algorithm execution, without compromising on the zero-trust security posture. Platform 300's adaptability makes it highly versatile for a multitude of use-cases, while ensuring consistent performance and robust security.

IDEP enclave 302 can further be designed to enable analytics for robust platform operations. At the core of the enclave's operational efficiency is a machine learning engine (e.g., machine learning engine 220) capable of performing real-time analytics. This enhances decision-making and operational efficiency across platform 300. Auto-scaling mechanisms can also be included to enable dynamic resource allocation based on workload demand, further adding to the platform's responsiveness and efficiency.

In the exemplary embodiment shown in FIG. 3, IDEP enclave 302 includes several components as described in further detail herein.

A “Monitoring Service Cell. may provide “Monitoring Service” and “Telemetry Service.” A cell may refer to a set of microservices, for example, a set of microservices executing within a kubernetes pod. These components focus on maintaining, tracking and analyzing the performance of platform 300 to ensure good service delivery, including advanced machine learning capabilities for real-time analytics. A “Search Service Cell” provides “Search Service” to aid in the efficient retrieval of information from DE platform 300, adding to its overall functionality. A “Logging Service Cell” and a “Control Plane Service Cell” provides “Logging Service,” “File Service”, and “Job Service” to record and manage operational events and information flow within platform 300, and are instrumental in the functioning of platform 300. A “Static Assets Service Cell,” provides “Statics Service”, and may house user interface, SDKs, command line interface (CLI), and documentation for platform 300. An “API Gateway Service Cell” provides “API Gateway Service,” and may provide DE platform API(s) (e.g., APIs 214, 216) and act as a mediator for requests between the client applications (e.g., DE tools 202, the repository of common V&V products 210, etc.) and the platform services. In some embodiments, the API gateway service cell may receive and respond to requests from agents such as DE platform exclave 316 to provide splice functions for model splicing purposes.

As shown in FIG. 3, the architecture of DE platform 300 may also include a cloud services 304 that provide services which cannot interact with customer data but can modify the software for the orchestration of DE platform operations. In example implementations, several cloud resources provide support and foundational services to the platform. For example, in the embodiment of the DE platform 300 shown in FIG. 3, cloud services 304 includes a “Customer Identity and Access Management (JAM) Service” that ensures secure and controlled access to platform 300. Cloud services 304 also includes a “Test Service” that tests tools to validate platform operations. In the context of software testing, the Test Service can be thought of as the execution layer that manages and orchestrates the different types of tests on the platform. The Test Service may utilize the test scripts generated, and additionally has functionality to generate tests for specific UI or API level testing. Cloud services 304 may also include an “Orchestration Service” that controls and manages the lifecycle of containers on the platform 300. Cloud services 304 may also include an “Artifact Service” and “Version Control and Build Services,” which may be used to maintain the evolution of projects, codes, and instances in the system, while also managing artifacts produced during the product development process.

As shown in FIG. 3, the architecture of DE platform 300 may also include a customer environment 310 with an “Authoritative Source of Truth” 312, customer tools 314, and an optional DE platform exclave 316. Customer environment 310 is where customer data resides and is processed in a zero-trust manner by DE platform 300. As described previously, DE platform enclave 302, by focusing on both zero-trust principles and hyperscale-like properties, provides a robust and scalable environment for the secure processing of significant workloads, according to the customer's unique needs. In some examples, DE platform exclave 316 may be situated within customer environment 310 in order to assist the customer(s) 306 with their DE tasks and operations, including model splicing and digital threading.

When a customer 306 (e.g., user 204) intends to perform a DE task using DE platform 300 (e.g., IDEP 100), typical operations may include secure data ingestion and controlled data retrieval. Derivative data generated through the DE operations, such as updated digital model files or revisions to digital model parameters, may be stored only within customer environment 310, and DE platform 300 may provide tools to access the metadata of the derivative data. Here metadata refers to data that can be viewed without opening the original data, and may comprise versioning information, time stamps, access control properties, and the like. Example implementations may include secure data ingestion, which utilizes zero-trust principles to ensure customer data is securely uploaded to customer environment 310 through a pre-validated secure tunnel, such as Secure Socket Layer (SSL) tunnel. This can enable direct and secure file transfer to a designated cloud storage, such as a simple storage service (S3) bucket, within customer environment 310. Example implementations may also include controlled data retrieval, in which temporary, pre-authenticated URLs generated via secure token-based mechanisms are used for controlled data access, thereby minimizing the risk of unauthorized interactions. Example implementations may also include immutable derivative data, with transformed data generated through operations like data extraction being securely stored within customer environment 310 while adhering to zero-trust security protocols. Example implementations may also include tokenization utility, in which a specialized DE platform tool referred to as a “tokenizer” is deployed within customer environment 310 for secure management of derivative metadata, conforming to zero-trust guidelines.

Customer environment 310 may interact with other elements of secure DE platform 300 and includes multiple features that handle data storage and secure interactions with platform 300. For example, one element of the customer environment 310 is “Authoritative Source of Truth” 312, which is a principal repository for customer data, ensuring data integrity and accuracy. Nested within this are “Customer Buckets” where data is securely stored with strict access controls, limiting data access to authorized users or processes through pre-authenticated URL links. This setup ensures uncompromising data security within customer environment 310 while providing smooth interactions with other elements of DE platform 300.

Customer environment 310 may also include additional software tools such as customer tools 314 that can be utilized based on specific customer requirements. For example, a “DE Tool Host” component may handle necessary DE applications for working with customer data. It may include a DE Tools Command-Line Interface (DET CLI), enabling user-friendly command-line operation of DE tools (e.g., DE tools 102). A “DE platform Agent” ensures smooth communication and management between customer environment 310 and elements of DE platform 300. Furthermore, there can be another set of optional DE tools designed to assist customer-specific DE workflows. Native DE tools are typically access-restricted by proprietary licenses and end-user license agreements paid for by the customer. IDEP platform functions call upon native DE tools that are executed within customer environment 310, therefore closely adhering to the zero-trust principle of the system design. Exemplary DE tools include, but are not limited to, proprietary and open-source versions of model-based systems engineering (MBSE) tools, augmented reality (AR) tools, computer aided design (CAD) tools, data analytics tools, modeling and simulation (M&S) tools, product lifecycle management (PLM) tools, multi-attribute trade-space tools, simulation engines, requirements model tools, electronics model tools, test-plan model tools, cost-model tools, schedule model tools, supply-chain model tools, manufacturing model tools, cyber security model tools, or mission effects model tools.

In some cases, an optional “IDEP Exclave” 316 may be employed within customer environment 310 to assist with customer DE tasks and operations, supervise data processing, and rigorously adhering to zero-trust principles while delivering hyperscale-like platform performance. IDEP exclave 316 is maintained by the IDEP to run DE tools for customers who need such services. IDEP exclave 316 may contain a “DE Tool Host” that runs DE tools and a “DE Platform Agent” necessary for the operation. Again, native DE tools are typically access-restricted by proprietary licenses and end-user license agreements paid for by the customer. IDEP exclave 316 utilities and manages proprietary DE tools hosted with customer environment 310, for example, to implement model splicing and digital threading functionalities.

In some embodiments, the machine learning (ML) models and artificial intelligence (AI) assistance approaches as described herein adapt to suit different customer instances of the IDEP (see FIG. 4) and the availability of training data. In an example, a pre-trained ML or AI model (e.g., within the IDEP enclave 302) is deployed in instances where there are restrictions around sharing customer data. In another example, AI models are deployed in a federated manner adjacent to DE agents and DE tools in the customer environment (e.g., within IDEP exclave 316). In another example, an AI model deployed inside the customer environment is trained behind its firewalls. In yet another example, the customer may allow sharing of subsets of their metadata for a training database located within the IDEP enclave.

### IDEP Deployment Scenarios

FIG. 4 shows potential scenarios for instantiating an IDEP in connection to a customer's physical system and IT environment, in accordance with some embodiments of the present invention. Specifically, FIG. 4 illustrates various potential configurations for instancing or instantiating an IDEP (“DE platform) 402 in connection to a customer's IT environment and physical system 404. The IT environment may be located on a virtual private cloud (VPC) protected by a firewall. The physical system may refer to a physical twin as discussed with reference to FIG. 1. In some embodiments, IDEP 402 may be instanced as an enclave such as 302 shown in FIG. 3. For example, IDEP 402 may be instanced on the cloud, possibly in a software-as-a-service (SaaS) configuration. The platform instances in these embodiments include software and algorithms, and may be described as follows:
1. External Platform Instance 410: This option showcases the IDEP as a separate platform instance. The platform interacts with the physical system through the customer's virtual environment, or a Customer Virtual Private Cloud (“Customer VPC”), which is connected to the physical system.
2. External Platform Instance with Internal Agent 420: The IDEP is instantiated as a separate platform, connected to an internal agent (“DE Agent”) wholly instanced within the Customer VPC. For example, the IDEP may be instantiated as enclave 302, and the DE agent may be instantiated as exclave 316 within the Customer VPC linked to the physical system.
3. External Platform Instance with Internal Agent and Edge Computing 430: This scenario displays the IDEP as a separate instantiation, connected to an internal DE Agent wholly instanced within the Customer VPC, which is further linked to an edge instance (“DE Edge Instance”) on the physical system. The DE agent is nested within the customer environment, with a smaller edge computing instance attached to the physical system.
4. Edge Instance Connection 440: This option shows the DE platform linked directly to a DE edge instance on the physical system. The DE platform and the physical system are depicted separately, connected by an edge computing instance in the middle, indicating the flow of data.
5. Direct API Connection 450: This deployment scenario shows the DE platform connecting directly to the physical system via API calls. In this depiction, an arrow extends directly from the platform sphere to the physical system sphere, signifying a direct interaction through API.
6. Air-Gapped Platform Instance 460: This scenario illustrates the IDEP being completely instanced on an air-gapped, or isolated, physical system as a DE agent. The platform operates independently from any networks or Internet connections, providing an additional layer of security by eliminating external access points and potential threats. Interaction with the platform in this context would occur directly on the physical system, with any data exchange outside the physical system being controlled following strict security protocols to maintain the air-gapped environment.

Across these deployment scenarios, the IDEP plays an important role in bridging the gap between a digital twin (DTw) established through the IDEP and its physical counterpart. Regardless of how the IDEP is instantiated, it interacts with the physical system, directly or through the customer's virtual environment. The use of edge computing instances in some scenarios demonstrates the need for localized data processing and the trade-offs between real-time analytics and more precise insights in digital-physical system management. Furthermore, the ability of the platform to connect directly to the physical system through API calls underscores the importance of interoperability in facilitating efficient data exchange between the digital and physical worlds. In all cases, the DE platform operates with robust security measures.

In some embodiments, the IDEP deployment for the same physical system can comprise a combination of the deployment scenarios described above. For example, for the same customer, some physical systems may have direct API connections to the DE platform (scenario 5), while other physical systems may have an edge instance connection (scenario 4).

### Multimodal User Interfaces

FIG. 5 illustrates the use of multimodal user interfaces 590 for the interconnected DE platform, which can handle various input and output modalities such as Virtual Reality (VR), Mixed Reality (MR), auditory, text, and code. These interfaces are designed to manage the complexity of data streams and decision-making processes, and provide decision support including option visualization, impact prediction, and specific decision invocation. Specifically, data streams 502 and 504 are processed in the Analysis & Control Plane (ACP) 150 of FIG. 1. The user interface may receive data streams from physical and virtual feedback loops 102 and 104, as well as external expert feedback 114, analysis module 154, and twin configuration set 156 of ACP 150.

The multimodal interfaces illustrated in FIG. 5 are configured to carry out all the DE tasks and actions described in the context of FIG. 1, by catering to both humans and bots/algorithms, handling the intricacies of data stream frequency and complexity, decision-making time scales, and latency impacts. In the case of human decision makers, the user interface may need to manage inputs and outputs while for algorithmic decision making, the user interface may need to present rationale and decision analysis to human users. Some examples of human interfaces include a dashboard-style interface 594, a workflow-based interface 596, conversational interfaces 598, spatial computer interfaces 592, and code interfaces 599.

Dashboard-style interface 594 offers a customizable overview of data visualizations, performance metrics, and system status indicators. It enables monitoring of relevant information, sectional review of documents, and decision-making based on dynamic data updates and external feedback. Such an interface may be accessible via web browsers and standalone applications on various devices.

Workflow-based interface 596 guides users through the decision-making process, presenting relevant data, options, and contextual information at each stage. It integrates external feedback and is designed as a progressive web app or a mobile app. In the context of alternative tool selection, workflow-based interface 596 may provide options on individual tools at each stage, or provide combinations of tool selections through various stages to achieve better accuracy or efficiency for the overall workflow.

Conversational interfaces 598 are based on the conversion of various input formats such as text, prompt, voice, audio-visual, etc. into input text, then integrating the resulting input text within the DE platform workflow. Outputs from the DE platform may undergo the reverse process. This enables interoperability with the DE platform, and specifically the manipulation of model splices. In the broad context of audio-visual inputs, the conversational interfaces may comprise data sonification, which involves using sound to represent data, information, or events, and using auditory cues or patterns to communicate important information to users, operators, or reviewers. Sonified alerts (e.g., alerts sent via sound, e.g., via a speaker) are especially useful when individuals need to process information quickly without having to visually focus on a screen. For example, sonified alerts can be used to notify security analysts of potential threats or breaches.

FIG. 5 also illustrates the use of spatial computing interfaces 592 and code interfaces 599 in the management of DTws and PTws. Spatial computing interfaces allow for more immersive and intuitive user experiences, and enable real-time synchronization between DTws and PTws. Code interfaces allow bots and digital engineers to interact with the DE platform through scripting and code. It also allows the collection of user preference, task history, and tool usage patterns for alternative tool selection purposes.

### Digital Threads and Autonomous Data Linkages

As discussed previously, a “digital thread” is intended to connect two or more digital engineering (DE) models for traceability across the systems engineering lifecycle, and collaboration and sharing among individuals performing DE tasks. In a digital thread, appropriate outputs from a preceding digital model may be provided as the inputs to a subsequent digital model, allowing for information and process flow. That is, a digital thread may be viewed as a communication framework or data-driven architecture that connects traditionally siloed elements to enable the flow of information and actions between digital models.

FIG. 6 describes the architecture and inherent complexity of digital threads, in accordance with the examples disclosed herein. Specifically, FIG. 6 is a schematic diagram comparing exemplary digital threads 600 of various complexities that manipulate and/or connect DE models, in accordance with some embodiments of the present invention. In the most basic sense, a digital thread may “thread” together DE models into a simple daisy-chain architecture 602 where modifications in any upstream DE model will affect all DE models downstream from the modified DE model. For example, a modification of any parameter or process of a DE model B will cause changes in DE model C, which in turn will cause changes in DE model D. Cause-and-effect changes will therefore cascade downstream. As another example, diagram 604 represents a more complex digital thread where a change in one DE model may affect more than one downstream model. In both 602 and 604, digital threads are represented by a directed acyclic graph (DAG).

DAGs are frequently used in many kinds of data processing and structuring tasks, such as scheduling tasks, data compression algorithms, and more. In the context of service platforms and network complexities, a DAG might be used to represent the relationships between different components or services within the platform. In digital thread 604, different models may depend on each other in different ways. Model A may affect models B, C, and D, with models B and C affecting model E, and models D and E affecting model G. Such dependencies are denoted as a DAG, where each node is associated with a component (e.g., a model), and each directed edge represents a dependency.

A major issue with dealing with interdependent DE models is that graph consistencies can be polynomial, and potentially exponential, in complexity. Hence, if a node fails (e.g., a model is unreliable), this can have a cascading effect on the rest of the digital thread, disrupting the entire design. Furthermore, adding nodes or dependencies to the graph does not yield a linear increase in complexity because of the interdependencies between models. If a new model is added that affects or depends on several existing models, the resulting increase in graph complexity is multiplicative in nature, hence potentially exponential. The multiplicative nature of digital thread consistencies is compounded by the sheer number of interconnected models, which may number in the hundreds or thousands. Diagram 606 is a partial representation of a real-world digital thread, illustrating the complexity of digital threads and its multiplicative growth.

FIG. 6 further shows special cases 603, 605, 607, 608, and 609 of exemplary simple digital threads. Diagram 607 represents a degenerate digital thread where data is shared from a single DE model. Diagram 608 represents a model-to-document digital thread where data (e.g., system attributes, performance attributes) extracted from a single DE model may be used to generate or update a text-based document (e.g., a Capability Development Document (CDD)). Diagrams 603 and 605 are generalized from 608 to represent cases where data extracted from a single model may be used to update multiple models, or vice versa. Specifically, diagram 605 may represent the dynamic updates of live or magic documents discussed in the context of FIG. 1. Here, the logic to connect the DE models shown is clear: data are extracted from multiple DE models A, B, and C to update a document model D. There are no interactions between the extracted data. Furthermore, diagram 609 shows a special case of a digital thread where data is loaded to and extracted from only a single model A. For example, as discussed in the context of FIG. 7 next, input splice functions of the model A shown in 609 may be executed to update the model, and output splice functions of model A shown in 609 may be executed to produce digital artifacts for sharing. For these special simple threads, the IDEP may provide a GUI-based interface to the user to connect the models and execute the digital threads. For complex threads such as 606, a code-based interface may be necessary.

### Model Splicing for Digital Threading and Digital Twin Generation

As disclosed herein, model splicing encapsulates and compartmentalizes digital engineering (DE) model data and model data manipulation and access functionalities. As such, model splices provide access to selective model data within a DE model file without exposing the entire DE model file, with access control to the encapsulated model data based on user access permissions. Model splicing also provides the DE model with a common, externally-accessible Application Programming Interface (API) for the programmatic execution of DE models. Model splices thus generated may be shared, executed, revised, or further spliced independently of the native DE tool and development platform used to generate the input digital model. The standardization of DE model data and the generalization of API interfaces and functions allow the access of DE model type files outside of their native software environments, and enable the linking of different DE model type files that may not previously be interoperable. Model splicing further enables the scripting and codification of DE operations encompassing disparate DE tools into a corpus of normative program code, facilitating the generation and training of artificial intelligence (AI) and machine learning (ML) models for the purpose of manipulating DE models through various DE tools across different stages of a DE process, DE workflow, or a DE life cycle.

Digital threads are created through user-directed and/or autonomous linking of model splices. A digital thread is intended to connect two or more DE models for traceability across the systems engineering life cycle, and collaboration and sharing among individuals performing DE tasks. In a digital thread, appropriate outputs from a preceding digital model are provided as inputs to a subsequent digital model, allowing for information flow. That is, a digital thread may be viewed as a communication framework or data-driven architecture that connects traditionally siloed elements to enable the flow of information between digital models. The extensibility of model splicing over many different types of DE models and DE tools enables the scaling and generalization of digital threads to represent each and every stage of the DE life cycle.

A digital twin (DTw) is a real-time virtual replica of a physical object or system, with bi-directional information flow between the virtual and physical domains, allowing for monitoring, analysis, and optimization. Model splicing allows for making individual DE model files into executable splices that can be autonomously and securely linked, thus enabling the management of a large number of DE models as a unified digital thread. Such a capability extends to link previously non-interoperable DE models to create digital threads, receive external performance and sensor data streams (e.g., data that is aggregated from DE models or linked from physical sensor data), calibrate digital twins with data streams from physical sensors outside of native DTw environments, and receive expert feedback that provides opportunity to refine simulations and model parameters.

Unlike a DTw, a virtual replica, or simulation, is a mathematical model that imitates real-world behavior to predict outcomes and test strategies. Digital twins use real-time data and have bidirectional communication, while simulations focus on analyzing scenarios and predicting results. In other words, a DTw reflects the state of a physical system in time and space. A simulation is a set of operations done on digital models that reflects the potential future states or outcomes that the digital models can progress to in the future. A simulation model is a DE model within the context of the IDEP as disclosed herein.

When testing different designs, such as variations in wing length or chord dimensions, multiple DTws (sometimes numbering in 100s to 1,000s) may be created, as a bridge between design specifications and real-world implementations of a system, allowing for seamless updates and tracking of variations through vast numbers of variables, as detailed in the context of FIG. 1. As an example, if three variations of a system are made, each one would have its own DTw with specific measurements. These DTws may be accessed and updated via API function scripts, which allow for easy input of new measurements from the physical parts during the manufacturing process. By autonomous linking with appropriate data, a DTw may be updated to reflect the actual measurements of the parts, maintaining traceability and ensuring accurate data representation through hundreds or thousands of models.

### Exemplary Model Splicing Setup

FIG. 7 is a schematic showing an exemplary model splicing setup, according to some embodiments of the present invention. Specifically, FIG. 7 is a schematic showing an embedded CAD model splicing example.

In the present disclosure, a “model splice”, “model wrapper”, or “model graft” of a given DE model file comprises locators to or copies of (1) DE model data or digital artifacts extracted or derived from the DE model file, including model metadata, and (2) splice functions (e.g., API function scripts) that can be applied to the DE model data. A model splice may take on the form of a digital file or a group of digital files. A locator refers to links, addresses, pointers, indexes, access keys, Uniform Resource Locators (URL) or similar references to the aforementioned DE digital artifacts and splice functions, which themselves may be stored in access-controlled databases, cloud-based storage buckets, or other types of secure storage environments. The splice functions provide unified and standardized input and output API or SDK endpoints for accessing and manipulating the DE model data. The DE model data are model-type-specific, and a model splice is associated with model-type-specific input and output schemas. One or more different model splices may be generated from the same input DE model file, based on the particular user application under consideration, and depending on data access restrictions. In some contexts, the shorter terms “splice”, “wrapper”, and/or “graft” are used to refer to spliced, wrapped, and/or grafted models.

Model splicing is the process of generating a model splice from a DE model file. Correspondingly, model splicers are program codes or uncompiled scripts that perform model splicing of DE models. A DE model splicer for a given DE model type, when applied to a specific DE model file of the DE model type, retrieves, extracts, and/or derives DE model data associated with the DE model file, generates and/or encapsulates splice functions, and instantiates API or SDK endpoints to the DE model according to input/output schemas. In some embodiments, a model splicer comprises a collection of API function scripts that can be used as templates to generate DE model splices. “Model splicer generation” refers to the process of setting up a model splicer, including establishing an all-encompassing framework or template, from which individual model splices may be deduced.

Thus, a DE model type-specific model splicer extracts or derives model data from a DE model file and/or stores such model data in a model type-specific data structure. A DE model splicer further generates or enumerates splice functions that may call upon native DE tools and API functions for application on DE model data. A DE model splice for a given user application contains or wraps DE model data and splice functions that are specific to the user application, allowing only access to and enabling modifications of limited portions of the original DE model file for collaboration and sharing with stakeholders of the given user application.

Additionally, a document splicer is a particular type of DE model splicer, specific to document models. A “document” is an electronic file that provides information as an official record. Documents include human-readable files that can be read without specialized software, as well as machine-readable documents that can be viewed and manipulated by a human with the help of specialized software such as word processor and/or web services. Thus, a document may contain natural language-based text and/or graphics that are directly readable by a human without the need of additional machine compilation, rendering, visualization, or interpretation. A “document splice”, “document model splice” or “document wrapper” for a given user application can be generated by wrapping document data and splice functions (e.g., API function scripts) that are specific to the user application, thus revealing text at the component or part (e.g., title, table of contents, chapter, section, paragraph) level via API or SDK endpoints, and allowing access to and enabling modifications of portions of an original document or document template for collaboration and sharing with stakeholders of the given user application, while minimizing manual referencing and human errors.

In the CAD model splicing example shown in FIG. 7, a CAD model file diesel-engine.prt 704 proceeds through a model splicing process 710 that comprises a data extraction step 720 and a splice function generation step 730. This input DE model 704 is in a file format (.prt) native to certain DE tools. Data extraction may be performed via a DE model crawling agent implemented as model crawling scripts within a model splicer to crawl through the input DE model file and to distill model data with metadata 722. Metadata are data that can be viewed without opening the entire input DE model file, and may include entries such as file name, file size, file version, last modified date and time, and potential user input options as identified from a user input 706. Model data are extracted and/or derived from the input DE model, and may include but are not limited to, parts (e.g., propeller, engine cylinder, engine cap, engine radiator, etc.), solids, surfaces, polygon representation, and materials, etc. When a model splicer crawls through the model file, it determines how model data may be organized and accessed, as fundamentally defined by a DE tool 702 that is being used in splicing the DE model, and establishes a model data schema. This data schema describes the structure and format of the model data, some of which are translated into, or used to create input/output API endpoints with corresponding input/output schemas. In some embodiments, model data with metadata 722 may be stored in an access-restricted storage 726, such as the “customer buckets” 312 within customer environment 310 in FIG. 3, so that model splices such as 742, 744, and 746 may be generated on-demand once an input DE model 704 has been crawled through.

The model splicer further generates splice functions (e.g., API function scripts) 732 from native APIs 702 associated with the input CAD model. In the present disclosure, “native” and “primal” refer to existing DE model files, functions, and API libraries associated with specific third-party DE tools, including both proprietary and open-source ones. Native API 702 may be provided by a proprietary or open-source DE tool. For example, the model splicer may generate API function scripts that call upon native APIs of native DE tools to perform functions such as: HideParts(parts_list), Generate2DView( ), etc. These model-type-specific splice functions may be stored in a splice function database 736, again for on-demand generation of individual model splices. A catalog or specification of splice functions provided by different model splices supported by the IDEP, and orchestration scripts that link multiple model splices, constitutes a Platform API. This platform API is a common, universal, and externally-accessible platform interface that masks native API 702 of any native DE tool integrated into the IDEP, thus enabling engineers from different disciplines to interact with unfamiliar DE tools, and previously non-interoperable DE tools to interoperate freely.

Next, based on user input or desired user application 706, one or more model splices or wrappers 742, 744, and 746 may be generated, wrapping a subset or all of the model data needed for the user application with splice functions or API function scripts that can be applied to the original input model and/or wrapped model data to perform desired operations and complete user-requested tasks. In various embodiments, a model splice may take on the form of a digital file or a group of digital files, and a model splice may comprise locators to or copies of the aforementioned DE digital artifacts and splice functions, in any combination or permutation. Any number of model splices/wrappers may be generated by combining a selective portion of the model data such as 722 and the API function scripts such as 732. As the API function scripts provide unified and standardized input and output API endpoints for accessing and manipulating the DE model and DE model data, such API handles or endpoints may be used to execute the model splice and establish links with other model splices without directly calling upon native APIs. Such API endpoints may be formatted according to an input/output scheme tailored to the DE model file and/or DE tool being used, and may be accessed by orchestration scripts or platform applications that act on multiple DE models.

In some embodiments, when executed, an API function script inputs into or outputs from a DE model or DE model splice. “Input” splice functions or “input nodes” such as 733 are model modification scripts that allow updates or modifications to an input DE model. For example, a model update may comprise changes made via an input splice function to model parameters or configurations. “Output” splice functions or “output nodes” 734 are data/artifact extraction scripts that allow data extraction or derivation from a DE model via its model splice. An API function script may invoke native API function calls of native DE tools. An artifact is an execution result from an output API function script within a model splice. Multiple artifacts may be generated from a single DE model or DE model splice. Artifacts may be stored in access-restricted cloud storage 726, or other similar access-restricted customer buckets.

One advantage of model splicing is its inherent minimal privileged access control capabilities for zero-trust implementations of the IDEP as disclosed herein. In various deployment scenarios discussed with reference to FIG. 4, and within the context of IDEP implementation architecture discussed with reference to FIG. 3, original DE input model 704 and model data storage 726 may be located within customer buckets 312 in customer environment 310 of FIG. 3. Splice functions 732 stored in database 736 call upon native APIs 702. The execution or invocation of splice functions 732 may rely on job-specific authentication or authorization via proprietary licenses of DE tools (e.g., residing within customer environment 310 of FIG. 3 and/or information security clearance levels of the requesting user. Thus, model splicing unbundles monolithic access to digital model-type files as whole files and instead provides specific access to a subset of functions that allow limited, purposeful, and auditable interactions with subsets of the model-type files built from component parts or atomic units that assemble to parts.

### Digital Threading of DE Models via Model Splicing

FIG. 8 is a schematic showing digital threading of DE models via model splicing, according to some embodiments of the present invention. A digital thread is intended to connect two or more DE models for traceability across the systems engineering lifecycle, and collaboration and sharing among individuals performing DE tasks.

Linking of model splices generally refers to jointly accessing two or more DE model splices via API endpoints or splice functions. For example, data may be retrieved from one splice to update another splice (e.g., an input splice function of a first model splice calls upon an output splice function of a second model splice); data may be retrieved from both splices to generate a new output (e.g., output splice functions from both model splices are called upon); data from a third splice may be used to update both a first splice and a second splice (e.g., input splice functions from both model splices are called upon). In the present disclosure, “model linking” and “model splice linking” may be used interchangeably, as linked model splices map to correspondingly linked DE models. Similarly, linking of DE tools generally refers to jointly accessing two or more DE tools via model splices, where model splice functions that encapsulate disparate DE tool functions may interoperate and call each other, or be called upon jointly by an orchestration script to perform a DE task.

Thus, model splicing allows for making individual digital model files into model splices that can be autonomously and securely linked, enabling the management of a large number of digital models as a unified digital thread written in scripts. Within the IDEP as disclosed herein, a digital thread is a platform script that calls upon the platform API to facilitate, manage, or orchestrate a workflow through linked model splices. Model splice linking provides a communication framework or data-driven architecture that connects traditionally siloed elements to enable the flow of information between digital models via corresponding model splices. The extensibility of model splicing over many different types of digital models enables the scaling and generalization of digital threads to represent each and every stage of the DE lifecycle and to instantiate and update DTws as needed.

In the particular example shown in FIG. 8, an orchestration script 894 is written in Python code and designed to interact via API endpoints such as 892 to determine if a CAD model meets a total mass requirement. API endpoint 892 is an output splice function and part of a platform API 890. Platform API 890 comprises not only splice functions but also platform scripts or orchestration scripts such as 894 itself.

Orchestration Script 894 is Divided into Three Main Steps:
1. Get Data From a CAD Model Splice: A POST request may be sent via the IDEP platform API to execute a computer-aided design (CAD) model splice 871. This model splice provides a uniform interface to modify and retrieve information about a CAD model 881. The parameters for the CAD model, such as hole diameter, notch opening, flange thickness, etc., may be sent in the request and set via an input splice function. The total mass of the CAD model may be derived from model parameters and retrieved via an output splice function. The response from the platform API includes the total mass of CAD model 881, and a Uniform Resource Identifier/Locator (URL) for the CAD model. The response may further comprise a URL for an image of the CAD model.
2. Get Data From a SysML Model Splice: Another POST request may be sent via the IDEP platform API to execute a Systems Modeling Language (SysML) model splice 872. SysML is a general-purpose modeling language used for systems engineering. Output function 892 of model splice 872 retrieves the total mass requirements for the system from a SysML model 882. The response from the platform API includes the total mass requirement for the system.
3. Align the Variables and Check If Requirement Met: The total mass from CAD model 881 is compared with the total mass requirement from SysML model 882. If the two values are equal, a message is printed indicating that the CAD model aligns with the requirement. Otherwise, a message is printed indicating that the CAD model does not align with the requirement.

In short, orchestration script 894, which may be implemented in application plane 160 of IDEP 100 shown in FIG. 1, links digital models 881 and 882 via model splice API calls. Orchestration script 894 is a scripted platform application that modifies a CAD model, retrieves the total mass of the modified CAD model, retrieves the total mass requirement from a SysML model, and compares the two values to check if the CAD model meets the requirement. In some embodiments, a platform application within IDEP 100 utilizes sets of functions to act upon more than one DE model.

### Model Splice Plane

FIG. 9 is a schematic illustrating the linking of DE model splices in a splice plane and comparing digital threading with and without model splicing, according to some embodiments of the present invention. The bottom model plane 180 demonstrates current digital threading practices, where each small oval represents a DE model, and the linking between any two DE models, such as models 982 and 984, requires respective connections to a central platform 910, and potential additional linkages from every model to every other model. The central platform 910 comprises program code that is able to interpret and manipulate original DE models of distinct model types. For example, platform 910 under the control of a subject matter expert may prepare data from digital model 982 into formats that can be accessed by digital model 984 via digital model 984's native APIs, thus allowing modifications of digital model 982 to be propagated to digital model 984. Any feedback from digital model 984 to digital model 982 would require similar processing via platform 910 so that data from digital model 984 are converted into formats that can be accessed by digital model 982 via digital model 982's native APIs. This hub-and-spoke architecture 934 is not scalable to the sheer number (e.g., hundreds or thousands) of digital models involved within typical large-scale DE projects, as model updates and feedback are only possible through central platform 910.

In contrast, once the DE models are spliced, each original model is represented by a model splice comprising relevant model data, unified and standardized API endpoints for input/output, as shown in the upper splice plane 170. Splices within splice plane 170 may be connected through scripts (e.g., python scripts) that call upon API endpoints or API function scripts and may follow a DAG architecture, as described with reference to FIG. 1 and FIG. 6. Note that in FIG. 1, only the set of generated splices are shown within splice plane 170, while in FIG. 9, scripts that link model splices are also shown for illustrative purposes within the splice plane. Such scripts are referred to as orchestration scripts or platform scripts in this disclosure, as they orchestrate workflow through a digital thread built upon interconnected DE model splices. Further note that while splice plane 170 is shown in FIG. 1 as part of IDEP 100 for illustrative purposes, in some embodiments, splice plane 170 may be implemented behind a customer firewall and be part of an agent of the DE platform, as discussed in various deployment scenarios shown in FIG. 4. That is, individual API function scripts generated via model splicing by a DE platform agent may be tailored to call upon proprietary tools the customer has access to in its private environment. No centralized platform 910 with proprietary access to all native tools associated with all individual digital models shown in FIG. 9 is needed. Instead, orchestration scripts call upon platform API function scripts that may be implemented differently in different customer environments.

Hence, model splicing allows model splices such as model splice 972 from digital model 982 and model splice 974 from digital model 984 to access each other's data purposefully and directly, thus enabling the creation of a model-based “digital mesh” 944 via platform scripts and allowing autonomous linking without input from subject matter experts.

An added advantage of moving from the model plane 180 to the splice plane 170 is that the DE platform enables the creation of multiple splices per native model (e.g., see FIG. 7), each with different subsets of model data and API endpoints tailored to the splice's targeted use. For example, model splices may be used to generate multiple digital twins (DTws) that map a physical product or process or object design into the virtual space. Two-way data exchanges between a physical object and its digital object twin enable the testing, optimization, verification, and validation of the physical object in the virtual world, by choosing optimal digital model configuration and/or architecture combinations from parallel digital twins built upon model splices, each reacting potentially differently to the same feedback from the physical object.

Supported by model splicing, digital threading, and digital twinning capabilities, the IDEP as disclosed herein connects DE models and DE tools to enable simple and secure collaboration on digital engineering data across engineering disciplines, tool vendors, networks, and model sources such as government agencies and institutions, special program offices, contractors, small businesses, Federally Funded Research and Development Centers (FFRDC), University Affiliated Research Centers (UARC), and the like. An application example 950 for the IDEP is shown on the right side of FIG. 9, illustrating how data from many different organizations may be integrated to enable cross-domain collaboration while maintaining data security, traceability, and auditability. Here DE models from multiple vendors or component constructors are spliced or wrapped by IDEP agents, and data artifacts are extracted with data protection. Turning DE models into data artifacts enables cross-domain data transfer and allows for the protection of critical information, so that model owners retain complete control over their DE models using their existing security and IT stack, continue to use DE tools that best fit their purposes, and also preserve the same modeling schema/ontology/profile that best fit their purposes. The IDEP turns DE models into micro-services to provide minimally privileged data bits that traverse to relevant stakeholders without the DE models ever leaving their home servers or being duplicated or surrogate. The IDEP also provides simple data access and digital threading options via secure web applications or secure APIs.

### DAG Representation of Threaded Tasks

Model splicing provides a unified interface among DE models, allowing model and system updates to be represented by interconnected and pipelined DE tasks. FIG. 10 shows an exemplary directed acyclic graph (DAG) representation 1000 of pipelined DE tasks related to digital threads, in accordance with some embodiments of the present invention. In diagram 1000, tasks performed through a digital thread orchestration script (e.g., 894) are structured as nodes within a DAG. Actions are therefore interconnected and carried out in a pipeline linking the DE model splices with a range of corresponding parameter values. Therefore, a digital thread can be created by establishing, via interpretable DE platform scripts, the right connections between any model splices for their corresponding models at the relevant endpoints.

Referring to FIGS. 1 and 8, DAGs of threaded tasks are built from digital threads and are part of the DE platform's application plane 160. Different DAGs may target different DE actions. For example, in FIG. 1, building or updating a DTw 122 in the virtual environment 120 has its own DAG 124. Model splicing turns DE models into data structures that can be accessed via API, thus enabling the use of software development tools, from simple python scripts to complex DAGs, in order to execute DE actions. A digital thread of model splices eliminates the scalability issue of digital thread management, and speeds up the digital design process, including design updates based on external feedback.

Following the above description of the basic elements and core aspects of the IDEP as disclosed herein, the systems and methods for AI-assisted testing of software functionalities related to a user intent on the IDEP are described in detail next.

### AI-Assisted Digital Engineering

The advent of model splicing as described below, and as further described in PCT applications No. PCT/US24/18278 (Docket No. IST-02.001PCT), No. PCT/US24/19297 (DocketNo. IST-01.002PCT), No. PCT/US24/18278 (Docket No. IST-02.001PCT), and No. PCT/US24/27898 (Docket No. IST-03.001PCT), enables the scripting of DE model operations encompassing disparate DE tools into a corpus of normative program code. As a consequence, a large space of DE activities can be threaded into program code, including DE model generation, model modification, model data sharing, DE thread generation, thread modification, thread data extraction, thread data sharing, digital twin generation, digital twin modification, digital twin data extraction, digital twin sharing, etc. In turn, the transformation of DE operations into code enables the generation and training of AI modules for the purpose of creating, manipulating, and testing digital engineering models, digital threads, and digital twins.

An artificial intelligence (AI)-assisted approach to the creation, manipulation, linking, sharing, and modification of the data encompassed within digital engineering model files may therefore utilize a combination of machine learning (ML) techniques to create scripts that analyze and extract relevant information, implement appropriate operations, functions and parameters, control digital engineering tools, and implement the optimal sequence of steps for creating or modifying a digital twin, a digital thread, or an underlying digital engineering model file. This allows for programmable, machine-learnable, and dynamic changes to the model files, and ultimately to the digital or physical twin, throughout the product lifecycle. Additionally, as described below, an AI-assisted approach to automating testing in software functionalities in an IDMP may utilize a combination of ML techniques to create test scenarios, test scripts, and to generate test reports based on user action data related to the IDMP.

The ML engine(s) may be trained on a dataset of user inputs and example model splicer, digital thread, and digital twin creation or manipulation scripts, allowing for greater customization and flexibility. This approach may be further enhanced by the use of fine-tuned transformers and language models, which are better suited to capture the specific language and context of the target model files. Moreover, the generation and use of customer data sovereignty-preserving embeddings is expected to ensure customer data sovereignty. Additional measures are described below to improve AI model performance.

The methods and systems described herein enable AI-assisted cross-tool scripting of any DE operation for the creation, manipulation, and testing of digital engineering model files, digital threads, and digital twins, thus leading to dramatic reductions in cost and delays throughout all phases of any digitally engineered product's lifecycle.

### The Need for a Scalable Approach to Testing

The integrated DE platform houses a wide range of dedicated scripts for a range of DE model splicers and related functionalities intended to augment the reliability and security of the platform. The testing process for the entire platform is complex and necessary.

Testing is typically done manually by a software engineer who first undertakes a review of the code to understand its objective, whether it be for model splicers, or for front-end user interface (UI) operations, or for any specific functionality that supports the reliability or security of the platform. Following the review of the code and its objective, the manual approach continues towards developing test scenarios and building out test scripts to verify that the code performs to standard, and to the desired outcomes. Such a manual approach is not scalable within a platform that seeks to integrate a large library of DE models and tools.

The example of automation within the DE platform highlights the complexity of the code and the manual effort involved. The example scenario targets the act of logging into the DE platform. Automating the login process involves a software engineer manually reviewing code, developing test scenarios, and building out test scripts to verify code performance. Exemplary code is provided in Table 1 below:

TABLE 1
Test Code Example

/*#### TEST CODE EXAMPLE ####*/
package istari.web.pageFactory;
import org.openqa.selenium.JavascriptExecutor;
import org.openqa.selenium.WebDriver;
import org.openqa.selenium.WebElement;
import org.openqa.selenium.support.FindBy;
import org.openqa.selenium.support.PageFactory;
import org.testng.Assert;
import java.util.ArrayList;
import java.util.concurrent.TimeUnit;
public class LoginPage extends Common{
// Define the page locators
@FindBy(xpath = “/html/body/div/main/div/div/div[2]/div/button[1]”)
WebElement gmailBtn;
@FindBy(xpath = “//*[@id=\”identifierId\“]”)
WebElement gmailEmail;
@FindBy(xpath = “/html/body/div[1]/div[1]/div[2]/div/c-
wiz/div/div[2]/div/div[2]/div/div[1]/div/div/button/span”)
WebElement gmailNext;
@FindBy(xpath = “/*[@id=\”password\“]/div[1]/div/div[1]/input”)
WebElement gmailPass;
@FindBy(xpath = “/*[@id=\”passwordNext\“]/div/button”)
WebElement gmailPassBtn;
@FindBy(xpath = “//*[@id=\”_{——}next\“]/header/div[2]/div/div[2]/span”)
WebElement loginBtn;
@FindBy(xpath = “//*[@id=\”root\“]/main/header/div/div/div[3]/button[3]/div[1]/span[1]”)
WebElement loggedinUserName;
@FindBy(xpath = “//*[@id=\”details-button\“]”)
WebElement advancedBtn;
@FindBy(xpath = “//*[@id=\”proceed-link\“]”)
WebElement proceedBtn;
String usrEmail = “automation.domain-name”;
String userPass = “User-security-expert”;
String userName = “Automation”;
// Initialize the driver
public LoginPage(WebDriver driver) {
this.driver = driver;
//This initElements method will create all WebElements
Page Factory.initElements(driver, this);
}
//Click on login button
public void clickGmailLoginBtn( ) {
gmailBtn.click( );
}
//Set the user Gmail Email
public void setUserEmail(String strUserEmail) {
gmailEmail.sendKeys(strUserEmail);
}
//Move to Gmail Pass page
public void click Next Button( ) {
gmailNext.click( );
}
// Set the Gmail pass
public void setGmailPass(String strUserPass) {
gmailPass.sendKeys(strUserPass);
}
// Click continue after entering the gmail pass
public void clickPassNextBtn( ) {
gmailNext.click( );
}
// Click Advance button to proceed with the link
public void clickAdvanceBtn( ) {
advancedBtn.click( );
}
// Click proceed button to proceed with the link
public void clickProceedBtn( ) {
proceedBtn.click( );
}
//Get the page title after do Login
public String getMainPageTitle( ) {
return driver.getTitle( );
}
// Return the User Name after do login
public String getUserName( ) {
return loggedinUserName.getText( );
}
public void doLogin( ) throws InterruptedException {
// Click the Gmail button to login by Gmail
this.clickGmailLoginBtn( );
driver.manage( ).timeouts( ).implicitlyWait(10, TimeUnit.SECONDS);
//Fill the user email
this.setUserEmail(usrEmail);
driver.manage( ).timeouts( ).implicitlyWait(10, TimeUnit.SECONDS);
//click Next to enter the pass
this.clickNextBtn( );
driver.manage( ).timeouts( ).implicitlyWait(10, TimeUnit.SECONDS);
//Enter the Gmail pass
this.setGmailPass(userPass);
Thread.sleep(9000);
driver.manage( ).timeouts( ).implicitlyWait(20, TimeUnit.SECONDS);
// Click Next to Login
this.clickPassNextBtn( );
driver.manage( ).timeouts( ).implicitlyWait(20, TimeUnit.SECONDS);
// Open the files to proceed with the link permission
((JavascriptExecutor) driver).executeScript(“window.open( )”);
ArrayList<String> tabs = new ArrayList<String>(driver.getWindowHandles( ));
driver.switchTo( ).window(tabs.get(1));
driver.get(“<cloud-storage-URL>/api/files?perPage=10&currentPage=1&sort =-
created_at&ownership=all”);
driver.manage( ).timeouts( ).implicitlyWait(20, TimeUnit.SECONDS);
this.clickAdvanceD tn( );
Thread.sleep(9000);
this.clickProceedBtn( );
driver.manage( ).timeouts( ).implicitlyWait(20, TimeUnit.SECONDS);
Thread.sleep(5000);
// switch back to the first tab
driver.switchTo( ).window(tabs.get(0)); // switch back to main screen
//driver.navigate( ).refresh( );
driver.manage( ).timeouts( ).implicitlyWait(10, TimeUnit.SECONDS);
Thread.sleep(15000);
System.out.println(“Login-step-complete”+driver.getCurrentUrl( ));
Assert.assertEquals(this.getUserName( ), userName);
}
package istari.web.smokeTest;
import istari.web.pageFactory.Common;
import istari.web.pageFactory.LoginPage;
import org.testng.annotations.Test;
import java.util.concurrent.TimeUnit;
public class Login extends Common {
LoginPage objLogin;
/**
* This test case will verify the login
*/
public void gmailLogin( ) throws InterruptedException {
//Do login by gmail
objLogin = new LoginPage(driver);
objLogin.doLogin( );
driver.manage( ).timeouts( ).implicitlyWait(10, TimeUnit.SECONDS);
Thread.sleep(5000);
/*#### TEST CODE EXAMPLE END ####*/

Such a manual approach may fall short in terms of scalability, especially in a platform that requires the integration of a large library of model tools and DE models.

### AI-assisted Testing Automation Approach

The approach for AI-assisted model splicer generation described above includes faster design mockups, model data understanding, and API script generation. This approach is hereby expanded to QA/QC, unit, and usability testing within the software engineering workflow. AI-driven automation tackles scalability issues in testing by generating test scenarios and scripts based on user input for both the frontend and the backend. It also accelerates testing while maintaining consistent and reliable results.

### QA/QC Testing

For QA/QC testing, AI models can help perform routine checks without human intervention, which may considerably diminish time and human resource costs. Additionally, AI models can combine multiple real-world scenarios at the same time and with higher accuracy, a feat that cannot be replicated manually, ensuring that the platform can withstand a variety of workloads and user behaviors.

### Usability Testing

AI models can automate usability testing by learning from user interaction patterns and recommending improvements for a more user-friendly interface. The AI-assisted approach streamlines the process by automatically generating and executing test scripts.

### End-to-End Testing

In end-to-end testing, AI models can use past patterns, bugs, and fixes to predict where issues may occur in new or edited code, significantly simplifying the testing process and helping to prevent potential errors.

### Overview of AI-Assisted Testing Automation

The methods and systems described herein include an AI-assisted testing automation approach for a DE platform, where ML models are used to generate test scenarios for a given user input, and are subsequently used to create test scripts for testing a target piece of written code or software, whether it be for the frontend or the backend.

In various implementations of the development and deployment of the IDMP, two fundamental approaches to software testing are employed: black box testing and white box testing.

Black box testing focuses on validating the functionality of the software without examining its internal code structure. Testers provide input, observe the output, and verify if the software meets the specified requirements and user expectations. This approach includes methods such as equivalence partitioning, boundary value analysis, decision table testing, state transition testing, and usability testing. These methods emphasize user experience, feature validation, and overall system behavior.

White box testing, in contrast, involves a detailed examination of the internal workings of the code. Testers have access to the codebase and employ techniques such as code coverage analysis, unit testing, and integration testing to ensure each part of the code functions correctly. This approach facilitates early error detection, ensures code correctness, and aids in refactoring.

Both testing methods are essential for creating robust, reliable software, each providing unique insights and coverage.

Example implementations of the IDMP can incorporate AI-assisted testing as described below:

### Black Box Testing

Black box testing comprises specification testing, feature and API testing, and usability testing.
1. Specification testing focuses on verifying that the software, both as a whole and in individual modules, meets specified requirements based on specifications and requirements. Techniques include equivalence partitioning, boundary value analysis, decision table testing, state transition testing, and error guessing. AI assistance as described herein can be utilized for pre-deployment environment checks based on contract documentation, IT environment specifications, and individual software modules within the IDMP platform code.
2. Feature and API testing validates individual features or API implementations of splice functions, focusing on functionality and user experience. This involves manual and automated testing, A/B testing, and scenario-based testing. In an exemplary AI-assisted workflow, AI can assist in dependency management testing or API testing, linking feature design documents, customer feedback, and digital thread examples, with individual APIs generated and tested.
3. Usability testing evaluates user experience and interface design, considering user interactions, ease of use, and satisfaction. Techniques include user interviews, surveys, task analysis, A/B testing, and heatmaps. Exemplary AI-assisted usability testing can link front-end usage patterns with test scenarios.

### White Box Testing

White box testing comprises unit testing and integration testing.
1. Unit testing verifies individual units or components of code, focusing on code logic and functionality of individual units such as functions, methods, and classes. Techniques involve test-driven development (TDD), mocking, stubbing, and code coverage analysis. In an exemplary AI-assistance workflow, AI modules can be employed for unit testing and compilation of test scenarios, test scripts, and summary reports.
2. Integration testing ensures different components work together effectively, focusing on system components and their interactions. This involves system integration testing, API testing, and environment-specific testing. Exemplary AI-assisted or automated integration testing can be particularly useful when individual digital models or tools are updated.

FIG. 11 illustrates a flowchart showing a process for AI-assisted testing within a DE platform, according to some embodiments of the present invention. A data collection database 1102 stores all the testing-related data, including training data for ML models generating test scenarios, training data for ML models generating test scripts, and examples of user workflow data such as model type files, instructions, test scripts, and test reports. The dashed lines 1150a and 1150b depict the flow of data being collected by the data collection database 1102. The dotted lines 1152 depict the flow of data from the data collection database 1102 to be used as training data or inputs for LLM models in certain sections of the flowchart. The flowchart is divided into four main sections: code integration 1110 for data collection, test scenario generation 1120, test script generation 1130, and test script execution 1140.

Within the code integration section 1110, in step 1112, web pages that are part of the software platform are parsed and form fields are extracted. Web page parsing may involve applying XPath queries to identify input elements, select dropdowns, and other form elements, while extracting relevant attributes such as field type, name, ID, and default values for further processing or test scenario generation. In step 1114, which may occur in parallel with step 1112, user actions and scenarios related to different user intents (e.g., “create new account”, “save design”, “update model file”, etc.) are logged. Javascript code is injected in all pages of the platform to collect information. The form field data and user action data from steps 1112 and 1114 are collected by the data collection database 1102 and may be used in steps 1122 and 1132 for test scenario generation and test script generation.

The test scenario generation section 1120 features step 1122, where an LLM model for test scenario generation parses user actions from the data collection database 1102 and generates human readable test scenarios. The LLM model may be trained on training data from the data collection database 1102. Based on the output of the LLM model, the process then moves to a decision point 1124 for approval by a human expert. If the human readable test scenario is not approved, then the human feedback is returned to the LLM model and step 1122 is repeated with the human feedback. If the human readable test scenario is approved, the process proceeds to the next section.

The test script generation section 1130 features step 1132, where an LLM model for test script generation generates test scripts based on the human readable scenarios from the test scenario generation section 1120 and user action data and data from interactive fields in the web page from the data collection database 1102. The test script generation LLM may be prompted by a user to generate test scripts utilizing specific frameworks and libraries. Based on the output of the LLM model, the process then moves to another decision point 1134 for approval by a human expert. If the test scripts are not approved, then the human feedback is returned to the LLM model and step 1132 is repeated with the human feedback. If the test scripts are approved, the process proceeds to the next section.

Within the test script execution section 1140, in step 1142, the test scripts from the test script generation section 1130 are executed on the platform. In step 1104, the test execution results are output in a report. The report output is also collected by the data collection database 1102 and may be used for further training and updating of the test scenario generation LLM models and the test script generation LLM models. The flowchart demonstrates a structured approach to automated test generation and execution, incorporating machine learning models and human oversight at various stages to ensure accuracy and relevance of the generated tests. The proposed implementation is described in more detail within the illustrative example of AI-assisted QA/QC testing of Tables 2 and 3 and FIGS. 12-16 below, through the following five steps:
1. Code integration with the necessary code and schema within the target software (see Tables 2 and 3 and FIG. 12);
2. Data preparation (see FIG. 13);
3. Test scenario generation (see FIG. 14);
4. Test script generation (see FIG. 15); and
5. Execution & Report generation (see FIG. 16).

The proposed implementation, illustrated in FIG. 11, is further described with respect to specification and feature testing (see FIG. 17 below).

### Additional Roles of AI Agents in AI-Assisted Testing

In exemplary implementations of the IDMP, AI agents, modules, or models may be pre-trained on contract documentation, customer environment description documents, or platform API documentation and may provide AI assistance to users for various ongoing testing requirements. Some AI agents may assist in parsing customer documents into software specifications and requirements and in defining user scenarios for testing.

AI agents, such as scenario machine learning (ML) models described below, may take example test scenarios and iterate across a broader test parameter set to create synthetic test scenarios based on the initial test scenario examples. Additional AI agents, such as script machine learning (ML) models described below, may utilize the test scenarios and requirements to generate executable test code scripts. These approaches can leverage external feedback to refine testing processes. The AI agents can be deployed to train within the specific context of appropriate documentations using a Retrieval Augmented Generation (RAG)-based approach or a Low-Rank Adaptation (LoRA) approach.

### Example of AI-Assisted QA/QC Testing

FIGS. 12-16 illustrate the individual components of the AI-assisted testing process of FIG. 11, according to embodiments of the present invention. In the embodiments of FIGS. 12-16, the process is carried out by a test module.

### Step 1: Code Integration Example

In one embodiment, the test module starts by generating a unique JavaScript code for the DE platform. The unique JavaScript code is created by a human expert or created by the system based on prior examples. The function of this code is to record all user actions within the IDEP. The development team will then inject this code into the HTML code of the system pages, specifically within the <head> tag.

Tables 2 and 3 below show an illustrative software application HTML <head> tag (Table 2) running an exemplary user-action collection script (Table 3), according to embodiments of the present invention. In this case, the target software is the DE platform application.

TABLE 2
Software Application HTML <head> Tag

```
<!DOCTYPE html>
<html lang=“en”>
  <head>
  <meta charset=“UTF-8” />
  <link rel=“icon” type=“image/svg+xml” href=“/assets/favicon-0e910ae6.svg” />
  <!-- Font -->
  <link rel=“preconnect” href=“fonts(dot)googleapis(dot)com” />
  <link rel=“preconnect” href=“ fonts(dot)gstatic(dot)com” crossorigin />
  <link
      href=“fonts(dot)googleapis(dot)com/css2?family=Inter:wght@400;500;600;700&family=Source+S
ans+Pro:wght@400;600;700&display=swap”
      rel=“stylesheet”
    />
    <meta name=“viewport” content=“width=device-width, initial-scale=1.0” />
    <title>Istari Digital</title>
    <script type=“module” crossorigin src=“/assets/index-42aaa01e.js”></script>
    <link rel=“stylesheet” href=“/assets/index-722777db.css”>
  </head>
```

TABLE 3
User Action Collection Script

<script>
(function(i,s,o,g,r,a,m){i[‘GoogleAnalyticsObject’]=r;i[r]=i[r]||function( ){(i[r].q=i[r].q||[ ]).push(argume
nts)},i[r].1=1*new Date( );a=s.createElement(o),
m=s.getElementsByTagName(o)[0];a.async=1;a.src=g;m.parentNode.insertBefore(a,m)})(window,
document,‘script’,‘//www.google-analytics.com/analytics.js',‘ga’);
ga(‘create’, ‘UA-xxxxxx-1’, ‘auto’);
ga(‘send’, ‘pageview’);
</script>

Hence, in the exemplary embodiment of Tables 2 and 3, if a user opens the application's main page and clicks the “Create Account” link, the code will create a record in the database capturing this behavior. Additionally, the JavaScript code of Table 3 also records the front-end elements with which the user interacts, such as the “Create Account” link, and stores this information in the data collection database (1102).

### Specification Testing and Feature Testing

FIG. 11. provides an adequate framework to introduce specification testing and feature testing. Specification testing involves creating test scenarios based on the software's requirements to ensure it meets the specified criteria. In this process, test scenario generation 1120 provides the necessary specifications, such as environment variables or software modules. In addition, the test scenarios might include simulations within the environment or module integration tests. Test script generation 1130 and execution 1140 will then follow these scenarios, create the necessary scripts, and conduct the tests.

Feature testing, however, focuses on testing individual features or API functions. Here, test scenario generation 1120 defines test scenarios, such as checking feature dependencies, testing edge cases, refining features based on customer feedback, and using related feature examples. Test script generation 1130 and execution 1140 will then implement the test scripts and carry out the testing for these scenarios.

FIG. 12 shows a developer screen illustrating a user action (“Create Account”) interface and corresponding HTML code, according to an embodiment of the present invention. With reference to the exemplary embodiments of Tables 2 and 3, a user may enter login credentials in the data field 1202 and click the “Create Account” link 1204. The corresponding HTML code 1206 and CSS code 1208 for the “Create Account” link 1204 shows the page structure and styles within the developer tools. All user actions within the user interface can be recorded, and this user action data can be stored and used for testing in subsequent steps.

### Step 2: Data Preparation and Collection

Next, the test module collects all user action data recorded by the JavaScript code and prepares a dataset to feed the AI model. FIG. 13 illustrates data collection for AI-enabled testing, according to one embodiment of the present invention. The data collection process 1302 includes logging user actions, usage workflow, and UI components following a specific usage scenario carried out by the user. In FIGS. 13-16, inputs and outputs are indicated by dashed and dotted boxes, respectively, as illustrated by the figure key 1320.

In step 1310, a user performs actions on a web page through the UI in a specific user scenario. The data collection step 1312 involves logging user actions and scenarios. This is done through a computer program that records all user actions 1314 on a user interface (UI). These actions could include clicks on buttons, filling out text fields, or submitting forms.

The order in which these actions are performed is also recorded, creating what is referred to as a user scenario or usage workflow 1316. This is essentially the logical sequence of user actions.

Additionally, the system also logs a mapping between the UI components and their corresponding XPath (a language used to navigate through elements in an HTML/XML document), as illustrated by element 1318. The XPath serves as a pointer to specific UI components, allowing the system to know exactly where a user action took place on the UI. The collected data 1314, 1316, and 1318 are then used for AI fine-tuning and training, forming the basis for the next steps in the system's process. FIG. 13 additionally contrasts a human view 1330 and a computer view 1340 of a web page and illustrates the XPath to the username text field.

### Step 3: Scenario Generation

The test module processes this data and prompts a scenario generation AI model to generate test scenarios based on user actions and interactions with the system components. FIG. 14 illustrates an exemplary process for AI-enabled test scenario generation 1402, according to one embodiment of the present invention. The generated scenarios are initially written in natural language, which allows human experts to review and approve them before they are converted into automated scripts. In FIG. 14, the element “A” 1408 refers to the data input from test reports that are successfully completed later in the workflow.

The test scenario generation step involves using AI to generate different test scenarios based on the data collected in the first step. This process is AI-assisted and may use a large language model to generate these scenarios in a human-readable format. Inputs and outputs of the scenario generation AI model 1410 are indicated by dashed and dash-dotted boxes, respectively, as illustrated by the figure key 1420.

The scenario generation AI model 1410 takes the logged user actions 1404 and usage workflows 1406 as inputs. These inputs are essentially the sequences of user actions that were recorded during the data collection phase. The scenario generation AI model 1410 then generates different human readable test scenarios 1412 based on these inputs. The goal is to create a variety of scenarios that a QA engineer might need to test, essentially simulating different user behaviors and sequences of actions. The inputs comprising user actions 1404, usage workflows 1406, and “A” (test report data) 1408 may also be used as training data for training the scenario generation AI model 1410.

The generated scenarios are in a human-readable format, which allows for human feedback 1414 and modification if necessary. The human feedback 1414 on the human readable test scenarios 1412 may be used to iteratively improve the scenario generation AI model 1410. This is important because it allows for the adjustment and fine-tuning of scenarios based on human expertise and understanding, which can lead to more effective and comprehensive testing.

A test scenario such as the human readable test scenarios 1412 may be defined as a sequence of steps that represents a possible situation that can be tested (i.e., a target testing situation). It is a high-level description of what a user or a bot can do with the system, and includes a list of actions. In some embodiments, a test scenario also includes the expected results or the list of actions. In other words, a test scenario pertains to a sequence of actions, constituting a potential situation to evaluate a software system. It provides a high-level depiction of the tasks a user or a system can execute, detailing the procedures and their corresponding action points. In various embodiments, each scenario also incorporates the anticipated outcomes besides the set of operations, offering comprehensive insight into the expected system responses. Test scenarios usually focus on understanding “what” to test rather than “how” to test, aiding in system validation and reliability assessment. FIG. 14 shows an exemplary human-readable test scenario 1430.

It is important to highlight that the number of potential test scenarios can increase exponentially based on the variety of user actions. This is where the AI model becomes invaluable, as it aids in generating valid test scenarios from this vast pool. The human-readable format of these scenarios allows for human intervention and modification if needed, ensuring more effective and comprehensive testing.

### Step 4: Test Script Generation

Upon approval of the test scenarios, the test module proceeds to create automation scripts using different programming languages like Java or Python. These scripts are created to be compatible with common automation frameworks like SELENIUM, CYPRESS, and TESTNG.

FIG. 15 shows an illustrative process for AI-assisted test script generation, in accordance with embodiments of the present invention. The test script generation process 1502 involves feeding the human-readable test scenarios 1503, UI components and their corresponding XPath mappings 1506, and training data into a script generation AI model 1508 (e.g., an LLM such as GorillaLLM). Inputs and outputs of the automatic script generation AI model 1508 are indicated by dashed and dash-dotted boxes, respectively, as illustrated by the figure key 1520.

The script generation AI model 1508 generates automation scripts 1510 based on the inputs 1504 and 1506. These scripts are essentially instructions for automated testing tools to execute specific test scenarios. The generated automation scripts 1510 are designed to mimic the actions a human tester would take, such as clicking on a button, filling out a form, or navigating through a website. This allows for automated testing of the software or application, which can save time and resources compared to manual testing. Once the scripts are generated, they can be reviewed and modified by a human if necessary, generating human feedback 1512 which can be used to iteratively improve the output of the script generation AI model 1508. The human feedback 1512 allows for fine-tuning of the scripts to ensure they accurately represent the test scenarios and can effectively test the software or application.

A test script refers to a predefined set of instructions, often written as program code, that are executed within specific software, such as the digital engineering platform, or a subsystem within it, to validate its expected functionality. The instructions in the test script, significantly inspired by easy-to-understand test scenarios, are delineated in an executable script that either runs within the target software or across the larger platform. Each test script, designed to execute detailed test cases, corresponds to one or more overarching test scenarios. It lays out the individual steps to be undertaken by the test module, the precise inputs required, and the anticipated outputs, thereby maintaining system behavior predictability and reliability. FIG. 15 shows an exemplary test script testing the automation of a POST request over a DE platform 1530.

In certain implementations, QA testing integrates error replication to enhance system resilience. An error replication process involves identifying a particular scenario that resulted in a prior error or system glitch. After identifying the issue, the system formulates tests to recreate that exact error-causing scenario, allowing developers to validate fixes and ensure that the issue does not return in future iterations of the software. A major challenge in prior manual and naive automated approaches is developing comprehensive tests that are not limited to covering the exact scenario which gave rise to an issue, but also recreate related cases that may cause similar errors to occur. With AI assisted testing, the system generates further tests that emulate analogous scenarios, increasing the likelihood of detecting and addressing hidden problems before they affect the end user. In these implementations, AI-assisted testing allows for several iterations between Step 3 (scenario generation) and Step 4 (test script generation), resulting in a portfolio of test scripts testing for the error but also encompassing analogous scenarios.

### Step 5: Test Execution and Report

FIG. 16 illustrates test script execution and report generation, according to embodiments of the present invention. The Execution and Test Reports step is the final component of the test module. It involves running the AI-generated automation test scripts and subsequently generating test reports based on the results. Within the execution and report generation process 1602, the test execution engine 1608 executes the generated automation test scripts 1604 on a dedicated server and generates comprehensive test reports 1610, which it shares with the DE platform's quality team & management. The test reports 1610 may also be collected in element “A” 1612 and shared as training inputs to the scenario generation AI model 1410 of FIG. 14. The test reports 1610 detail the number of generated and executed automation scripts and provides test results for each scenario. Inputs and outputs of the test execution engine 1608 are indicated by dashed and dash-dotted boxes, respectively, as illustrated by the figure key 1620.

In more detail, during the execution phase, the automation scripts 1604 that were generated in the previous step are run. These scripts perform a series of actions on the software or application being tested, effectively simulating user behavior and interactions.

Once the scripts have been executed, test reports 1610 are generated. These reports provide a detailed account of the test execution, including information about which tests passed, which tests failed, and any errors or issues that were encountered during the testing process.

These test reports can then be used for further analysis and improvement of the target software. They can provide valuable insights into the performance and effectiveness of the automation scripts, as well as highlight any potential issues or bugs in the software or application being tested.

Furthermore, these reports can also serve as a source of feedback or training for the AI models as shown in element “A” 1612, helping to improve and fine-tune the generation of user scenarios and automation scripts in future iterations.

Therefore, test scenario- and script-generation can be configured as cycles that end when human feedback triggers the following testing steps, as shown in FIG. 11. In other embodiments, the test scenario generation, test script generation, and test execution steps may be repeated until sufficient replication of a specific error, bug, or UI issue is achieved. In addition to their use within this cycle to verify error replication, test reports may also be used to train the various ML models, as discussed above.

### Example of Usability Testing

For usability testing, exemplary steps 2, 3 and 4 are described below, as they utilize different approaches for collecting training data for user tests and test scripts.

### Step 2: Data Collection

Initially, the DE platform (or test module) collects training data for the test scenario AI model from various sources related to usability testing. For instance, the data could include bug reports from users, steps followed for troubleshooting, corrective actions taken, and final scripts used to rectify the issues. This training data serves as reference to generate meaningful and realistic test scenarios for future testing processes.

### Step 3: Test Scenario Generation

In an implementation example, a generative test scenario generation AI model is fine-tuned with the training data from the historical data of prior bugs and their corresponding fixes, for example, as documented in JIRA tickets, where JIRA is a project management software tool. Using the training data, the scenario generation AI model identifies patterns, high-risk areas, and recurring issues. Through such fine-tuning, the generative scenario generation AI model automatically generates test scenarios that aim to capture similar bugs. The human readable test scenarios output by the scenario generation AI model may be verified through human expert feedback before use in the testing process. A benefit of the above approach for usability testing is that the platform progressively tests scenarios informed by the history of previous bugs, continuously improving usability.

### Step 4: Test Script Creation

The generated test scenarios are used by the platform to prepare corresponding test scripts. This is achieved using a second script generating AI model that specializes in generating code and which has been trained on previously generated test scripts. This AI model may leverage transformer models like CodeBERT or other machine learning models such as Seq2Seq. However, to uphold the accuracy and relevance of these scripts, they may be reviewed and approved by a human expert before deployment.

### Example of End-to-End Testing

For end-to-end testing, exemplary steps are described below.

Step 1: Integration of AI into Backend Testing Processes Examples of end-to-end tests are typically available within the platform and can be further updated based on textbook examples and code repositories of end-to-end tests. An example test may target a GET functionality that retrieves a list of models and sorts them by date. The platform may create three models at different dates, reach out to the API to get the models sorted, and then check that the first model corresponds to the correct output.

### Step 2: Leveraging User Actions for Intuitive Test Scenario Generation

In certain cases, manual consideration of edge cases and search filters is undertaken. However, such edge cases can be automated. Tests can be created to check for other results, limits and to test different combinations of filters and search parameters. This automation takes out human error and a scenario generation AI model can be trained to constantly generate test scenarios based on user actions and platform interactions.

### Step 3: Automated Creation of Test Scripts

Following the generation of test scenarios, a script generation AI model can be used to automatically create end-to-end test scripts for each scenario. For instance, the AI model can create scripts for each combination of filters and search parameters used by the users or for different setups of database models. The scripts, once run, would throw an error if a test fails.

### Step 4: Execution and Review

These automated test scripts are subsequently integrated into the end-to-end testing process. Results are analyzed, tests that fail point out possible bugs, and this information is sent to platform management as well as fed into the scenario generation AI model in order to create better, more conclusive test scenarios. In this way, the platform can continuously learn and identify potential gaps in testing.

### Specification and Feature Testing

FIG. 17 shows an exemplary process for AI-assisted specification and/or feature testing script generation, in accordance with one embodiment of the present invention. Specifically, FIG. 17 illustrates specification and feature testing through an exemplary flowchart for automated testing with scenarios, scripts, and tester agents.

In FIG. 17, the user input (1712) initiates the testing process by capturing the user's intent for testing along with action data reflecting interactions with the Integrated Digital Model Platform (IDMP) and its interfaces. This input is processed by a scenario ML model (1714) that defines test scenarios. The scenario ML model is trained on historical data such as software specifications, requirements documents (1716), and the IDMP platform documentation, including its API (1718). This model may be specifically trained on this targeted data or could be a refined large language model adapted to the specific context of the IDMP using RAG or LoRA approaches. This approach enables the generation of precise test scenarios tailored to the platform's unique requirements.

In various exemplary implementations, this process can be applied to software specification testing during the deployment of the IDMP platform in specific environments, as well as for integration testing of available tools. Additionally, it is suitable for feature testing or API testing, where the requirements of a particular feature or API are validated using the IDMP documentation and API, and by extrapolating various scenarios to assess performance.

Once the test scenarios are defined, a script ML model generates the corresponding test scripts (1722), which are then compiled by the IDMP (1724) to ensure they are executable and meet the intended testing objectives. The script ML model can be trained using a variety of data sources, including user inputs, user actions, historical test scenarios, and test scripts. Tester agents (1726) generate test cases based on these scenarios and execute the scripts to run the tests using the test input in step (1732). If the scripts execute successfully, the system generates a detailed report on the testing outcomes in step (1736). If issues arise at the errors decision point (1734), the tester agents iterate through additional test cases to resolve them.

Throughout this process, the testing can be fully automated, or in some examples, semi-automated with human expert feedback integrated to further refine both the test scenarios (1720) and scripts (1728), ensuring that the process is comprehensive and aligned with real-world requirements.

Digital Workflows through AI-Assisted Script Generation

In various embodiments, an approach is proposed for AI-enabled program code generation for digital workflow tools, where the scripts in the IDMP platform are translated into embeddings, then used to train one or more transformers to generate a script that carries out a digital task. Customer data sovereignty considerations are discussed in PCT application No. PCT/US24/38878 (Docket No. IST-03.002PCT), within a section entitled The Generation of Customer Data Sovereignty Preserving Embeddings.

Many of the scripts used on the IDMP fall into one of the two following categories:
1. API scripts manipulate model representations at the splicing plane (see FIG. 1). They use the APIs of a specific digital workflow tool. For example, among illustrative digital workflows that utilize spreadsheet data, the open-source tool OpenXL offers various APIs for programmatic access to data management, machine learning, and automation features.
2. Orchestration scripts that manipulate digital threads and digital twins at the application plane or the control/analysis plane (see FIG. 1). They are capable of calling API scripts via microservices (see PCT applications No. PCT/US24/18278 (Docket No. IST-02.001PCT) and No. PCT/US24/27898 (Docket No. IST-03.001PCT)) or DAG tasks (see FIG. 10) to coordinate multiple different digital workflow tools.

FIG. 18 shows a generalized AI-assisted design process over an Interconnected Digital Model Platform (IDMP), in accordance with one embodiment of the present invention. In the embodiment of FIG. 18, the three major building blocks used for AI-assisted digital design are:

1. Context AI model (1804):

The IDMP receives access to a context AI model (1804) and runs it to satisfy an input prompt (1802). The context AI model may be based on one or more large transformers or LLMs (e.g., the context AI model (1804) may be a closed-source LLM such as GPT4. Its task is to identify the steps and associated subsystems (1806) related to a digital task. It receives a user's input digital workflow prompt (1802) and generates a selection of choices of one or more trained syntax AI models, along with a corresponding listing of steps and subsystems that need to be carried out by the selected syntax AI model(s) to satisfy the digital workflow prompt (1806).

The input digital workflow prompt (1802) is usually a prompt from a user of the IDMP (e.g., a human user or a software agent). The terms “input digital workflow prompt”, “input prompt”, and “user prompt” are used interchangeably herein.

In various embodiments, a digital workflow prompt (1802) is a request by the user to carry out a digital task involving access to a model representation. Examples of digital workflow prompts include the following:
a. High-level user prompt: “Make a gear with 20 teeth, 50 mm pitch diameter and 3-year service life operating within a max torque of 20 Nm”
b. Lower-level user prompt: “Use an open source tool to conduct static and dynamic analyses for a 3D CAD model of a spur gear consistent with the dimensions provided. Evaluate gear operations for 3 materials (e.g., sintered iron, injection molded nylon, and 3D printed ABS).”

### 2. Syntax AI Model (1808):

The trained syntax AI model may be selected by the context AI model or by a user based on suggestions from the context AI model. It receives the listing of steps and subsystems that need to be carried out to satisfy the digital workflow prompt (1806), and generates one or more scripts to implement digital workflow process steps that satisfy the digital workflow prompt (1810), where these scripts include variables for parameters to be substituted. A syntax AI model may be based on open-source transformers or LLMs, and may be trained to generate API scripts or orchestration scripts. Hence, in one embodiment, the trained syntax AI model generates template scripts comprising API and/or splicing scripts, where a template script includes a variable (i.e., a placeholder for a parameter related to the digital task). The generation of variable parameter scripts (i.e., template scripts) enables the anonymization of enterprise-confidential parameters through the use of variable “parameter placeholders”, a process that may be referred to as “placeholder anonymization”. This process enables customer data sovereignty, as discussed in PCT application No. PCT/US24/38878 (Docket No. IST-03.002PCT). A script database (1826) may be provided by the IDMP for training, fine-tuning, or providing runtime contextual information to the syntax AI model.

### 3. Parameter Substitution Process (1812):

The parameter substitution process receives the script(s) generated by the syntax AI model (1810), and replaces the variables identified by the syntax AI model with enterprise-confidential parameters (1814). In some embodiments, the received scripts are template scripts and include placeholder variables. The parameter substitution process (1812) generates parameter-substituted scripts (e.g., orchestration scripts) to implement digital workflow steps associated with the digital workflow prompt (1802), where script variables are substituted with parameters (1814). The enterprise-confidential parameters usually originate from enterprise documentation (1828) and may be:
a. inserted by the user, or selected by the user from a list extracted from enterprise documentation,
b. selected by the user from a list generated by an enterprise AI module from enterprise documentation,
c. inserted by an algorithm from a parameter table, or
d. inserted by an enterprise AI module.

In one embodiment, the script (1810) generated by the syntax AI model may not include a variable (i.e., a placeholder for a parameter value), and may hence be output as parameter-substituted scripts (1814) without undergoing the parameter substitution process (1812). Once the scripts are ready (1814), they may be executed (1816), where the results are output (1818) into the IDMP or customer environment.

In some implementations, the parameter substitution process (1812) may include the generation of scripts having dummy parameters (1810) that are then substituted with enterprise-confidential parameters, as discussed below. PCT application No. PCT/US24/38878 (Docket No. IST-03.002PCT) provides various options related to the implementation of the parameter substitution process.

Exemplary parameters are listed below in the context of API and orchestration scripts. Once the variables are substituted with parameters, the generated script(s) may be executed over the IDMP to satisfy the user's input digital workflow prompt.

Note that all features discussed in the context of digital engineering through AI-assisted script generation, including ML implementation features such as Retrieval Augmented Generation (RAG)-based or a Low-Rank Adaptation (LoRA) approaches, and the use of variable mapping tables, all apply in the context of digital workflows through AI-assisted script generation.

### User Feedback

Multiple user input and feedback modalities may be implemented within the AI-assisted script generation pipeline. The embodiment of FIG. 18 shows the following user interactions.

At step 1802, the user may initiate with a simple task request such as “Design a gear with 20 teeth . . . ” or “I want to create a plastic chair . . . ”.

At step 1820, the user may interact with a Reinforcement Learning Human Feedback (RLHF) loop to approve or reject workflow steps or tools within the described digital thread. For example, the user may decide on the suggested material selection or simulation models.

At step 1822, the user may thoroughly review the digital thread offered by the system. The user reviews the proposed steps and their parameters. The user may update them, if necessary. The modifications may include changes to potential models or tool configurations, tool and/or model parameters, and giving updates on these parameter values. For instance, the user adapts software tools or parameters and provides updates on Finite Element Analysis (FEA) models.

At step 1824, within the RLHF loop, the user may review, select, or reject proposed algorithm scripts. For example, the user analyzes coding algorithms or machine learning models, then decides to accept or reject them.

FIG. 18 shows the data flow through the platform and, in addition to the user interactions shown in this flow and discussed above, there are additional options for user input to the platform over several iterations. In some embodiments, the user may go through the following interactive steps:
1. uploading a model,
2. selecting a function in the IDMP (in the application plane or the splicing plane—see FIG. 1),
3. changing a function in the IDMP (in the application plane—see FIG. 1), and
4. implicitly assessing whether a digital model meets certification requirements (e.g., by inserting the digital model into a certification document without further changing it). The implicit assessment described here is an important user feedback element.

### Script Types

For generating API scripts, the main building blocks may have the following specific features:
1. Context AI Model (1804): The context AI model generates the objective of the code to be generated, the tool it interacts with, and the broader engineering task it belongs to, such as aircraft design. This data helps frame the task and provides a high-level understanding of the steps to be carried out. This context data is usually hard to infer purely from the digital workflow prompt. Consequently, transformers such as large language models (LLMs) can be particularly effective as they can process large amounts of data and extract high-level themes and concepts.
2. Syntax AI Model (1808): The transformers or LLMs comprised within the syntax AI model are trained to generate the actual code that interfaces with the APIs of any specific digital workflow tool. These transformers or LLMs may be trained on a dataset of similar API interactions, so they capture the nuances of how these APIs operate. Although API scripts are tool-specific by definition, a syntax AI model trained to generate an API script may be trained on the native API of multiple specific tools. Although tool-specialization is possible, in general, the syntax AI model is trained on API scripts within the IDMP, across a mix of native APIs and in addition, platform APIs that implement business logic and further, their related orchestration scripts.
3. Parameter Substitution Process (1812): API script parameters are highly specific to each use-case and may include the dimensions of a component (e.g., an aircraft wing), the viscosity of a fluid (e.g., for a CFD simulation), or the material properties of an FEA model. Since they are deterministic and customer-specific, they may be provided directly by the user or a highly reliable method, and should be incorporated into the code in a deterministic, consistent way (e.g., via a templating system such as the one described in PCT application No. PCT/US24/35885 (Docket No. IST-02.002PCT)).

For generating microservice or DAG task scripts, the main building blocks may have the following specific features:
1. Context AI Model: The context AI model may provide a workflow to carry out the target digital task and would identify the different required digital workflow tools.
2. Syntax AI Model: Transformers may be responsible for generating the code that calls the various required API scripts, ensuring the correct order, dependencies, error handling, etc. across the various manipulated model files. These scripts could be seen as orchestrating the overall workflow of the engineering task.
3. Parameter Substitution Process: Parameters here may include the specific ordering of tasks, any necessary waiting periods between tasks, the handling of any outputs or error messages, etc. They may be provided directly and inserted into the scripts in a deterministic way. Alternatively, they may be inserted by an enterprise AI module.

To generate the scripts that carry out digital tasks, FIG. 18 thus represents a pipeline where the cascaded context and syntax AI models generate the program code, and the parameter substitution process inserts the parameters in a reliable fashion. This setup allows the generation of highly complex, tool-specific code in a very flexible way, whilst still ensuring the right level of control and specificity.

### AI-Assisted Test Script Generation

FIG. 19 shows a process for AI-assisted test script generation over an Integrated Digital Model Platform (IDMP), in accordance with one embodiment of the present invention. Specifically, FIG. 19 presents a structured sequence of steps for AI-assisted testing within the IDMP, leveraging a combination of AI models and human feedback to optimize the software testing process. The process begins with the user providing a digital workflow prompt (1902), capturing the user's intent for testing. This prompt sets the foundation for subsequent steps, guiding the overall testing objectives. The input is initially processed by a scenario machine learning (ML) model (1904), which interprets the user's intent and defines relevant test scenarios (1906) tailored to the specific testing requirements. In one embodiment, like the Context AI model of FIG. 18, the scenario ML model may be a large language model trained on a vast (e.g., Internet-scale) dataset. In some embodiments, the scenario ML model may be refined with IDMP-specific documentation, enabling it to generate precise and relevant test scenarios.

Once the test scenarios are defined, the process involves the selection of a test script ML model (1906) to translate these scenarios into actionable test scripts (1914). The test script ML model generates template scripts (1908, 1910), which include API calls or other necessary instructions (e.g., splicing scripts) to implement the testing steps. These scripts are stored in a script database (1926) for further review and refinement. User feedback is incorporated at various points to ensure the generated scripts align with practical testing needs and real-world conditions. This collaborative approach results in robust test scripts that accurately reflect the testing objectives outlined in the initial user prompt.

In some embodiments, a predictive analytics model (1912) may be employed to assess the relevance and impact of the generated test scenarios on different sections of the software. This step ensures that testing is focused on the most critical or high-risk areas, enhancing both efficiency and effectiveness. The predictive analytics model (1912) may take as input enterprise-confidential parameters that usually originate from enterprise documentation (1928). Following this, the test scripts are executed through the IDMP platform (1916), with the results (1918) providing a detailed report on the software's performance relative to the defined testing scenarios. In some embodiments, the system may include a testing loop control (1930), where a testing AI controller manages iterative testing and further adjustments based on initial results, ensuring thorough validation.

At steps 1920, 1922, and 1924, a user may review the output test scenarios and test template scripts offered by the system. The user reviews the proposed steps and their parameters of the test scenarios and scripts. The user may update them, if necessary. The modifications may include changes to potential models or tool configurations, tool and/or model parameters, and giving updates on these parameter values. For instance, the user adapts software tools or parameters, and provides updates on Finite Element Analysis (FEA) models.

Throughout the entire process, user action data is continuously captured by the IDMP and can be utilized as training data for the AI models or as context for large language models acting as agents. Additionally, human expert feedback is integrated at key stages, allowing the testing process to be either fully automated or semi-automated, depending on the specific implementation. This integration of AI-driven automation with human oversight ensures that the testing process is both comprehensive and adaptable, capable of addressing the complex and dynamic requirements of modem software testing.

The aforementioned test script ML model falls within the category of the syntax AI model described in the context of FIG. 18. Therefore, all training and implementation details for the syntax AI model described above may apply to the training and implementation of the test script ML model. Similarly, the aforementioned scenario ML model falls within the category of the context AI model described in the context of FIG. 18. Therefore, all training and implementation details for the context AI model described above may apply to the training and implementation of the test script ML model.

### Machine-Learning Algorithms

The AI-assisted functions described herein may be created in a machine learning engine by utilizing a combination of supervised and unsupervised learning techniques. Once the model is trained, it can be used to generate a sequence of scripts to carry out digital tasks. Additionally, the machine learning engine can be continuously trained on new data, improving its performance over time. This approach allows for greater customization and flexibility, as the machine learning engine can be tailored to the specific needs and requirements of the user.

Furthermore, Machine Learning (ML) modules may be used to convert user input (e.g., text instructions) into instructions or scripts for carrying out digital tasks. ML modules based on Large Language Models (LLMs) are particularly well suited for such tasks. Sebastian Raschka, Understanding Large Language Models—A Transformative Reading List. Feb. 7, 2023 (available at sebastianraschka(dot)com/blog/2023/llm-reading-list.html, and hereby incorporated by reference in its entirety herein as if fully set forth herein) describes various LLM architectures that are within the scope of the methods and systems described herein. Prior to deployment, the ML module is to be trained on one or more sample user input datasets and on one or more corresponding sample instructions/steps (context AI model) or scripts (syntax AI model) to be generated. Such input and output training datasets may be assembled from a database of user input instances and corresponding output instructions or scripts provided by subject matter experts.

LLM is only one illustrative machine learning algorithm within the scope of the present invention, and the present invention is not limited to the use of LLMs. Any transformer-based ML module is within the scope of the present invention. Transformer architecture and operation are described in more detail in Vaswani et al., “Attention is all you need”, arXiv:1706.03762, 2017, hereby incorporated by reference in its entirety herein.

Furthermore, other machine learning algorithms may also be applied to implement the ML modules listed above. Such machine learning algorithms include, but are not limited to, random forest, nearest neighbor, decision trees, support vector machines (SVM), Adaboost, gradient boosting, Bayesian networks, evolutionary algorithms, various neural networks (including deep learning networks (DLN), generative adversarial networks (GANs), convolutional neural networks (CNN), and recurrent neural networks (RNN)), etc., and are within the scope of the present invention. The section below on machine learning (ML) and neural networks goes into further detail about ML architecture and training.

### Generative AI Deployment for Digital Workflows

In some embodiments, the machine learning (ML) models and artificial intelligence (AI) assistance approaches described herein adapt to suit different customer instances of the IDMP/IDEP (see FIG. 4) and the availability of training data. For example, a pre-trained ML or AI model (e.g., within the IDMP/IDEP enclave 302) is deployed in instances where there are restrictions around sharing customer data. In another example, AI models are deployed in a federated manner adjacent to DE agents and DE tools in the customer environment (e.g., within IDMP/IDEP exclave 316). In another example, an AI model deployed inside the customer environment is trained behind its firewalls. In yet another example, the customer may allow sharing of subsets of their metadata for a training database located within the IDMP/IDEP enclave.

Exemplary implementations of the Interconnected Digital Model Platform (IDMP) incorporate Generative AI assistance for digital workflows through an agent-based approach. Open-source Large Language Model (LLM) agents are customized via fine-tuning with training datasets (e.g., using LoRA) or using a Retrieval-Augmented Generation (RAG) approach, which involves incorporating various data sets into the context window to improve performance. In alternative embodiments, the agents can be transformer-based agents and can further include Natural Language Processing models. Depending on the customer's environment and security requirements, these Generative AI models can be deployed in different configurations:
Within the Enclave: Suitable for community-shared, permissioned datasets.
Across Enclave and Exclave: Ensures protection of sensitive customer data and compliance with specific security requirements.
Within Customer Environment: AI models operate entirely behind customer firewalls, maintaining data security.

FIG. 20 shows potential scenarios for deploying the building blocks of a generalized AI-assisted design process in connection to a customer's physical system and IT environment, in accordance with some embodiments of the present invention. FIG. 20 shows different embodiments where the building blocks of a generalized AI-assisted design process are deployed across the IDMP 2002 and the customer environment 2004.

### 1. Scenario a (2010): Community Permissioned Data Sharing

Deployment: Context AI 2012, syntax AI 2014, and Parameter Substitution 2016 agents are deployed within a secure enclave.
Operation: The context AI model uses a generic open-source LLM agent to manage user inputs and recommend structured sets of digital tasks or digital workflows. The syntax AI model, a custom model trained with universal platform APIs and tool documentation, generates necessary digital thread scripts or workflows based on user inputs. Parameter Substitution is handled entirely within the enclave, using an open-source LLM agent with documentation specific to the digital tools requested by the user, ensuring correct variable replacement. All operations comply with community data-sharing policies.
Example: A community version of the IDMP for CAD modeling users who would like to use public CAD model data sets and their personal CAD models on the platform to create new designs.

### 2. Scenario B (2020): Customer-Sensitive Data Compliance

Deployment: Context AI 2022 and syntax AI 2024 models are deployed within the enclave, while Parameter Substitution 2026 operates in the exclave within the customer environment.
Operation: The context AI model uses a generic open-source LLM agent to process user inputs and recommend structured digital workflows. The syntax AI model, deployed in the enclave, uses training data such as universal APIs and existing tool documentation to generate generic digital thread scripts, maintaining zero-knowledge security principles. Parameter Substitution takes place in the customer environment, where an open-source LLM agent uses specific digital tool documentation to handle customer-specific data securely.
Example: A deployment of the IDMP within a commercial company's network where all company confidential data is strictly within the customer environment.

### 3. Scenario C (2030): Secure, Sensitive Data Networks

Deployment: The context AI model 2032 is deployed in the enclave, while the syntax AI model 2034 and parameter substitution model 2036 are located within the exclave inside the customer environment.
Operation: The context AI model uses a generic open-source LLM agent to manage tasks and identify subsystems securely within the enclave. The syntax AI model, within the exclave, applies training data including universal APIs and existing tool documentation to generate actionable scripts and workflows. Parameter Substitution is implemented by an open-source LLM agent provided with a context window of relevant digital tool documentation, ensuring secure handling of specific parameter values and compliance with stringent security protocols. In some implementations, the agent for syntax AI and the agent for parameter substitution are instanced together within the exclave, enabling a customer-environment-trained syntax AI model that generates scripts incorporating the parameters.
Example: A deployment of the IDMP within a security network where the user processes and workflows are also sensitive and confidential, and must reside strictly within the customer environment.

### 4. Scenario D (2040): Classified Networks and Air-Gapped Environments

Deployment: All three components—context AI 2042, syntax AI 2044, and Parameter Substitution 2046—are deployed as agents within the customer environment.
Operation: The context AI model uses a generic open-source LLM agent to manage tasks and identify subsystems securely. Syntax AI, deployed as an agent, applies training data, including universal APIs and existing tool documentation, to generate actionable scripts and workflows. Parameter Substitution is implemented by an LLM language agent equipped with relevant digital tool documentation, ensuring secure handling of specific parameter values.
Example: In a highly sensitive military application, the entire IDMP along with AI assistance system operates within an air-gapped network to prevent any external access. This setup ensures that all operations are securely contained within the customer's high-security infrastructure, providing robust data protection and compliance with military-grade security requirements.

Note that in Scenarios A and B, the syntax AIs 2014 and 2024 are trained outside the customer environment. Scenarios A and B represent development using the IDMP, i.e., writing digital thread scripts that link with models. These scenarios benefit from a syntax AI that is broadly trained on the IDMP and does not need to be restricted to the customer environment. Scenarios C and D both have the syntax AIs 2034 and 2044 within the customer environment. In these scenarios, testing is easier when the syntax AI model is already within the customer environment, since the syntax AI model can refer to additional customer documents for test scenario generation while preserving customer data sovereignty.

Table 4 summarizes the four deployment scenarios discussed above, showing both IDMP context as well as location with respect to the IDMP deployment scenarios of FIG. 4:

TABLE 4
Generic AI Deployment Scenarios

| | | | Parameter |
|---|---|---|---|
| | Context AI | Syntax AI | substitution |
| Agent-based | Generic | Open-source LLM | Open-source LLM |
| deployment | open-source | agent trained with | agent provided with |
| approach | LLM agent | datasets of universal | knowledge base of |
| | | platform API, tool | appropriate digital tool |
| | | documentations on the | documentation for |
| | | platform, example user | specific digital model |
| | | workflows | as context window |
| IDMP context | Deployment location | | |
| Community | Enclave | Enclave | Enclave |
| permissioned | | | |
| data sharing | | | |
| Customer | Enclave | Enclave | Exclave within |
| sensitive-data | | | customer environment |
| compliance | | | |
| Secure, | Enclave | Exclave within | Exclave within |
| sensitive data | | customer environment | customer environment |
| networks | | | |
| Classified Networks | Within customer | Within customer | Within customer |
| and Air-Gapped | environment | environment | environment |
| Environments | | | |

### Syntax AI Architecture and Training

FIG. 21 describes the operation, training and implementation of a syntax AI model, in accordance with one embodiment of the present invention.

### Training of the Syntax AI Model

An illustrative syntax AI model is described as shown in FIG. 21, beginning with the data that the DE platform collects (2102). The data (2102) collection process shown at the top of FIG. 21 is an important part of the methods disclosed herein, as DE workflow data is uniquely captured through the DE platform through running data-collection orchestration scripts. In one embodiment, the data-collection orchestration script is a metadata-indexed database of examples, with a scrubbing step to remove any parameters and substitute with dummy parameters. Such masking of sensitive information (2104) is further discussed in the context of PCT application No. PCT/US24/38878 (Docket No. IST-03.002PCT) and constitutes one aspect of customer data sovereignty.

Collected data is then pre-processed and tokenized (2106). The DE task-specific training data set (2108) is continuously updated by the DE platform and can be augmented with external data sets of specific DE models (e.g., Shapenet or Partnet) or public repositories of other DE model type files (e.g., repositories of ReqIF files).

A syntax AI model is trained based on the following types of data, collected by the DE platform:
API scripts and orchestration scripts (with parameter masked through placeholder anonymization),
endpoint metadata that is collected by the IDEP listing the various actions at API endpoints, and
model type files (e.g., JSON files).

The endpoint metadata includes both splice-related actions specific to a model-type, and orchestration steps that invoke specific actions on specific splices of specific model-types. Boxes 2110, 2112, and 2113 represent embodiments for training a syntax machine learning model that assists in API script generation. The DE workflow steps to be included in the output DE task script are inferred from endpoint metadata and associated DE models. The process leverages machine learning techniques, specifically fine-tuning a pre-trained language model (2110), a Sequence-to-Sequence (Seq2Seq) model (2112) with attention, and a Transformer(-based) and Sequential Denoising Auto-Encoder (TSDAE) model (2113).

In a first embodiment (2110), a pre-trained language model is fine-tuned for the task. The pre-trained language model may be a model such as open source LLMs or a language model specifically designed for programming languages and source code such as codeBERT. The endpoint metadata, DE models, and corresponding API scripts are tokenized into a suitable format for the chosen model. Input-output pairs are created, where the input is the tokenized metadata and DE model, and the output is the corresponding tokenized API script. The pre-trained model is then fine-tuned on this task-specific data, with the model being fed the input-output pairs and a suitable loss function being optimized. The fine-tuned model is evaluated on a held-out test set to assess its performance. The fine-tuned model can then be used to generate API scripts given a sequence of endpoint metadata and DE models.

In a second embodiment (2112), a Seq2Seq model with attention is used. The model architecture includes an encoder and a decoder, both typically implemented with recurrent neural networks (RNNs) such as LSTM or GRU. The endpoint metadata, DE models, and corresponding API scripts are tokenized into a sequence of tokens that can be fed into the Seq2Seq model. Input-output pairs are created, where the input is the tokenized metadata and DE model, and the output is the corresponding tokenized API script. The Seq2Seq model is trained on this task-specific data, with the model being fed the input-output pairs and a suitable loss function being optimized. The trained model is evaluated on a held-out test set to assess its performance. The trained model can then be used to generate API scripts given a sequence of endpoint metadata and DE models.

The third methodology (2113) is designed for cases where the endpoint metadata, DE models and corresponding API scripts form a training data set that is voluminous and varied compared to the first two approaches. The model employs unsupervised fine-tuning of language transformers known as Transformer (-based) and Sequential Denoising Auto-Encoder (TSDAE). The TSDAE introduces noise to input sequences through token deletion or swapping, which are then encoded into model vectors by the transformer model. A secondary decoder network tries to reconstruct the original input from the encoded model. The TSDAE method (2113) is different from the first embodiment (2110) and second embodiment (2112) as the model decoder only has access to the model vector produced by the encoder, not the full-length token embeddings. The unsupervised learning model in 2113 is evaluated using similar metrics to the first two approaches (2110 and 2112). In the TSDAE method, third party data, open source data, dummy parameters and user approved and shared data (gathered from endpoint metadata, API scripts governing platform functionality and intercommunication and JSON files of model data) can be combined in a large corpus with distinctly heterogenous data properties. Pre-processing using deletion instead of masking in providing the noise component of the encoder transformer algorithm to learn against and pooling of token vectors into a single model vector, are distinguishing factors in 2113. TSDAE architecture and operation are described in more detail in Wang et al., “TSDAE: Using Transformer-based Sequential Denoising Auto-Encoder for Unsupervised Sentence Embedding Learning” (arXiv:2104.06979v3, 2021), hereby incorporated by reference in its entirety herein.

The different embodiments can be suitable depending on the specific requirements, the nature and amount of available data, and the computational resources. The first embodiment (2110), fine-tuning a pre-trained model, leverages the knowledge learned from large-scale pre-training and can be more efficient, especially when training data is limited. The second embodiment (2112), a Seq2Seq model with attention, can be designed to be more specific to the task, which can potentially lead to better performance if enough task-specific training data is available. The third embodiment (2113), a TSDAE model, can be designed to be more specific, when the task-specific training data grows to be voluminous and varied.

In each of the three methodologies (2110, 2112, and 2113), the models may be trained and/or fine-tuned using stored sample user workflows and other enterprise documentation. Specialized and/or context-specific sample user workflows and other enterprise documentation stored at the IDEP may also be used for augmentation purposes as retrieved context information in RAG-based approaches, or as part of a fine-tuning data set in LoRA-based approaches.

In various embodiments, once the training data set is generated (2102-2108) and the syntax AI model trained (2110, 2112, and/or 2113), the trained syntax AI model may be deployed for API script generation purposes (2114-2120). Hence, upon syntax AI model deployment, input from context AI on the overall DE task (2114) (i.e., contextual data) may be fed to the trained syntax AI (2116), which in turn may make accurate predictions for scripts to implement the DE task (2118), yielding the required output API/orchestration script (2120). Although FIG. 21 describes the generation of API and/or orchestration scripts over an IDEP in order to carry out a DE task, the description above applies to the generation of template scripts over an IDMP in order to carry out a digital task, as described herein.

The aforementioned test script ML model falls within the category of the syntax AI model. Therefore, all training and implementation details for the syntax AI model described above apply to the training and implementation of the test script ML model.

### Voice-to-Gear Testing Example

In one exemplary embodiment of the present invention, the generation and execution of a voice-to-gear orchestration script for testing may use the following steps.

The first three steps are related to user-interface data processing: First, the user submits a voice command for the generation of a test, including a specific software functionality or user goal (i.e., user intent). Then, the system stores the audio file with the user input into a database. Finally, the system converts the user input into audio-to-text commands, and identifies the user intent and associated user action data within them using a machine learning model.

The next steps are related to the use of a scenario ML model: First, a scenario ML model based on an LLM generates an inference of the digital thread based on the user input, then generates a test scenario for the script ML model. In one embodiment, prompt engineering for the scenario ML model is performed first, then the scenario ML model uses the LLM-based system to infer the digital thread. With fine tuning, the scenario ML model presents the user input in a standard format featuring a sequence of test steps, each potentially associated with a model/tool, and having an expected outcome. For example, in a DE platform such as an IDEP, the inferred digital thread may lead to the prompt “Test requirements verification for a SysML model with both qualitative and quantitative requirements, against a CAD model of an airplane wing and a static and dynamic analysis using an FEA tool in a low-res simulation mesh”. The expected outcome may then be an expected CAD design or a set of expected CAD design standards.

The script ML model then develops a test script connecting every digital model in the identified digital thread, with associated parameters. In some embodiments, the parameters are hidden from the script ML model and added subsequently by a software module (e.g., a python script) or a separate LLM in order to preserve the privacy of platform customer data.

The last three steps occur at the application plane of the DE platform (see FIG. 1). First, the generated test script, fitted with the design parameters, is executed, to generate a test outcome (e.g., various new CAD designs) to be compared with the expected outcome in a test report. Then, the generated test report is saved. Finally, the saved test report can be viewed.

### AI Performance Improvement

Below are options for technical implementation approaches to reduce hallucinations on an LLM trained on specific data (e.g., the transformers or LLMs described in FIG. 18):
1. Controlled generation: Implementing techniques to guide or control the output of the model can be helpful. For example, using prompt engineering or specifying constraints in the generation process.
   a. Prompt engineering: Design prompts that guide or control the output of the LLM. The prompts can provide explicit instructions, contextual cues, or specific framing to steer the model's generation process.
   b. Specifying constraints: Constraints can be specified in the generation process to guide the output of the LLM. For example, constraints can be used to ensure that the output is factually accurate or that it adheres to a particular style or tone.
2. Ensemble methods: Employing ensemble methods involves training multiple models and combining their outputs. By leveraging the diversity of multiple models, the likelihood of hallucinations can be reduced, as consensus among the models can indicate more reliable information.
   a. Train multiple models: Train multiple LLMs on the same data.
   b. Combine outputs: Combine the outputs of the multiple models to obtain a more reliable output.
3. Adversarial testing: Conducting rigorous testing and adversarial evaluation of the model's outputs can uncover vulnerabilities and areas prone to hallucinations. By identifying specific patterns or situations where the model tends to hallucinate, targeted improvements can be made.
   a. Conduct adversarial testing: Test the LLM's outputs against adversarial examples to identify vulnerabilities.
   b. Identify patterns: Identify specific patterns or situations where the model tends to hallucinate.
   c. Make targeted improvements: Make targeted improvements to the LLM to address the identified vulnerabilities.

Other techniques that can be used to reduce hallucinations on an LLM trained on specific data include improving training data, fine-tuning with human feedback (RLHF), confidence thresholding, and using post-processing steps for factual validation.

The techniques described above are described in more detail in Adrian Tam, “A Gentle Introduction to Hallucinations in Large Language Models”, Jun. 2, 2023 (available at machinelearningmastery(dot)com/a-gentle-introduction-to-hallucinations-in-large-language-models/), Janakiram M S V, “How to Reduce the Hallucinations from Large Language Models”, Jun. 9, 2023, (available at thenewstack(dot)io/how-to-reduce-the-hallucinations-from-large-language-models/), Ofer Mendelevitch, “Avoiding hallucinations in LLM-powered Applications”, May 2, 2023, (available at vectara(dot)com/avoiding-hallucinations-in-llm-powered-applications/), Abhilasha Sinha, “Ensuring Reliability and Trust: Strategies to Prevent Hallucinations in Large Language Models”, May 18, 2023, (available at walkingtree(dot)tech/ensuring-reliability-and-trust-strategies-to-prevent-hallucinations-in-large-language-models/), and Haziqa Sajid, “What Are LLM Hallucinations?Causes, Ethical Concern, & Prevention”, Apr. 29, 2023, (available at www.unite(dot)ai/what-are-llm-hallucinations-causes-ethical-concern-prevention/), all hereby incorporated by reference in their entirety herein as if fully set forth herein.

### AI-Assisted Testing

FIG. 22 shows an exemplary flow chart for a method of AI-assisted testing of a software functionality related to a user intent on a software platform, in accordance with some embodiments of the present invention. In some embodiments, at step 2210, the method includes receiving a user action data indicating a user intent related to a software platform, such as the IDMP. At step 2220, the method includes generating a test scenario based on the user action data using a scenario machine learning (ML) model. At step 2230, the method includes generating a test script based on the test scenario using a script machine learning (ML) model, wherein the test scenario comprises a sequence of human-readable testing steps and an expected outcome that are related to the user intent. At step 2240, the method includes generating a test outcome related to the test scenario by interpreting the test script on an interpreter operatively connected to the software platform. At step 2250, the method includes generating a test report based on the test outcome and the expected outcome.

As used herein, a user intent refers to a goal, objective, or desired outcome that a user aims to achieve when interacting with the IDMP/IDEP. User intent may be expressed through various forms of input, such as user actions, natural language prompts, commands, or selections within the platform interface. User actions refers to specific interactions, inputs, or operations performed by a user within the IDMP/IDEP. User actions may include, but are not limited to, mouse clicks, keyboard inputs, voice commands, or any other form of interaction with the platform's interface or components.

The aforementioned ML models for scenario generation and script generation may be implemented as fine-tuned, pre-trained, transformer-based generative AI-based modules, such as Large Language Models (LLMs). For example, such generative AI modules may be trained on a dataset of sample user actions, corresponding sample test scenarios, and corresponding sample scripts. The fine-tuned LLM may then be able to predict the specific required user actions to be tested, making them better suited to suggest appropriate test scenarios, create scripts to carry out the selected scenarios, and suggest the set of scripts for optimal results. Additionally, new data may be added in the form of user/SME feedback, such that generative AI modules may continually improve their performance over time. This approach allows for greater customization and flexibility, as the AI modules can be tailored to the specific requirements of the software platform.

In some embodiments, the script ML model may generate a template test script that includes a variable, where the variable is a placeholder for a parameter related to the test scenario. A finalized test script may be generated by substituting the variable with a value for the parameter using a parameter substitution process such as the parameter substitution process 1912 in FIG. 19, where the parameter substitution process receives the template test script and replaces the variable in the template test script with the value of the parameter, and where the test script, when interpreted by the Interconnected Digital Model Platform (IDMP), causes the IDMP to implement the testing steps specified by the test scenario.

In addition to the testing settings and objectives described above, AI-assisted testing may include the testing of code that relates to development of a software platform such as the IDMP, the testing of platform functionalities during the development of the platform, and the testing of functionalities related to development (i.e., software developer actions) on the platform after deployment (e.g., user acceptance testing). Multiple test scenarios related to a single user intent may be generated and tested on the software platform.

### Parameter Substitution as a Zero-Knowledge Measure

In one embodiment, a zero-knowledge (ZK) architecture for the IDMP is implemented where the IDMP's Software Development Kit (SDK) prevents any customer data that is deemed sensitive to be sent through an IDMP API. This ZK objective is achieved through a process of cryptographic tokenization. Cryptographic tokenization identifies sensitive data (e.g., through customer input) and maps each sensitive data element (e.g., digital model, digital artifact, document) with a cryptographic token and a cryptographic identifier. Each cryptographic token includes metadata describing the data element. In cryptographic tokenization, metadata from the cryptographic tokens, rather than the data elements themselves, are used to train the syntax AI models. A syntax AI model training data set may hence include a customer data sovereignty-preserving training data set that consists of sample contextual data associated with sample digital tasks, and corresponding sample template scripts. The generation of each sample template script includes the steps of receiving an orchestration script implementing an associated digital task, identifying sensitive data elements within the orchestration script, and replacing each sensitive data element with its mapped metadata.

Cryptographic tokenization replaces sensitive data with the cryptographic identifier when a data element is to be used outside the customer environment, and exchanges the cryptographic token back for the mapped data elements for use within the customer environment, in a process step called cryptographic de-tokenization. The ZK architecture hence stores the sensitive data elements within the customer's environment (e.g., on the customer's network).

Parameter substitution is a further component of the ZK architecture. Specifically, the parameter substitution process contributes to the ZK architecture by mapping generic parameter names or generic API function details (e.g., function names, inputs, outputs) to specific software tool resources or software tool functions within a customer environment. Consequently, the orchestration scripts generated by the syntax AI model support the ZK architecture by requiring an explicit parameter substitution step within the customer environment.

### System Embodiments

FIG. 23 is an exemplary system diagram showing a process for AI-assisted testing of a software functionality related to a user intent on a software platform, in accordance with some embodiments of the present invention. Specifically, FIG. 23 provides an exemplary schematic representation of the modules and data for AI-assisted testing 2320 that may be used for carrying out AI-assisted testing of software functionalities related to a user intent by generating a test scenario 2334 using a scenario AI model 2332, generating a template script 2352 based on the test scenario 2334 using a test script AI model 2350, and then generating a test script 2356 based on the template script 2352 using a substitution AI model 2354 that fills in test script parameters. In some embodiments, the test script AI model 2350 directly generates a test script 2356 with all test script parameters included.

The system may include access to at least one hardware processor 2394 responsible for executing program code 2392 to implement the modules 2320 described below. The system may include access to at least one non-transitory physical storage medium 2390, accessible by the at least one hardware processor 2392, which stores the program code 2392 that is executable by the hardware processor 2394. In some embodiments, the program code 2392 may be stored and distributed among two or more non-transitory physical storage media, and may be executed by two or more processors.

The system may include an IDMP application 2380 controlling a training module 2340 that may carry out training, fine tuning, and/or validation of one or more AI modules. In one embodiment, the AI modules include a scenario AI model 2332, a test script AI model 2350, and a substitution AI model 2354. In some embodiments, the test script AI model 2350 and the substitution AI model 2354 may comprise a script-generating or script-updating machine learning model. In other embodiments, the modules for AI-assisted testing 2320 may comprise a splice-generation and/or a splice-updating AI module.

In order to train and/or fine-tune the AI models 2332, 2350, and 2354, the training module 2340 may use training and tuning data 2342 which may include sample user action data, sample test scenarios, sample test scripts, generated/updated scripts including template scripts, test script parameters, APIs, documentation, and other relevant training data. In some embodiments, the training and tuning data 2342 may be used by the IDMP application 2380 as retrieved context data added to the context windows of the test script AI model 2350 or the substitution ML model 2354 as part of a Retrieval-Augmented Generation (RAG) approach. In other embodiments, the training and tuning data 2342 may be used by the IDMP application 2380 to fine-tune the scenario AI model 2332, test script AI model 2350, and substitution AI model 2354 as part of a Low-Rank Adaptation (LoRA) approach.

At run time, a user 2302 may carry out actions on a user interface 2304, generating user action data 2330 which is collected by the IDMP application 2380 and stored in the training and tuning data 2342. In one embodiment, the user 2302 is a human interacting with the IDMP through a conventional user interface 2304 (e.g., a computer). In another embodiment, the user 2302 is a software agent (e.g., a software module running in a client environment). In some embodiments, the user 2302 is a software agent that includes an AI model, or an AI agent.

The user action data 2330 is indicative of a user intent related to the software platform, and comprises one or more operations performed by the user 2302 on the software platform to achieve the user intent, which comprises an outcome desired by the user 2302 when interacting with the software platform. Based on the user action data, the scenario AI model 2332 generates a human-readable test scenario, where the test scenario comprises a sequence of human-readable testing steps and an expected outcome that are related to the user intent. The sequence of human-readable testing steps will be carried out on the IDMP application 2380 to evaluate a performance of the IDMP application 2380 in accomplishing the user intent. In some embodiments, the test script AI model 2350 generates a template test script 2352 based on the test scenario 2334, where the template test script 2352 includes a variable which is a placeholder for a parameter related to the test scenario 2334. The substitution AI model 2354 then generates a test script 2356 by substituting the variable with a value for the parameter using a parameter substitution process such as the parameter substitution process 1912 in FIG. 19. In the embodiment of FIG. 23, the two placeholder function names of the template script 2252 are replaced in the orchestration script 2356 by two function IDs, “Function_ID_1” and “Function_ID_2”. In the context of parameter substitution, the term “parameter” encompasses numeric parameters such as arrays, matrices, and tensors of numeric values corresponding to real-world attributes (e.g., budget parameters, physical design parameters, etc.). The term “parameter” also extends to function names and API attributes (e.g., number and format of inputs/outputs in a function) that may be specific to a customer or a customer software tool. In some embodiments, the test script AI model 2350 directly generates a test script 2356 based on the test scenario 2334.

To generate the template test script 2352 and the test script 2356, the test script AI model 2350 and the substitution AI model 2354 (or any parameter substitution process) may require access to model data. In the embodiment of FIG. 23, the IDMP application 2380 may provide access to two model splices, Model A Splice 2360 and Model B Splice 2370, associated with Digital Model A 2310 and Digital Model B 2312, respectively, where both are digital models related to the user intent. The model A splice 2360 may include splice data 2362 and splice functions 2364. Similarly, the model B splice 2370 may include splice data 2372 and splice functions 2374. The model splices 2360 and 2370, their data, and their functions are accessible through splicing APIs 2366 and 2376. The trained test script AI model 2350 and the substitution AI model 2354 may generate or update scripts 2352 and 2356, respectively, connecting model A splice 2360 and the model B splice 2370, based on the test scenario 2334.

The test script 2356 may be interpreted on an interpreter operatively connected to the IDMP application 2380. Interpreting the test script causes the implementation of at least one testing step from the test scenario 2334 on the IDMP application 2380. A test report can be generated based on the test outcome, and this test report may be stored in the training and tuning data 2342.

The scenario AI model 2332 may be trained on a scenario training data set comprising sample user action data indicating a sample user intent, and corresponding sample test scenarios related to the sample user intent, which are stored in the training and tuning data 2342.

Generalized Model Splicing Process with Base Model Splices

While FIG. 7 illustrates the inputs to and outputs of the model splicing process for a CAD model, it is important to note that the implementation of the model splicer is generalizable across the breadth and range of various model type files. FIG. 24 further shows a general process 2400 within the IDEP to perform model splicing and to generate model splices for all types of models, in accordance with some embodiments of the present invention.

The following exemplary steps may be carried out in the generalized model splicing process shown in FIG. 24 upon initialization at a step 2410:

At a step 2420, a user uploads a DE model to the IDEP. A DE model file may be represented by one or more DE model files having respective source file formats. Recall that a DE model is a computer-generated digital model that represents characteristics or behaviors of a complex product or system. A DE model can be created or modified using a DE tool. A DE model file is the computer model file created or modified using the DE tool. A DE model within the IDEP as disclosed herein refers to any digital file uploaded onto the platform, including documents that are appropriately interpreted. For example, a computer-aided design (CAD) file, a Computer-Aided Engineering (CAE) file, a Computer-Aided Manufacturing (CAM) file, a Systems Modeling Language (SysML) file, a Systems Requirements Document (SDR) text file, a cost model, a scientific/engineering computing and simulation model file, a Model-Based Systems Engineering (MBSE) file, or a Neural Network Model JSON file may each be considered a DE model, in various embodiments of the present invention. A DE model may be machine-readable only, may be human-readable as well but written in programming codes, or may be human-readable and written in natural language-based texts. For example, a word-processing document comprising a technical specification of a product, or a spreadsheet file comprising technical data about a product, may also be considered a DE model. A DE tool is a DE application software (e.g., a CAD software), computer program, and/or script that creates or manipulates a DE model during at least one stage or phase of a product lifecycle. A DE tool may comprise multiple functions or methods. Exemplary DE tools include, but are not limited to, model-based systems engineering (MBSE) tools, augmented reality (AR) tools, computer aided design (CAD) tools, data analytics tools, modeling and simulation (M&S) tools, product lifecycle management (PLM) tools, multi-attribute trade-space tools, simulation engines, requirements model tools, electronics model tools, test-plan model tools, cost-model tools, schedule model tools, supply-chain model tools, manufacturing model tools, cyber security model tools, and mission effects model tools.

At a step 2430, based on the type of the input DE model, the system may send requests to an appropriate server, computing entity, or computing module to process the input model files and extract data (e.g., components, variables, metadata) from the DE model. In some embodiments, this model data extraction step may be performed using a model data crawler that interfaces with APIs/SDKs provided by native and/or open-source DE tools. In some embodiments, data extracted from the model may not represent the whole model, but may be a subset or a slice of the whole model, and may depend on the DE tool and tool APIs used to access the model. In some embodiments, data extraction may rely on inputs from human or AI experts, who may use native model APIs to understand model data structure and provide model crawling scripts for extracting variables and parameters. In some embodiments, the system may generate a data structure that holds the model data and stores it in a database. Such data structures may be model-type specific.

At a step 2440, the system may build and/or execute scripts to generate one or more model splices based on the type of the model and/or user input. The user may provide feedback to update such model splices at a step 2450, and share the ensuing model splice(s) with collaborators at a step 2460, before the process terminates at a step 2470. In some embodiments, the system may provide base model splices at step 2440 according to typical use cases for the input model type. The user may select a based model splice for further customization at step 2450, before the model splice is shared with relevant stakeholders at step 2460. In some embodiments, the model splice is executed by the user or the collaborator at step 2490, for example as part of a digital thread. As illustrated by lines 2494, model splice execution in step 2590 and tracking may depend on the outputs of the user updates to the model splices and the model splice shared by the user. The execution of a model splice refers to user-initiated or system-initiated execution or invocation of a splice function, for example to access or manipulate a digital artifact, or to update the DE model.

For example, CAD files are associated with general functions (e.g., operations, deltas) that can be applied to a CAD model, and CAD files are often reviewed in different representations such as as-designed and as-planned views of 3D models, 2D drawings with geometrical tolerances and technical specifications, attribute-based color-washings, simulation results (e.g., calculated weight and balance, finite element analysis), bill of materials (BOM) reports, and the like. Multiple base or default model splices may be generated from the general functions by the system, based on typical uses of CAD models as collected previously by the system, or as specified by user intent input. Such base model splices may be presented to a user through a UI for further revision and approval.

In another example, DE models in the type of scientific/engineering computing and simulation scripts may be spliced into one or more mode splices by default, and the user may provide feedback by selecting specific inputs and outputs of specific splices. In some instances, the model file may contain existing methods that may be used directly as splice functions, in addition to new scripts or plugins that are generated by the model splicer system. Additionally, a human or AI expert may identify specific splice functions or API endpoints for a splice, and the human or AI expert may create initial function scripts for the creation of model splices. The AI expert may be implemented using generative AI algorithms to automate any one of the aforementioned embodiments. More generally, during each of the process steps shown in FIG. 24, expert user actions, system actions, and user inputs may all be logged into a system database 2480. Such system logs may help in auditing and collecting datasets for AI systems capable of API function script generation, autonomous model splice linking and orchestration.

Additionally, during each of the process steps shown in FIG. 25, expert user actions, system actions, and user inputs may be collected as part of testing data collection 2585. As illustrated by the dotted lines 2492a, 2492b, and 2492c, testing data collection 2585 may comprise collecting data related to (1) user actions, input, and model data from step 2520 of the user uploading the model to the IDEP, (2) model variable data from step 2530 of extracting variables from the model file, (3) system actions and outputs from step 2540 of building and executing scripts to generate model splices, (4) user actions and inputs from step 2550 of the user updating the model splices, (5) user actions and data from step 2560 of the user sharing the model splices, and (6) system actions and outputs from step 2590 of model splice execution and tracking. Any user action may be recorded for purposes of training ML modules for test scenario generation and script generation. The collected training data may be used for training the test scenario AI and script generation AI modules before deployment, but also as context data supporting deployed models, such as the previously described syntax AI models.

In the context of FIG. 24, model splicing may create several categories of model splice functions or API/SDK endpoints. A first category is predefined based on the model type, and may be viewed as base or default splice functions. For example, these may be written by a human expert using the API/SDK provided by the native DE tool. A second category may be extracted from a script, as in the case of scientific/engineering computing and simulation models. A third category may be provided by an AI algorithm trained on existing splice functions associated with existing model splices for the same and/or analogous DE models or DE model types. Similarly, a user may customize base model splices written by human experts or AI algorithms, or shared/received model splices within the user's editing rights. For example, the user may select/modify specific digital artifacts and/or functions within a model splice. The user may select a single splice function and/or a single digital artifact first and sequentially select several splice functions or the entire model-type file or the splice. Such user selections may be stored in the system database 2480 for creating based model splices.

In short, model splicing may comprise one or more of the following core processes:
1. Identifying a DE model type (e.g., CAD, requirements, etc.).
2. Breaking the DE model down into its smallest possible components or atomic units (e.g., solids, surfaces, edges, wireframes, parameters, assembly to parts, owner, reviewer, etc.).
3. Crawling through the model and determining the data structure of each atomic unit (e.g., for CAD it may crawl through each part and then find each face, curve, line, chord, etc.).
4. Creating a data structure of one or more data files to represent the DE model. These data files may include one or more of the original file, open-source clones, and other data representations such as JSON files and metadata inputs.
5. Providing an interface for humans and/or machines to update the DE model, which is now a collection of data files containing model data.
6. Providing an interface for humans and/or machines to extract digital artifacts from the model, which is now a collection of data files containing model data.
7. Identifying how humans interact with the model via a GUI or web-app.
8. Identifying how machines interact with the model via the APIs.
9. Automatically handling new version forks or variants of the original model based upon changes by users.
10. Tracking all of the above functions with metadata for auditability, traceability, accountability, and security.

### Model Access Control and Tracking for Zero-Trust Security

As disclosed herein, model splicing enables selective access to and modification of certain data and/or functions within a DE model, while keeping the rest of the model hidden. As such, model splicing enables the IDEP to be implemented under a zero-trust approach, where the users interact with the system through computer networks. Such a zero-trust approach methodology extends to the access and manipulation of data related to individual DE models, DE tools, and digital threads, for example at the model splice sharing step 2460 and/or the model splice execution step 2490.

In some examples, the policies of a security architecture implemented under zero-trust may include model storage policy, model access policy, attribute-based access control, handling of read vs. write queries, traceability and auditability, and a model trust policy, etc. For instance, model access may be restricted to specific splice functions, authenticating users and models at API endpoints to DE models, allowing customers (e.g., model owners or model developers) to set additional access control policies, implementing data restrictions and encryptions, recording endpoint transactions in a secure database, and incorporating metadata and digital watermarks for traceability and auditability, etc. The goal is to ensure the right authenticated user has access to the right authenticated model and to assess model truth and user credibility.

Specifically, embodiments of the present invention enable the implementation of the aforementioned zero-trust policies by restricting access to model data/digital artifacts to a specific subset of splice functions, and by tracking API endpoint transactions, which are executions or invocations of splice functions. In some embodiments, access restrictions to model data and digital artifacts may be implemented by authenticating users, for example using attribute-based access control. These attribute-based access controls can include username, password, email, security keys, information security (infosec) levels, DE model expertise, role in a digital review, etc.

In some implementations, a model splice may comprise one or more infosec tags or markings for zero-trust access control on a “need-to-know” basis, where an infosec tag may indicate an access level to one or more of the model splice itself, the digital artifacts, and/or the splice functions. Tagging individual or groups of digital artifacts and/or splice functions with infosec information may enforce zero-trust access control by categorizing each based on its sensitivity and the security requirements for access. This approach may minimize the risk of unauthorized access and data breaches while enabling secure collaboration and data sharing among authorized users.

In one non-limiting example, infosec levels may be defined based on the types of data handled within DE models. Such levels could range from public, to confidential, secret, or could be specifically defined based on organizational levels where a digital artifact or a splice function at a given infosec level can only be read and/or edited and/or executed by a user having a matching or higher infosec level, or having a particular role in a project. A model splice may inherit the input DE model's infosec level, and each individual digital artifact or splice function contained within the model splice may be assigned the same infosec level. In some embodiments, the DE model owner creating the model splice, or an admin or managing user who understands the nature of the data and the potential impact of its disclosure, may specify infosec levels for individual digital artifacts or splice functions. Such infosec metadata may travel with the model splice, digital artifact(s), or splice function(s) to ensure that the security level is clear, no matter where the data is moved to and how the functions are invoked. When a model splice is shared, access control policies may be practiced to correspond with the defined infosec levels, to dictate who can access the model splice, data, or functions, based on their security clearance, role within an organization, and/or the context of access requests. With such infosec metadata, access control may be enforced at every access point or API/SDK endpoint of the DE model. When a user attempts to invoke a splice function to access a digital artifact, the infosec tag of the digital artifact and/or the splice function may be checked against the user's credentials and any active access control policies. Access may be granted if the user's clearance level meets or exceeds infosec level.

In a zero-trust model, verification is not a one-time event. The system may continuously monitor access and re-verify credentials and security levels to ensure that access remains appropriate. Any changes in a user's role, clearance level, or the data/functions' infosec level may trigger a re-evaluation of access permissions.

In some embodiments, a traceability and auditability policy may be implemented by tracking or tracing any access to or specific manipulation of a specific DE model via its model splice. In particular, a detailed audit log of all access attempts, both successful and unsuccessful, may be maintained, to enable traceability and to facilitate review of access patterns. Such event logs on any splice function execution or API endpoint transaction may be recorded as metadata, for example in an endpoint transaction database or as non-fungible tokens on a private blockchain.

Table 5 below shows exemplary endpoint metadata associated with the generation or execution of a model splice. Such metadata may be stored in a secure endpoint transaction database or on a private blockchain, and may be linked from, or contained in, the model splice itself. Such metadata may include model owner organization, model owner ID, user ID, access rights of user, device ID, device location according to IP number and geographic location identifiers, and ID for the model splice and splice functions, transaction commands related to the model splice and splice function calls, a time associated with each transaction command, and a value associated with the transaction. Other examples can include a function ID, a type of method to be called; a start time of the transaction; an end time of the transaction, a duration; the parameters of the call made by the model splice and splice function, the success of the call (e.g., either “TRUE” or “FALSE”); CPU cost time in money, time and cycles; and GPU cost time in money, time and cycles. Other examples are also possible.

TABLE 5
Exemplary Endpoint Metadata

| Model ID | 1 | |
|---|---|---|
| Model Address | 192.168.1.100 | |
| Wrapper ID | 1 | |
| Function ID | 1 | |
| METHOD | GET | |
| Started (Time) | Jan. 1, 2022 8:00 | |
| Finished (Time) | Jan. 1, 2022 8:15 | |
| Duration | 15 | mins |
| Value ($) | $50 | |
| API Call ID | 1001 | |
| Call Parameters | {“input1”: 5} | |
| Success? | TRUE | |
| Model Owner ID | 1 | |

| | |
|---|---|
| Model Org ID | Acme Inc |
| Model Type | NLP |
| Model Type ID | AI-Acme-1 |
| Encryption Type? | AES256 |
| CPU Cost (Time, $, cycles, etc.) | 0 sec, $0.50, 100 cycles |
| GPU Cost (Time, $, cycles, etc.) | 5 sec, $0.25, 100 cycles |

### Model Splicing Enables Zero-Trust Access for Several Reasons:

1. Model splice provides API endpoints for accessing model data.
2. Data security in the IDEP may follow a zero-trust approach for users, networks, and models with attribute-based access control for authorization.
3. Zero trust for models implies users are authenticated and authorized in order to use specific model splices for accessing specific API functions.
4. Endpoint metadata tracking allows access-based controls to specific functions of models for authorized users, and models can be digitally watermarked for traceability and auditability.

### Providing Training Data for AI

As discussed with reference to the system database 2480, in some embodiments, user inputs and actions, input DE model and the resulting model splice (e.g., data descriptors, model component details, specific digital artifact calculated from splice functions, etc.) may be stored and consolidated to provide core training data for AI-assisted capabilities that may enable the scalable sharing of large libraries of models and versatile linking of different models into digital threads. That is, such training data may be used to fine-tune AI algorithms which may assist users in creating model splices and/or digital threads.

The IDEP may also implement additional steps to ensure that the model splices created provide a continuous data stream that serves as training data for automation and AI-assisted capabilities. Example steps include, but are not limited to:
1. Determine which APIs and functions within the DE model are necessary to execute an identified workflow and user action.
2. Develop a model splice that links only the necessary APIs and functions, and captures data on user interactions with those APIs and functions.
3. Use the model splice to create a data stream that reflects user workflows and actions, as well as the specific API functions in specific model-type files.
4. Use the model splice actions dataset to automate user actions or feed into machine learning engines that perform predictive analytics on typical user actions or security audits.
5. Use the resulting data stream as a training dataset to fine-tune AI algorithms that can assist users in creating digital threads and performing other tasks related to the DE system.
6. Continue to capture data using the model splicer to improve the accuracy and effectiveness of the training dataset over time.
7. Enhance the training dataset using synthetic data generation, as well as customization for enterprise-specific models for customers.
8. Continuously evaluate and update the model splicer and training dataset to ensure they remain aligned with the evolving needs of the digital engineering system and the workflows and actions of users.

Thus, a model splicer's action dataset may be used to automate user actions, or feed into machine learning engines that perform predictive analytics on typical user actions, security audits, etc. The training dataset can also be enhanced using synthetic data generation and can be customized to train enterprise-specific models for customers.

### Testing-Related Data Collection

In FIG. 2, the Apps and Services (222) will include the testing process, with the AI-assistance linked with the machine learning engine (220). The dotted lines such as lines 2492a, 2492b, and 2492c in the embodiment of FIG. 24 illustrate the collection of user action data for testing-related purposes. Such data may be sent to a testing module or labeled as testing-related data within the DE database in order to enable easy access. The training of testing-related AI models such as the scenario machine learning (ML) model is a prime objective of testing-related data collection.

### Machine Learning (ML) and Neural Networks

Machine learning (ML) algorithms are characterized by the ability to improve their performance at a task over time without being explicitly programmed with the rules to perform that task (i.e., learn). An artificial intelligence (AI) model, or an ML model, is the trainable software module associated with an ML algorithm. As described herein, embodiments of the present invention use one or more ML algorithms to perform different operations required for the implementation of a digital task including but not limited to the generation of human-readable test scenarios and the generation of test scripts to test software functionalities in an IDMP, as well as the generation of other IDMP scripts such as data collection scripts, as disclosed herein. Various exemplary ML algorithms are within the scope of the present invention. The following description describes illustrative ML techniques for implementing various embodiments of the present invention.

### Neural Networks

A neural network is a computational model comprising interconnected units called “neurons” that work together to process information. It is a type of ML algorithm that is particularly effective for recognizing patterns and making predictions based on complex data. Neural networks are widely used in various applications such as image and speech recognition and natural language processing, due to their ability to learn from large amounts of data and improve their performance over time. FIG. 25 describes neural network operation fundamentals, according to exemplary embodiments of the present invention.

FIG. 25 shows a single-layered neural network, also known as a single-layer perceptron. The operation of a single-layered neural network involves the following steps:
1. Input: Receiving a digital task input (or a process step input) vector v (2504) with elements vⱼ, with j∈[1, n] representing the j^{th} digital task input, and where each element of the vector corresponds to an element 2506 in the input layer. For an exemplary neural network model trained to generate an IDMP script such as a testing script, the digital task input vector v (2504) may take the form of a contextual data file such as a human-readable test scenario generated from a scenario ML model. A digital task input may also be a user prompt, a template script, and/or any data relevant to the digital task, as described herein.
2. Transfer Function: Multiplying each element of the digital task input vector by a corresponding weight wⱼ(2508). These weighted inputs are then summed together (2510) as the transfer function, yielding the net input to the activation function

$${\sum }_{j = 1}^{n} {v}_{j} \cdot {w}_{j} .$$

Each neuron in a neural network may have a bias value 2512, which is added to the weighted sum of the inputs to that neuron. Both the weights and bias values are learned during the training process. The purpose of the bias is to provide every neuron with a trainable constant value that can help the model fit the data better. With biases, the net input to the activation function is

$${\sum }_{j = 1}^{n} \{ {v}_{j} \cdot {w}_{j} \} + b .$$

In the exemplary neural network model described above (e.g., to implement a test script-generating ML model), the value of the transfer function 2510 may represent the probability that a given platform script or test scenario will be output.
3. Activation Function: Passing the net input through an activation function 2514. The activation function σ determines the activation value σ (2518), which is the output of the neuron. It is typically a non-linear function such as a sigmoid or ReLU (Rectified Linear Unit) function. The threshold θ 2516 of the activation function is a value that determines whether a neuron is activated or not. In some activation functions, such as the step function, the threshold is a specific value. If the net input is above the threshold, the neuron outputs a constant value, and if it's below the threshold, it outputs a zero value. In other activation functions, such as the sigmoid or ReLU (Rectified Linear Unit) functions, the threshold is not a specific value but rather a point of transition in the function's curve.

In the exemplary neural network model described above (e.g., to implement a test script-generating ML model), the activation function σ (2514) may be a ReLU that is activated at a threshold θ (2516) representing the minimum probability for a given script to be generated. Hence, the activation function 2514 will yield the given script when the implementation likelihood exceeds the threshold θ (2516).
4. Output: The activation value o (2518) is the output of the activation function. This value is what gets passed on to the next layer in the network or becomes the final digital task (or process step) output in the case of the last layer. In the exemplary neural network model described above (e.g., to implement a test script-generating ML model), multiple activation values o (2518) from multiple layers of a neural network may be combined to generate a text variable representing the test script that has the highest likelihood of satisfying a given digital task input 2504 (e.g., accomplishing a given digital task or process step defined by the human-readable test scenario). A digital task (or process step) output may alternatively be a contextual data, an orchestration script, or any form of data relevant to the digital task, as described herein.

In the exemplary neural network discussions of FIG. 25, examples are provided with respect to a particular script-generating ML model implementation using neural networks. Analogous approaches can be used to implement test scenario-generating ML models that generate human-readable test scenarios based on user action data, collection ML models, context AI models, substitution ML models, and any other NN-based components of the systems and subsystems described herein.

FIG. 26 shows an overview of an IDMP neural network training process, according to exemplary embodiments of the present invention. The training of the IDMP neural network involves repeatedly updating the weights and biases 2610 of the network to minimize the difference between the predicted output 2604 and the true or target output 2606, where the predicted output 2604 is the result produced by the network when a set of inputs from a dataset is passed through it. The predicted output 2604 of an IDMP neural network 2602 corresponds to the digital task output 2518 of the final layer of the neural network. The true or target output 2606 is the true desired result. The difference between the predicted output and the true output is calculated using a loss function 2608, which quantifies the error made by the network in its predictions.

The loss function is a part of the cost function 2608, which is a measure of how well the network is performing over the whole dataset. The goal of training is to minimize the cost function 2608. This is achieved by iteratively adjusting the weights and biases 2610 of the network in the direction that leads to the steepest descent in the cost function. The size of these adjustments is determined by the learning rate 2608, a hyperparameter that controls how much the weights and biases change in each iteration. A smaller learning rate means smaller changes and a slower convergence towards the minimum of the cost function, while a larger learning rate means larger changes and a faster convergence, but with the risk of overshooting the minimum.

For an IDMP neural network model 2602 based on the exemplary neural network model (e.g., to implement a test script-generating ML model) discussed above in the context of FIG. 25, and trained to determine whether a given test script is to be implemented based on a given contextual data file input such as a human-readable test scenario generated by a scenario ML model:
the weights and biases 2610 are the IDMP neural network's hyperparameters that get updated at each iteration of the training process, as discussed in the context of FIG. 25,
the predicted output 2604 may be the binary prediction on whether a given test script is to be implemented based on a sample contextual data, (or a normalized score ranking prioritizing the order of scripts to be displayed to the user),
the true/target output 2606 is the correct decision (i.e., sample ground truth output) on whether to generate the given test script based on the sample contextual data,
the loss function 2608 is the difference between the evaluation and the true output (e.g., a binary error indicating whether the IDMP neural network's decision was correct),
the cost function 2608 is the average of all errors over a training dataset including sample contextual data files associated with digital tasks, and corresponding scripts implementing the associated digital tasks, and
the learning rate 2608 is the rate at which the cost function 2608 in consecutive training epochs approaches a pre-specified tolerable cost function.

Neural network training combines the processes of forward propagation and backpropagation. Forward propagation is the process where the input data is passed through the network from the input layer to the output layer. During forward propagation, the weights and biases of the network are used to calculate the output for a given input. Backpropagation, on the other hand, is the process used to update the weights and biases 2610 of the network based on the error (e.g., cost function) 2608 of the output. After forward propagation through the IDMP neural network 2602, the output 2604 of the network is compared with true output 2606, and the error 2608 is calculated. This error is then propagated back through the network, starting from the output layer and moving towards the input layer. The weights and biases 2610 are adjusted in a way that minimizes this error. This process is repeated for multiple iterations or epochs until the network is able to make accurate predictions.

The neural network training method described above, in which the network is trained on a labeled dataset (e.g., sample pairs of input user prompts and corresponding output recommendations), where the true outputs are known, is called supervised learning. In unsupervised learning, the network is trained on an unlabeled dataset, and the goal is to discover hidden patterns or structures in the data. The network is not provided with the true outputs, and the training is based on the intrinsic properties of the data. Furthermore, reinforcement learning is a type of learning where an agent learns to make decisions from the rewards or punishments it receives based on its actions. Although reinforcement learning does not typically rely on a pre-existing dataset, some forms of reinforcement learning can use a database of past actions, states, and rewards during the learning process. Any neural network training method that uses a labeled dataset is within the scope of the methods and systems described herein, as is clear from the overview below.

FIG. 27 provides additional details on the training process or an IDMP machine learning model such as a test scenario AI model, a test script AI model, a collection AI model, a context AI model, a syntax AI model, or a substitution ML model, according to exemplary embodiments of the present invention.

### Transformer Model Architecture

The transformer architecture is a neural network design that was introduced in the paper “Attention is All You Need” by Vaswani et al. (arxiv: 1706.03762, 2017), and incorporated herein by reference as if fully set forth herein. Large Language Models (LLMs) heavily rely on the transformer architecture.

The architecture (see FIG. 1 in Vaswani et al.) is based on the concept of “attention”, allowing the model to focus on different parts of the input sequence when producing an output. Transformers consist of an encoder and a decoder. The encoder processes the input data and the decoder generates the output. Each of these components is made up of multiple layers of self-attention and point-wise, fully connected layers.

The layers of self-attention in the transformer model allow it to weigh the relevance of different parts of the input sequence when generating an output, thereby enabling it to capture long-range dependencies in the data. On the other hand, the fully connected layers are used for transforming the output of the self-attention layers, adding complexity and depth to the model's learning capability.

The transformer model is known for its ability to handle long sequences of data, making it particularly effective for tasks such as machine translation and text summarization. In the transformer architecture, positional encoding is used to give the model information about the relative positions of the words in the input sequence. Since the model itself does not have any inherent sense of order or sequence, positional encoding is a way to inject some order information into the otherwise order-agnostic attention mechanism.

### The Embeddings Vector Space

In the context of neural networks, tokenization refers to the process of converting the input and output spaces, such as natural language text or programming code, into discrete units or “tokens”. This process allows the network to effectively process and understand the data, as it transforms complex structures into manageable, individual elements that the model can learn from and generate.

In the training of neural networks, embeddings serve as a form of distributed word representation that converts discrete categorical variables (i.e., tokens) into a continuous vector space (i.e., embedding vectors). This conversion process captures the semantic properties of tokens, enabling tokens with similar meanings to have similar embeddings. These embeddings provide a dense representation of tokens and their semantic relationships. Embeddings are typically represented as vectors, but may also be represented as matrices or tensors.

The input of a transformer typically requires conversion from an input space (e.g., the natural language token space) to an embeddings space. This process, referred to as “encoding”, transforms discrete inputs (tokens) into continuous vector representations (embeddings). This conversion is a prerequisite for the transformer model to process the input data and understand the semantic relationships between tokens (e.g., words). Similarly, the output of a transformer typically requires conversion from the embeddings space to an output space (e.g., natural language tokens, programming code tokens, etc.), in a process referred to as “decoding”. Therefore, the training of a neural network and its evaluation (i.e., its use upon deployment) both occur within the embeddings space.

In this document, the processes of tokenization, encoding, decoding, and de-tokenization may be assumed. In other words, the processes described below occur in the “embeddings space”. Hence, while the tokenization and encoding of training data and input prompts may not be represented or discussed explicitly, they may nevertheless be implied. Similarly, the decoding and de-tokenization of neural network outputs may also be implied.

### Training and Fine-Tuning Machine Learning (ML) Modules

FIG. 27 is an illustrative flow diagram showing the different phases and datasets involved in training an IDMP ML model such as a test scenario AI model, test script AI model, collection AI model, context AI model, a syntax AI model, or a substitution ML model, according to exemplary embodiments of the present invention.

The training process starts at step 2710 with digital task data acquisition, retrieval, assimilation, or generation. Digital tasks may include test scenario generation, test script generation, data collection, context generation, orchestration scripting, and other tasks related to the streamlined design, validation, verification, certification, assembly, operations, and maintenance processes of complex systems. At step 2720, acquired digital task data is pre-processed, or prepared. At step 2730, the IDMP ML model is trained using training data 2725. At step 2740, the IDMP ML model is evaluated, validated, and tested, and further refinements to the IDMP ML model are fed back into step 2730 for additional training. Once its performance is acceptable, at step 2750, optimal IDMP ML parameters are selected.

Training data 2725 is a dataset containing multiple instances of system inputs (e.g., user action data, user inputs, user prompts, DTw/PTw performance data, simulation data, and/or certification/requirement documents, etc.) and correct outcomes (e.g., human-readable test scenario, test script, contextual data, orchestration script, template script, digital model, placeholder variable, etc.). It trains the IDMP ML model to optimize the performance for a specific target task, such as the prediction of a specific target output data field within a specific target document. In FIG. 27, training data 2725 may also include subsets for validating and testing the IDMP ML model, as part of the training iterations 2730 and 2740. For an NN-based ML model, the quality of the output may depend on (a) NN architecture design and hyperparameter configurations, (b) NN coefficient or parameter optimization, and (c) quality of the training data set. These components may be refined and optimized using various methods. For example, training data 2725 may be expanded via a document database augmentation process.

In some embodiments, an additional fine-tuning 2760 phase including iterative fine-tuning 2760 and evaluation, validation, and testing 2770 steps, is carried out using fine-tuning data 2755. Fine-tuning in machine learning is a process that involves taking a selected 2750 pre-trained model and further adjusting or “tuning” its parameters to better suit a specific task or fine-tuning dataset 2755. This technique is particularly useful when dealing with deep learning models that have been trained on large, general training datasets 2725 and are intended to be applied to more specialized tasks or smaller datasets. The objective is to leverage the knowledge the model has already acquired during its initial training (often referred to as transfer learning) and refine it so that the model performs better on a more specific task at hand.

The fine-tuning process typically starts with a model that has already been trained on a large benchmark training dataset 2725, such as ImageNet (available at image-net(dot)org) for image recognition tasks. The model's existing weights, which have been learned from the original training, serve as the starting point. During fine-tuning, the model is trained further on a new fine-tuning dataset 2755, which may contain different classes or types of data than the original training set. This additional training phase allows the model to adjust its weights to better capture the characteristics of the new fine-tuning dataset 2755, thereby improving its performance on the specific task it is being fine-tuned for.

In some embodiments, additional test and validation 2780 phases are carried out using digital task test and validation data 2775. Testing and validation of a ML model both refer to the process of evaluating the model's performance on a separate dataset 2775 that was not used during training, to ensure that it generalizes well to new unseen data. Validation of a ML model helps to prevent overfitting by ensuring that the model's performance generalizes beyond the training data.

While the validation phase is considered part of ML model development and may lead to further rounds of fine-tuning, the testing phase is the final evaluation of the model's performance after the model has been trained and validated. The testing phase provides an unbiased assessment of the final model's performance that reflects how well the model is expected to perform on unseen data, and is usually carried out after the model has been finalized to ensure the evaluation is unbiased.

Once the IDMP ML model is trained 2730, selected 2750, and optionally fine-tuned 2760 and validated/tested 2780, the process ends with the deployment 2790 of the IDMP ML model. Deployed IDMP ML models 2795 usually receive new digital task data 2785 that was pre-processed 2780.

In machine learning, data pre-processing 2720 is tailored to the phase of model development. During model training 2730, pre-processing involves cleaning, normalizing, and transforming raw data into a format suitable for learning patterns. For fine-tuning 2760, pre-processing adapts the data to align with the distribution of the specific targeted task, ensuring the pre-trained model can effectively transfer its knowledge. Validation 2780 pre-processing mirrors that of training to accurately assess model generalization without leakage of information from the training set. Finally, in deployment 2790, pre-processing ensures real-world data matches the trained model's expectations, often involving dynamic adjustments to maintain consistency with the training and validation stages.

Unless otherwise stated, the methods and systems disclosed herein regarding training, particularly pertaining to training data collection, generally apply to tuning, fine-tuning, pre-training, and/or post-training.

### Machine Learning Algorithms

Various exemplary ML algorithms are within the scope of the present invention. Such machine learning algorithms include, but are not limited to, random forest, nearest neighbor, decision trees, support vector machines (SVM), Adaboost, gradient boosting, Bayesian networks, evolutionary algorithms, various neural networks (including deep learning networks (DLN), convolutional neural networks (CNN), and recurrent neural networks (RNN)), etc.

ML modules based on transformers and Large Language Models (LLMs) are particularly well suited for the tasks described herein. The online article “Understanding Large Language Models—A Transformative Reading List”, by S. Raschka (posted Feb. 7, 2023, available at sebastianraschka(dot)com/blog/2023/llm-reading-list.html), describes various LLM architectures that are within the scope of the methods and systems described herein, and is hereby incorporated by reference in its entirety herein as if fully set forth herein.

The input to each of the listed ML modules is a feature vector comprising the input data described above for each ML module. The output of the ML module is a feature vector comprising the corresponding output data described above for each ML module.

Prior to deployment, each of the ML modules listed above may be trained on one or more respective sample input datasets and on one or more corresponding sample output datasets. The input and output training datasets may be generated from a database containing a history of input instances (e.g., user inputs, user prompts, contextual data files, task-related documents, template scripts, placeholder variables) and output instances (e.g., contextual data files, template scripts, orchestration scripts, placeholder variables), or may be generated synthetically by subject matter experts.

### Exemplary System Architecture

An exemplary embodiment of the present disclosure may include one or more servers (management computing entities), one or more networks, and one or more clients (user computing entities). Each of these components, entities, devices, and systems (similar terms used herein interchangeably) may be cloud-based, and in direct or indirect communication with, for example, one another over the same or different wired or wireless networks. All of these devices, including servers, clients, and other computing entities or nodes may be run internally by a customer (in various architecture configurations including private cloud), internally by the provider of the IDMP (in various architecture configurations including private cloud), and/or on the public cloud.

FIG. 28 provides illustrative schematics of a server (management computing entity) 2810 connected via a network 2820 to a client (user computing entity) 2830 used for documentation within an interconnected digital model platform (IDMP), according to some embodiments of the present invention. While FIG. 28 illustrates the various system entities as separate, standalone entities, the various embodiments are not limited to this particular architecture. Additionally, the terms “client device”, “client computing entity”, “edge device”, and “edge computing system” are equivalent and are used interchangeably herein.

### Exemplary Management Computing Entity

An illustrative schematic is provided in FIG. 28 for a server or management computing entity 2810. In general, the terms computing entity, computer, entity, device, system, and/or similar words used herein interchangeably may refer to, for example, one or more cloud servers, computers, computing entities, desktop computers, mobile phones, tablets, phablets, notebooks, laptops, distributed systems, gaming consoles, watches, glasses, iBeacons, proximity beacons, key fobs, radio frequency identification (RFID) tags, earpieces, scanners, televisions, dongles, cameras, wristbands, wearable items/devices, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, crawling, displaying, storing, determining, creating/generating, monitoring, evaluating, and/or comparing (similar terms used herein interchangeably). In one embodiment, these functions, operations, and/or processes can be performed on data, content, and/or information (similar terms used herein interchangeably), as they are used in a digital task or process step.

In one embodiment, management computing entity 2810 may be equipped with one or more communication interfaces 2812 for communicating with various computing entities, such as by exchanging data, content, and/or information (similar terms used herein interchangeably) that can be transmitted, received, operated on, processed, displayed, stored, and/or the like. For instance, management computing entity 2810 may communicate with one or more client computing devices such as 2830 and/or a variety of other computing entities. Network or communications interface 2812 may support various wired data transmission protocols including, but not limited to, Fiber Distributed Data Interface (FDDI), Digital Subscriber Line (DSL), Ethernet, Asynchronous Transfer Mode (ATM), frame relay, and data over cable service interface specification (DOCSIS). In addition, management computing entity 2810 may be capable of wireless communication with external networks, employing any of a range of standards and protocols, including but not limited to, general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High-Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

As shown in FIG. 28, in one embodiment, management computing entity 2810 may include or be in communication with one or more processors 2814 (also referred to as processors and/or processing circuitry, processing elements, and/or similar terms used herein interchangeably) that communicate with other elements within management computing entity 2810, for example, via a bus. As will be understood, processor 2814 may be embodied in a number of different ways. For example, processor 2814 may be embodied as one or more complex programmable logic devices (CPLDs), microprocessors, multi-core processors, co-processing entities, application-specific instruction-set processors (ASIPs), graphical processing units (GPUs), microcontrollers, and/or controllers. The term circuitry may refer to an entire hardware embodiment or a combination of hardware and computer program products. Thus, processor 2814 may be embodied as integrated circuits (ICs), application-specific integrated circuits (ASICs), field-programmable gate arrays (FPGAs), programmable logic arrays (PLAs), hardware accelerators, other circuitry, and/or the like. As will therefore be understood, processor 2814 may be configured for a particular use or configured to execute instructions stored in volatile or non-volatile (or non-transitory) media 2816 and 2818, or otherwise accessible to processor 2814. As such, whether configured by hardware or computer program products, or by a combination thereof, processor 2814 may be capable of performing steps or operations according to embodiments of the present disclosure when configured accordingly.

In one embodiment, management computing entity 2810 may further include or be in communication with non-transitory memory 2818 (also referred to as non-volatile media, non-volatile storage, non-transitory storage, physical storage media, memory, memory storage, and/or memory circuitry—similar terms used herein interchangeably). In one embodiment, the non-transitory memory or storage may include one or more non-transitory memory or storage media, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile (or non-transitory) storage or memory media may store cloud storage buckets, databases, database instances, database management systems, data, applications, programs, program modules, scripts, source code, object code, byte code, compiled code, interpreted code, machine code, executable instructions, and/or the like. The term database, database instance, and/or database management system (similar terms used herein interchangeably) may refer to a collection of records or data that is stored in a computer-readable storage medium using one or more database models, such as a hierarchical database model, network model, relational model, entity-relationship model, object model, document model, semantic model, graph model, and/or the like.

In one embodiment, management computing entity 2810 may further include or be in communication with volatile memory 2816 (also referred to as volatile storage, memory, memory storage, memory and/or circuitry—similar terms used herein interchangeably). In one embodiment, the volatile storage or memory may also include one or more volatile storage or memory media, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, processor 2814. Thus, the cloud storage buckets, databases, database instances, database management systems, data, applications, programs, program modules, scripts, source code, object code, byte code, compiled code, interpreted code, machine code, executable instructions, and/or the like may be used to control certain aspects of the operation of management computing entity 2810 with the assistance of processor 2814 and an operating system.

Although not shown, management computing entity 2810 may include or be in communication with one or more input elements, such as a keyboard input, a mouse input, a touch screen/display input, motion input, movement input, audio input, pointing device input, joystick input, keypad input, and/or the like. Management computing entity 2810 may also include or be in communication with one or more output elements, also not shown, such as audio output, visual output, screen/display output, motion output, movement output, spatial computing output (e.g., virtual reality or augmented reality), and/or the like.

As will be appreciated, one or more of the components of management computing entity 2810 may be located remotely from other management computing entity components, such as in a distributed system. Furthermore, one or more of the components may be combined and additional components performing functions described herein may be included in management computing entity 2810. Thus, management computing entity 2810 can be adapted to accommodate a variety of needs and circumstances. As will be recognized, these architectures and descriptions are provided for exemplary purposes only and are not limited to the various embodiments.

### Exemplary User Computing Entity

A user may be a human individual, a company, an organization, an entity, a department within an organization, a representative of an organization and/or person, an artificial user such as algorithms, artificial intelligence, or other software that interfaces, and/or the like. FIG. 28 further provides an illustrative schematic representation of a client user computing entity 2830 that may be used in conjunction with embodiments of the present disclosure. In various embodiments, computing device 2830 may be a general-purpose computing device with dedicated modules for performing digital engineering-related tasks. It may alternatively be implemented in the cloud, with logically and/or physically distributed architectures.

As shown in FIG. 28, user computing entity 2830 may include a power source 2831, an antenna 2870, a radio transceiver 2832, a network and communication interface 2834, and a processor unit 2840 that provides signals to and receives signals from the network and communication interface. The signals provided to and received may include signaling information in accordance with air interface standards of applicable wireless systems. In this regard, user computing entity 2830 may be capable of operating with one or more air interface standards, communication protocols, modulation types, and access types. More particularly, user computing entity 2830 may operate in accordance with any of a number of wireless communication standards and protocols, such as those described above with regard to management computing entity 2810. Similarly, user computing entity 2830 may operate in accordance with multiple wired communication standards and protocols, such as those described above with regard to management computing entity 2810.

Via these communication standards and protocols, user computing entity 2830 may communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). User computing entity 2830 may also download changes, add-ons, and updates, for instance, to its firmware, software (e.g., including executable instructions, applications, program modules), and operating system.

In some implementations, processing unit 2840 may be embodied in several different ways. For example, processing unit 2840 may be embodied as one or more complex programmable logic devices (CPLDs), microprocessors, multi-core processors, co-processing entities, application-specific instruction-set processors (ASIPs), graphical processing units (GPUs), microcontrollers, and/or controllers. Further, processing unit 2840 may be embodied as one or more other processing devices or circuitry. The term circuitry may refer to an entire hardware embodiment or a combination of hardware and computer program products. Thus, processing unit 2840 may be embodied as integrated circuits, application specific integrated circuits (ASICs), field programmable gate arrays (FPGAs), programmable logic arrays (PLAs), hardware accelerators, other circuitry, and/or the like. As will therefore be understood, processing unit 2840 may be configured for a particular use or configured to execute instructions stored in volatile or non-volatile media or otherwise accessible to the processing unit. As such, whether configured by hardware or computer program products, or by a combination thereof, processing unit 2840 may be capable of performing steps or operations according to embodiments of the present invention when configured accordingly.

In some embodiments, processing unit 2840 may comprise a control unit 2842 and a dedicated arithmetic logic unit (ALU) 2844 to perform arithmetic and logic operations. In some embodiments, user computing entity 2830 may comprise a graphics processing unit (GPU) 2846 for specialized parallel processing tasks, and/or an artificial intelligence (AI) module or accelerator 2848, also specialized for applications including artificial neural networks and machine learning. In some embodiments, processing unit 2840 may be coupled with GPU 2846 and/or AI accelerator 2848 to distribute and coordinate digital workflow related tasks.

In some embodiments, computing entity 2830 may include a user interface, comprising an input interface 2850 and an output interface 2852, each coupled to processing unit 2840. User input interface 2850 may comprise any of a number of devices or interfaces allowing computing entity 2830 to receive data, such as a keypad (hard or soft), a touch display, a mic/speaker for voice/speech/conversation, a camera for motion or posture interfaces, and appropriate sensors for spatial computing interfaces. User output interface 2852 may comprise any of a number of devices or interfaces allowing computing entity 2830 to provide information to a user, such as through the touch display, or a speaker for audio outputs. In some embodiments, output interface 2852 may connect computing entity 2830 to an external loudspeaker or projector, for audio and/or visual output. In some embodiments, user interfaces 2850 and 2852 integrate multimodal data in an interface that caters to human users. Some examples of human interfaces include a dashboard-style interface, a workflow-based interface, conversational interfaces, and spatial-computing interfaces. As shown in FIG. 5, computing entity 2830 may also support bot/algorithmic interfaces such as code interfaces, text-based API interfaces, and the like.

User computing entity 2830 can also include volatile and/or non-volatile storage or memory 2860, which can be embedded and/or may be removable. For example, the non-volatile or non-transitory memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile (or non-transitory) storage or memory 2860 may store an operating system 2862, application software 2864, data 2866, databases, database instances, database management systems, data, applications, programs, program modules, scripts, source code, object code, byte code, compiled code, interpreted code, machine code, executable instructions, and/or the like to implement functions of user computing entity 2830. As indicated, this may include a user application that is resident on the entity or accessible through a browser or other user interface for communicating with management computing entity 2810 and/or various other computing entities.

In some embodiments, user computing entity 2830 may include one or more components or functionalities that are the same or similar to those of management computing entity 2810, as described in greater detail above. As will be recognized, these architectures and descriptions are provided for exemplary purposes only and are not limited to the various embodiments.

In some embodiments, computing entities 2810 and/or 2830 may communicate to external devices like other computing devices and/or access points to receive information such as software or firmware, or to send information from the memory of the computing entity to external systems or devices such as servers, computers, smartphones, and the like.

In some embodiments, two or more computing entities such as 2810 and/or 2830 may establish connections using a network such as 2820 utilizing any of the networking protocols listed previously. In some embodiments, the computing entities may use network interfaces such as 2812 and 2834 to communicate with each other, such as by communicating data, content, information, and/or similar terms used herein interchangeably that can be transmitted, received, operated on, processed, displayed, stored, and/or the like.

### Additional Hardware & Software Implementation Details

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The terms “processor”, “computer,” “data processing apparatus”, and the like encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing, and grid computing infrastructures.

A computer program (also known as a program, software, software application, script, code, program code, and the like) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read only memory or a random-access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media, and memory devices, including by way of example semiconductor memory devices, e.g., EPROM, EEPROM, and flash memory devices; magnetic disks, e.g., internal hard disks or removable disks; magneto-optical disks; and CD ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a backend component, e.g., as an information/data server, or that includes a middleware component, e.g., an application server, or that includes a frontend component, e.g., a client computer having a graphical user interface or a web browser through which a user can interact with an implementation of the subject matter described herein, or any combination of one or more such back end, middleware, or front end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship with each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any embodiment or of what may be claimed, but rather as descriptions of features specific to particular embodiments. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

In some embodiments of the present invention, the entire system can be implemented and offered to the end-users and operators over the Internet, in a so-called cloud implementation. No local installation of software or hardware would be needed, and the end-users and operators would be allowed access to the systems of the present invention directly over the Internet, using either a web browser or similar software on a client, which client could be a desktop, laptop, mobile device, and so on. This eliminates any need for custom software installation on the client side and increases the flexibility of delivery of the service (software-as-a-service), and increases user satisfaction and ease of use. Various business models, revenue models, and delivery mechanisms for the present invention are envisioned, and are all to be considered within the scope of the present invention.

In general, the method executed to implement the embodiments of the invention, may be implemented as part of an operating system or a specific application, component, program, object, module, or sequence of instructions referred to as “program code,” “computer program(s)”, “computer code(s),” and the like. The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually affect the distribution. Examples of computer-readable media include but are not limited to recordable type media such as volatile and non-volatile (or non-transitory) memory devices, floppy and other removable disks, hard disk drives, optical disks, which include Compact Disk Read-Only Memory (CD ROMS), Digital Versatile Disks (DVDs), etc., as well as digital and analog communication media.

### Terminology

Some illustrative terminologies used with the IDMP are provided below to assist in understanding the present invention, but these are not to be read as restricting the scope of the present invention. The terms may be used in the form of nouns, verbs, or adjectives, within the scope of the definition.
Digital engineering (DE): According to the Defense Acquisition University (DAU) and the Department of Defense (DOD) Digital Engineering Strategy published in 2018, digital engineering is “an integrated digital approach to systems engineering, using authoritative sources of systems' data and models as a continuum across disciplines to support lifecycle activities from concept through disposal.” Digital engineering incorporates digital technological innovations into an integrated, model-based approach that empowers a paradigm shift from the traditional design-build-test methodology of systems engineering to a new model-analyze-build methodology, thus enabling systems design, prototyping, and testing all in a virtual environment.
DE data: Digital engineering (DE) data includes project management, program management, product management, design review, and/or engineering data.
DE data field: A data field for DE data, for example, in a DE document template.
Phases: The stages within a DE product lifecycle, including but not limited to, stakeholder analysis, concept studies, requirements definition, preliminary design and technology review, system modeling, final design, implementation, system assembly and integration, prototyping, verification and validation on system, sub-system, and component levels, and operations and maintenance.
DE model: A computer-generated model that represents characteristics or behaviors of a complex product, system, or process. A DE model can be created or modified using a DE tool, and a DE model may be represented by one or more DE model files. A DE model file is the computer model file created or modified using the DE tool. In the present disclosure, the terms “digital model”, “DE model” and “DE model file” may be used interchangeably, as the context requires. A DE model within the IDEP as disclosed herein refers to any digital file uploaded onto the platform, including documents that are appropriately interpreted, as defined below. For example, a computer-aided design (CAD) file, a Systems Modeling Language (SysML) file, a Systems Requirements Document (SDR) text file, and a Neural Network Model JSON file may each be considered a DE model, in various embodiments of the present invention. A DE model may be machine-readable only, may be human-readable as well but written in programming codes, or may be human-readable and written in natural language-based texts. For example, a word-processing document comprising a technical specification of a product, or a spreadsheet file comprising technical data about a product, may also be considered a DE model. A DE model is a type of digital model, defined below. In general, any reference to a DE model in the specification and drawings may be considered equivalent to a reference to a digital model, and vice versa.
Interconnected Digital Engineering Platform (IDEP), also referred to as a “Digital Engineering and Certification Ecosystem”: According to the DAU, a “DE ecosystem” is the “interconnected infrastructure, environment, and methodology (process, methods, and tools) used to store, access, analyze, and visualize evolving systems' data and models to address the needs of the stakeholders.” Embodiments of the IDEP as disclosed herein comprise software platforms running on hardware to realize the aforementioned capabilities under zero-trust principles. Specifically, an embodiment of the IDEP is a software platform that interconnects a plurality of spliced DE model files through one or more software-defined digital threads (see FIGS. 1-4). A DE and certification ecosystem performs verification and validation tasks, defined next. An IDEP may be considered a type of Interconnected Digital Model Platform (IDMP) when one or more of the digital models are engineering or science related, the IDMP being defined below. In general, any reference to an IDEP in the specification and drawings can be considered equivalent to a reference to an IDMP, and vice versa, and any feature, embodiment, or description in relation to one applies analogously to the other. The terms “Interconnected” and “Integrated” are used interchangeably herein.
Verification: According to the DAU, verification “confirms that a system element meets design-to or build-to specifications. Through the system's life cycle, design solutions at all levels of the physical architecture are verified through a cost-effective combination of analysis, examination, demonstration, and testing.” Verification refers to evaluating whether a product, service, or system meets specified requirements and is fit for its intended purpose, checking externally against customer or stakeholder needs. For example, in the aerospace industry, a verification process may include testing an aircraft component to ensure it can withstand the forces and conditions it will encounter during flight.
Validation: According to the DAU, validation is “1) the review and approval of capability requirement documents by a designated validation authority. 2) The process by which the contractor (or as otherwise directed by the DoD component procuring activity) tests a publication/technical manual for technical accuracy and adequacy. 3) The process of evaluating a system or software component during, or at the end of, the development process to determine whether it satisfies specified requirements.” Thus, validation refers to evaluating whether the overall performance of a product, service, or system is suitable for its intended use, including its compliance with regulatory requirements, and its ability to meet the needs of its intended users, checking internally against specifications and regulations. For example, for an industrial product manufacturing, a validation process may include consumer surveys that inform product design, modeling and simulations for validating the design, prototype testing for failure limits and feedback surveys from buyers.
Common Verification & Validation (V&V) products: Regulatory and certification standards, compliances, calculations, and tests (e.g., for the development, testing, and certification of products and/or solutions) are referred to herein as “common V&V products.”
DE tool: A tool or DE tool is a DE application software (e.g., a CAD software), computer program, and/or script that creates or manipulates a DE model during at least one stage or phase of a product lifecycle. A DE tool may comprise multiple functions or methods.
Application Programming Interface (API): A software interface that provides programmatic access to services by a software program, thus allowing application software to exchange data and communicate with each other using standardized requests and responses. It allows different programs to work together without revealing the internal details of how each works. A DE tool is typically provided with an API library for code-interface access.
Script: A computer-executable sequence of instructions that is interpreted and run within or carried out by another program, without compilation into a binary file to be run by itself through a computer processor without the support of other programs.
API scripts: Scripts that implement particular functions available via the IDEP as disclosed herein. An API script may be an API function script encapsulated in a model splice, or an “orchestration script” or “platform script” that orchestrates a workflow through a digital thread built upon interconnected model splices.
Platform API or IDEP/IDMP API: A library of API scripts available on the IDEP/IDMP as disclosed herein.
API function scripts, “splice functions,” “splice methods,” “ISTARI functions,” or “function nodes”: A type of API scripts. When executed, an API function script inputs into or outputs from a DE model or DE model splice. An “input” function, input method, or “input node” allows updates or modifications to an input DE model. An “output” function, output method, or “output node” allows data extraction or derivation from an input DE model via its model splice. An API function script may invoke native API function calls of native DE tools, where the terms “native” and “primal” may refer to existing DE model files, functions, and API libraries associated with specific third-party DE tools, including both proprietary and open-source ones.
Endpoints: an endpoint in the context of software and networking is a specific digital location or destination where different software systems communicate with each other. It enables external systems to access the features or data of an application, operating system, or other services. An API endpoint is the point of interaction where APIs receive requests and return data in response. A software development kit (SDK) endpoint or SDK-defined endpoint similarly provides a service handle for use with an SDK. References to API endpoints in the present disclosure are equally applicable to SDK endpoints.
Artifact: According to the DAU, a digital artifact is “an artifact produced within, or generated from, a DE ecosystem” to “provide data for alternative views to visualize, communicate, and deliver data, information, and knowledge to stakeholders.” In the present disclosure, a “digital artifact” or “artifact” is an execution result from an output API function script within a model splice. Multiple artifacts may be generated from a single DE model or DE model splice.
Model splice: Within the present disclosure, a “model splice”, “model wrapper”, or “model graft” of a given DE model file comprises locators to or copies of (1) DE model data or digital artifacts extracted or derived from the DE model file, including model metadata, and (2) splice functions (e.g., API function scripts) that can be applied to the DE model data. The splice functions provide unified and standardized input and output API endpoints for accessing and manipulating the DE model data. The DE model data are model-type-specific, and a model splice is associated with model-type-specific input and output schemas. One or more different model splices may be generated from the same input DE model file(s), based on the particular user application under consideration, and depending on data access restrictions. In some contexts, the shorter terms “splice”, “wrapper”, and/or “graft” are used to refer to spliced, wrapped, and/or grafted DE models.
Model representation: Within the present disclosure, “model representation” of a given DE model includes any embodiment of the engineering model in the form of DE model file(s), model splices, or collections of digital artifacts derived from the DE model. In some embodiments, a DE model representation comprises model-type-specific locators to DE model data and metadata, potentially including standardized input and output API endpoints for accessing and manipulating the DE model data. Discussions related to the usage of model splices in the present disclosure are applicable to any other forms of model representation as well.
Model splicing or DE model splicing: A process for generating a model splice from a DE model file. DE model splicing encompasses human-readable document model splicing, where the DE model being spliced is a human-readable text-based document.
Model splicer: Program code or script (uncompiled) that performs model splicing of DE models. A DE model splicer for a given DE model type, when applied to a specific DE model file of the DE model type, retrieves, extracts, or derives DE model data associated with the DE model file, generates and/or encapsulates splice functions and instantiates API endpoints according to input/output schemas.
Model splice linking: Generally, model splice linking refers to jointly accessing two or more DE model splices via API endpoints or splice functions. For example, data may be retrieved from one splice to update another splice (e.g., an input splice function of a first model splice calls upon an output splice function of a second model splice); data may be retrieved from both splices to generate a new output (e.g., output splice functions from both model splices are called upon); data from a third splice may be used to update both a first and a second splice (e.g., input splice functions from both model splices are called upon). In the present disclosure, “model linking” and “model splice linking” may be used interchangeably, as linked model splices map to correspondingly linked DE models.
Digital thread, Software-defined digital thread, Software-code-defined digital thread, or Software digital thread: According to the DAU, a digital thread is “an extensive, configurable and component enterprise-level analytical framework that seamlessly expedites the controlled interplay of authoritative technical data, software, information, and knowledge in the enterprise data-information-knowledge systems, based on the digital system model template, to inform decision makers throughout a system's lifecycle by providing the capability to access, integrate, and transform disparate data into actionable information.” Within the IDEP as disclosed herein, a digital thread is a platform script that calls upon the platform API to facilitate, manage, or orchestrate a workflow through linked model splices to provide the aforementioned capabilities. That is, a digital thread within the IDEP is a computer-executable script that connects data from one or more DE models, data sources, or physical artifacts to accomplish a specific mission or business objective, and may be termed a “software-defined digital thread” or “software digital thread” that implements a communication framework or data-driven architecture that connects traditionally siloed DE models to enable seamless information flow among the DE models via model splices. In various embodiments, a digital thread associated with a digital twin is configured to execute a scripted workflow associated with the DTw.
Tool linking: Similar to model splice linking, tool linking generally refers to jointly accessing two or more DE tools via model splices, where model splice functions that encapsulate disparate DE tool functions are called upon jointly to perform a DE task.
Zero-trust security: An information security principle based on the assumption of no implicit trust between any elements, agents, or users. Zero trust may be carried out by implementing systematic mutual authentication and least privileged access, typically through strict access control, algorithmic impartiality, and data isolation. Within the IDEP as disclosed herein, least privileged access through strict access control and data isolation may be implemented via model splicing and the IDEP system architecture.
Hyperscale capabilities: The ability of a system architecture to scale adequately when faced with massive demand.
IDEP enclave or DE platform enclave: A central command hub responsible for the management and functioning of DE platform operations. An enclave is an independent set of cloud resources that are partitioned to be accessed by a single customer (i.e., single-tenant) or market (i.e., multi-tenant) that does not take dependencies on resources in other enclaves.
IDEP exclave or DE platform exclave: A secondary hub situated within a customer environment to assist with customer DE tasks and operations. An exclave is a set of cloud resources outside enclaves managed by the IDEP, to perform work for individual customers. Examples of exclaves include virtual machines (VMs) and/or servers that the IDEP maintains to run DE tools for customers who may need such services.
Digital twin: According to the DAU, a digital twin is “a virtual replica of a physical entity that is synchronized across time. Digital twins exist to replicate configuration, performance, or history of a system. Two primary sub-categories of digital twin are digital instance and digital prototype.” A digital instance is “a virtual replica of the physical configuration of an existing entity; a digital instance typically exists to replicate each individual configuration of a product as-built or as-maintained.” A digital prototype is “an integrated multi-physical, multiscale, probabilistic model of a system design; a digital prototype may use sensor information and input data to simulate the performance of its corresponding physical twin; a digital prototype may exist prior to realization of its physical counterpart.” Thus, a digital twin is a real-time virtual replica of a physical object or system, with bi-directional information flow between the virtual and physical domains. In some embodiments, a digital twin is a digital replica configured to run in a virtual environment and instantiated through a scripted digital thread, where the digital thread accesses data (e.g., digital artifacts) from a set of digital models through splicing. A digital twin may be instantiated, run, or executed, through a digital thread. Updating a digital twin may include the actions of modifying, deleting, and/or adding data to its twin configuration, to an associated digital thread, or to an associated digital model associated with the updated digital twin. In one embodiment, digital twins may be ephemeral and may have in-built time and space restrictions (see “twin configuration” definition below). In various embodiments, a physical twin is a physical object instantiated in a physical environment based on a set of model files through an MBSE manufacturing and/or prototyping process. In various embodiments, digital twins can be created for both physical products and physical processes. They are not limited to tangible items like machinery or vehicles; they can also simulate complex physical processes, such as manufacturing workflows or supply chain logistics, to improve efficiency and predict outcomes. This flexibility allows digital twins to be applied across various industries and scenarios.
Authoritative twin: A reference design configuration at a given stage of a product life cycle. At the design stage, an authoritative twin is the twin configuration that represents the best design target. At the operational stage, an authoritative twin is the twin configuration that best responds to the actual conditions on the ground or “ground-truths”.
Admins or Administrators: Project managers or other authorized users. Admins may create templates in the documentation system and have high-level permissions to manage settings in the IDEP.
Requesters: Users who use the platform for the implementation of the modeling and simulations towards certification and other purposes, and who may generate documentation in the digital documentation system, but do not have admin privileges to alter the required templates, document formats, or other system settings.
Reviewers/Approvers: Users who review and/or approve templates, documents, or other system data.
Contributors: Users who provide comments or otherwise contribute to the IDEP.
Digital Model: A computer-generated model that represents characteristics or behaviors of a complex product, system, or process. Digital models include DE models but are not limited to the field of digital engineering. For example, digital models include medical model files used to build digital twins of patients (e.g., digital patients), such as clinical documentation, laboratory results, physiological test results, psychological test results, patient communications and reports, patient medical data, health records, remote monitoring data, and the like. Digital models also include the financial models used to build digital twins of financial assets, such as enterprise data, business financial data, process data (e.g., manufacturing, logistics, sales, supply chain), research results, etc. Other examples of digital models are also within the scope of the present invention, for example, scientific models, geophysical models, climate models, biological models, biochemical models, chemical models, drug models, petrochemical models, oceanographic models, business process models, management science models, economic models, econometric models, sociological models, population dynamics models, socioeconomic models, planetary science models, mining models, mineral models, metallurgical models, supply chain logistics models, manufacturing models, and so on. Digital models include one or more digital artifacts, where each digital artifact is accessible with a security network. A model file can be created or modified using a software tool. A model file within the IDMP as disclosed herein refers to any digital file uploaded onto the platform. All the terms and concepts defined above and included herein, including model splicing, model splices, and software-defined digital threads, apply in the context of the digital model and within the context of the IDMP.
Interconnected Digital Model Platform (IDMP): Embodiments of the IDMP as disclosed herein include interconnected infrastructure, environment, and methodology (process, methods, and tools) used to store, access, analyze, visualize, and modify data and digital models associated with a product or system. In some embodiments, IDMPs include software platforms running on hardware to realize the aforementioned capabilities under zero-trust principles. Specifically, an embodiment of the IDMP is a software platform that interconnects a plurality of spliced model files through one or more software-defined digital threads. The expressions “Interconnected Digital Model Platform” and “Integrated Digital Model Platform” are used interchangeably herein. Any feature, embodiment, or description disclosed in relation to the IDEP, applies equally to the IDMP, and vice versa.
Security Network: A set of networked resources having identical access control restrictions (e.g., a security level), where each networked resource provides access to one or more digital model files. Information security networks are security networks that are configured to maintain the confidentiality, integrity, and availability of digital information (e.g., digital model data) through cybersecurity measures such as encryption, firewalls, intrusion detection systems, and access controls.
External Feedback: In various embodiments, external feedback comprises feedback data from at least one source external to a given digital twin, including digital twin performance data as received, analyzed or processed by the IDMP. External feedback may also include physical twin performance data, data from a virtual sensor, data from a physical sensor, user input (e.g., a user prompt, or a user response over a GUI), data from a simulation, a product certification file, or a product requirements file. In some embodiments, external feedback may also include feedback from control algorithms or processes in the IDMP that track digital twin performance (e.g., tracking error levels and/or tolerance between digital and corresponding physical twin data). External feedback data can also include feedback data that is external to the IDMP.
Twin Configuration: A twin configuration includes data specifying the configuration of a digital or a physical twin. Twin configurations may include a twin version identifier identifying the digital twin, one or more digital thread identifiers identifying the digital threads responsible for instantiating and running a twin, one or more model representation identifiers (e.g., URIs) identifying the model representations that are used by the twin, and an authoritative twin indicator (e.g., a boolean or binary variable) indicating whether the twin is an authoritative twin. The various twin configurations associated with the various physical and digital twins of a given product may be stored in a twin configuration set of the IDMP. In some embodiments, the twin configuration set acts as a specification database for the various digital and physical twins for one or more products or systems. In some embodiments, the twin configuration of a digital twin may include time and space restrictions on the associated digital twin, such as a validity time frame, a validity cutoff time, a validity space, or a validity geographical area (e.g., geofencing, proximity to another twin configuration).
Zero-knowledge approach: A zero-knowledge approach in data operations refers to a method where computational processes and data analyses are conducted such that the underlying data remains completely confidential and undisclosed to the parties performing the operations. This technique enables the validation, aggregation, and processing of data without exposing the actual data content, thereby preserving privacy and confidentiality.
Workflow: A workflow typically representing an entire process or sequence of operations that achieves a specific goal or outcome. It encompasses the complete set of activities, from initiation to completion, that are required to fulfill a business process or software function. Workflows often involve multiple participants, systems, or departments and can be complex, involving branching paths, decision points, and parallel processes.
Digital Workflow: A digital workflow refers to a series of digital tasks and process steps that are carried out electronically to achieve a specific outcome. Digital workflows involve the use of digital tools, software applications, and technologies to streamline and manage various activities within an organization or project. They often enable full or partial automation, and typically include elements such as data input, information processing, task assignment, approval processes, and document management, all conducted in a digital environment.
Tasks and Process Steps: A task is usually a subset of a workflow and represents a discrete unit of work that needs to be completed as part of the larger process. Tasks are more specific and focused than workflows and are often assigned to individual agents. They have defined inputs, outputs, and objectives. Multiple tasks typically make up a workflow, and each task contributes to the overall goal of the workflow. A process step, or simply “step”, in turn, is the smallest unit of work within this hierarchy. Process steps are the individual actions or operations that, when combined, form a task. They are highly specific, often atomic actions that represent the most granular level of detail in a workflow. Multiple process steps are usually required to complete a single task, and the successful execution of all steps results in the completion of the task. In the context of digital workflows, the terms “digital task”, “digital workflow task”, and “digital engineering task” are used interchangeably herein.
Digital Task Implementation: An orchestration script, or a platform script, may be generated over the IDMP to implement a digital task including one or more process steps, where the “implementation” of the digital task through an orchestration script means that the orchestration script includes instructions carrying out each process step required to complete the digital task.
Resource-capability mapping: A framework for identifying and linking available resources with the capabilities they enable or support. An exemplary resource-capability mapping is the IDMP API, or platform API, where the resource refers to third-party tools and functions integrated into and accessible via the IDMP, and where the exemplary capability refers to IDMP functions written in scripts for completing certain tasks using the available resource. Such resource-capability mappings may be used to identify how tool-specific resources such as tool functions, access and control capabilities, human-machine interfaces, processes, and objects can be allocated, invoked, and utilized efficiently and effectively to achieve specific IDMP platform functions or tasks. Resource capability mapping also assists with zero-knowledge implementations where the capability details are available to a user while the specific digital tool resource or its functions are only mapped within the customer environment. Another example of the resource-capability mapping framework is the variable mapping table disclosed herein.
Testing: The process of evaluating and verifying the functionality, performance, and reliability of software components, digital workflows, or systems within a software platform such as the IDMP/IDEP. Testing may include assessing various aspects such as quality assurance (QA), quality control (QC), usability, and end-to-end functionality of the platform, its components, or the digital tasks executed on it.
User intent: The goal, objective, or desired outcome that a user aims to achieve when interacting with the IDMP/IDEP. User intent may be expressed through various forms of input, such as user actions, natural language prompts, commands, or selections within the platform interface.
User actions: Specific interactions, inputs, or operations performed by a user within the IDMP/IDEP. User actions may include, but are not limited to, mouse clicks, keyboard inputs, voice commands, or any other form of interaction with the platform's interface or components.
Human-readable test scenarios: Descriptions of test cases or testing situations written in natural language that are easily understandable by human users or testers. These scenarios may outline the steps, conditions, and expected outcomes of a particular test. The test scenarios usually include a sequence of human-readable testing steps that are carried out on the software platform. In some embodiments, the testing steps are configured to evaluate the performance of the software platform in accomplishing the user intent. In other embodiments, they are configured to verify the ability of the software platform to accomplish the user intent.
Test script: A set of instructions, typically in the form of computer code or a structured sequence of commands, designed to automate the execution of a specific test scenario within the IDMP/IDEP. Test scripts may be generated based on human-readable test scenarios and may be used to perform automated testing of various platform components, digital workflows, or system functionalities.

### CONCLUSIONS

One of ordinary skill in the art knows that the use cases, structures, schematics, flow diagrams, and steps may be performed in any order or sub-combination, while the inventive concept of the present invention remains without departing from the broader scope of the invention. Every embodiment may be unique, and step(s) of method(s) may be either shortened or lengthened, overlapped with other activities, postponed, delayed, and/or continued after a time gap, such that every active user and running application program is accommodated by the server(s) to practice the methods of the present invention.

For simplicity of explanation, the embodiments of the methods of this disclosure are depicted and described as a series of acts or steps. However, acts or steps in accordance with this disclosure can occur in various orders and/or concurrently, and with other acts or steps not presented and described herein. Furthermore, not all illustrated acts or steps may be required to implement the methods in accordance with the disclosed subject matter. In addition, those skilled in the art will understand and appreciate that the methods could alternatively be represented as a series of interrelated states via a state diagram or events or their equivalent.

As used herein, the singular forms “a,” “an,” and “the” include plural references unless the context clearly indicates otherwise. Thus, for example, reference to “a cable” includes a single cable as well as a bundle of two or more different cables, and the like.

The terms “comprise,” “comprising,” “includes,” “including,” “have,” “having,” and the like, used in the specification and claims are meant to be open-ended and not restrictive, meaning “including but not limited to.”

In the foregoing description, numerous specific details are set forth, such as specific structures, dimensions, processes, parameters, etc., to provide a thorough understanding of the present invention. The particular features, structures, materials, or characteristics may be combined in any suitable manner in one or more embodiments. The words “example”, “exemplary”, “illustrative” and the like, are used herein to mean serving as an example, instance, or illustration. Any aspect or design described herein as “example”, or its equivalents, is not necessarily to be construed as preferred or advantageous over other aspects or designs. Rather, use of the words “example” or equivalents is intended to present concepts in a concrete fashion.

As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A, X includes B, or X includes both A and B, then “X includes A or B” is satisfied under any of the foregoing instances.

Reference throughout this specification to “an embodiment,” “certain embodiments,” or “one embodiment” means that a particular feature, structure, or characteristic described in connection with the embodiment is included in at least one embodiment. Thus, the appearances of the phrase “an embodiment,” “certain embodiments,” or “one embodiment” throughout this specification are not necessarily all referring to the same embodiment.

As used herein, the term “about” in connection with a measured quantity, refers to the normal variations in that measured quantity, as expected by one of ordinary skill in the art in making the measurement and exercising a level of care commensurate with the objective of measurement and the precision of the measuring equipment. For example, in some exemplary embodiments, the term “about” may include the recited number±10%, such that “about 10” would include from 9 to 11. In other exemplary embodiments, the term “about” may include the recited number±X %, where X is considered the normal variation in said measurement by one of ordinary skill in the art.

Features which are described in the context of separate embodiments may also be provided in combination in a single embodiment. Conversely, various features which are, for brevity, described in the context of a single embodiment, may also be provided separately or in any suitable sub-combination. The applicant hereby gives notice that new claims may be formulated to such features and/or combinations of such features during the prosecution of the present application or of any further application derived therefrom. Features of the transitory physical storage medium described may be incorporated into/used in a corresponding method, digital documentation system and/or system, and vice versa.

Although the present invention has been described with reference to specific exemplary embodiments, it will be evident that the various modifications and changes can be made to these embodiments without departing from the broader scope of the invention. Accordingly, the specification and drawings are to be regarded in an illustrative sense rather than in a restrictive sense. It will also be apparent to the skilled artisan that the embodiments described above are specific examples of a single broader invention which may have greater scope than any of the singular descriptions taught. There may be many alterations made in the descriptions without departing from the scope of the present invention, as defined by the claims.

What is claimed is:

1. A non-transitory storage medium storing program code executable by a hardware processor for artificial intelligence (AI) assisted testing of a software functionality related to a user intent, comprising program code to:
receive a user action data indicating the user intent related to a software platform,
wherein the user action data comprises a sequence of operations performed by a user on the software platform to achieve the user intent, wherein the user intent comprises an outcome desired by the user when the sequence of operations is performed on the software platform, and wherein the desired outcome is achieved based on linking two digital model representations;
generate a test scenario based on the user action data, using a scenario machine learning (ML) model,
wherein the test scenario comprises a sequence of human-readable testing steps and an expected outcome that are related to the user intent, wherein the sequence of human-readable testing steps are carried out on the software platform to evaluate a performance of the software platform in achieving the expected outcome, wherein at least one of the sequence of human-readable testing steps links the two digital mode representations,
wherein the scenario ML model was trained on a scenario training data set comprising a plurality of sample scenario pairs, wherein each scenario pair comprises sample user action data indicating a sample user intent, and a corresponding sample test scenario related to the sample user intent, and wherein the sample test scenario related to the sample user intent comprises linking two digital model representations;
generate a test script based on the test scenario using a script machine learning (ML) model,
wherein the test script, when interpreted on the software platform, implements at least one human-readable testing step of the sequence of human-readable testing steps,
wherein the script ML model was trained on a script training data set comprising a plurality of sample script pairs, wherein each sample script pair comprises a sample test scenario and a corresponding sample test script implementing the sample test scenario, and wherein each sample test scenario comprises a sequence of human-readable sample testing steps;
generate a test outcome related to the human-readable test scenario by interpreting the test script on an interpreter operatively connected to the software platform, wherein the interpreting the test script comprises interpreting the at least one human-readable testing step and causing an implementation of the at least one human-readable testing step on the software platform; and
generate a test report based on the test outcome and the expected outcome, wherein the test report is a human-readable report comprising an evaluation of the test scenario on the software platform from the at least one human-readable testing step.

2. The non-transitory storage medium of claim 1, wherein the software platform is an interconnected digital model platform (IDMP).

3. The non-transitory storage medium of claim 2, wherein the program code further comprises code to collect, on the IDMP, the user action data describing the user intent.

4. The non-transitory storage medium of claim 2, wherein the software functionality designated for testing is part of a software tool of the IDMP, and wherein the at least one testing step, when implemented, interacts with the software tool of the IDMP.

5. The non-transitory storage medium of claim 2, wherein the test script, when interpreted, generates a digital model representation.

6. The non-transitory storage medium of claim 5, wherein the at least one test step requires access to a digital artifact through the digital model representation, and wherein the test script accesses the digital artifact.

7. The non-transitory storage medium of claim 6, wherein the digital model representation comprises a model splice connected to a digital model file, wherein the model splice comprises one or more splice data items and a splice function to provide an Application Programming Interface (API) or Software Development Kit (SDK) endpoint to the digital model representation to access the digital artifact.

8. The non-transitory storage medium of claim 1, wherein the human-readable test scenario is selected from the group consisting of a quality assurance (QA) test scenario, a quality control (QC) test scenario, a usability test scenario, an end-to-end test scenario, a performance test scenario, and a security test scenario.

9. The non-transitory storage medium of claim 1, wherein the user action data comprises a usage workflow.

10. The non-transitory storage medium of claim 9, wherein the usage workflow comprises one of a model type file, an instruction, a test script, and a test report.

11. The non-transitory storage medium of claim 1, wherein the user action data is collected using a collection script generated by a collection ML model.

12. The non-transitory storage medium of claim 11, wherein the collection ML model is trained on a data set comprising sample software tools and corresponding sample collection scripts.

13. The non-transitory storage medium of claim 11, wherein the collection script is inserted into a system page of the software platform.

14. The non-transitory storage medium of claim 1, wherein the test scenario is a usability test scenario, and wherein the user action data comprises one of a bug report from the user, a troubleshooting step, a corrective action, and a final script used to rectify an issue.

15. The non-transitory storage medium of claim 14, wherein the user action data comprises one or more bug reports generated using a project management software tool.

16. The non-transitory storage medium of claim 1, wherein the scenario ML model is trained on a data set comprising sample prior bugs and corresponding sample human-readable test scenarios.

17. The non-transitory storage medium of claim 1, wherein the scenario ML model is trained on a data set comprising sample user bug reports and corresponding bug fixes generated using a project management software tool.

18. The non-transitory storage medium of claim 1, wherein the sequence of human-readable testing steps comprises a plurality of user actions.

19. A system for artificial intelligence (AI) assisted testing of a software functionality related to a user intent, comprising:
a hardware processor; and
a memory storing program code, the program code executable by the hardware processor, the program code comprising instructions to:
receive a user action data indicating the user intent related to a software platform,
wherein the user action data comprises a sequence of operations performed by a user on the software platform to achieve the user intent, wherein the user intent comprises an outcome desired by the user when the sequence of operations is performed on the software platform, and wherein the desired outcome is achieved based on linking two digital model representations;
generate a test scenario based on the user action data, using a scenario machine learning (ML) model,
wherein the test scenario comprises a sequence of human-readable testing steps and an expected outcome that are related to the user intent, wherein the sequence of human-readable testing steps are carried out on the software platform to evaluate a performance of the software platform in achieving the expected outcome, wherein at least one of the sequence of human-readable testing steps links the two digital mode representations,
wherein the scenario ML model was trained on a scenario training data set comprising a plurality of sample scenario pairs, wherein each scenario pair comprises sample user action data indicating a sample user intent, and a corresponding sample test scenario related to the sample user intent, and wherein the sample test scenario related to the sample user intent comprises linking two digital model representations;
generate a test script based on the test scenario using a script machine learning (ML) model,
wherein the test script, when interpreted on the software platform, implements at least one human-readable testing step of the sequence of human-readable testing steps,
wherein the script ML model was trained on a script training data set comprising a plurality of sample script pairs, wherein each sample script pair comprises a sample test scenario and a corresponding sample test script implementing the sample test scenario, and wherein each sample test scenario comprises a sequence of human-readable sample testing steps;
generate a test outcome related to the human-readable test scenario by interpreting the test script on an interpreter operatively connected to the software platform, wherein interpreting the test script comprises interpreting the at least one human-readable testing step and causing an implementation of the at least one human-readable testing step on the software platform; and
generate a test report based on the test outcome and the expected outcome, wherein the test report is a human-readable report comprising an evaluation of the test scenario on the software platform from the at least one human-readable testing step.

20. A computer-implemented method for artificial intelligence (AI) assisted testing of a software functionality related to a user intent, the method comprising:
receiving a user action data indicating the user intent related to a software platform,
wherein the user action data comprises a sequence of operations performed by a user on the software platform to achieve the user intent, wherein the user intent comprises an outcome desired by the user when the sequence of operations is performed on the software platform, and wherein the desired outcome is achieved based on linking two digital model representations;
generating a test scenario based on the user action data, using a scenario machine learning (ML) model,
wherein the test scenario comprises a sequence of human-readable testing steps and an expected outcome that are related to the user intent, wherein the sequence of human-readable testing steps are carried out on the software platform to evaluate a performance of the software platform in achieving the expected outcome, wherein at least one of the sequence of human-readable testing steps links the two digital mode representations,
wherein the scenario ML model was trained on a scenario training data set comprising a plurality of sample scenario pairs, wherein each scenario pair comprises sample user action data indicating a sample user intent, and a corresponding sample test scenario related to the sample user intent, and wherein the sample test scenario related to the sample user intent comprises linking two digital model representations;
generating a test script based on the test scenario using a script machine learning (ML) model,
wherein the test script, when interpreted on the software platform, implements at least one human-readable testing step of the sequence of human-readable testing steps,
wherein the script ML model was trained on a script training data set comprising a plurality of sample script pairs, wherein each sample script pair comprises a sample test scenario and a corresponding sample test script implementing the sample test scenario, and wherein each sample test scenario comprises a sequence of human-readable sample testing steps;
generating a test outcome related to the human-readable test scenario by interpreting the test script on an interpreter operatively connected to the software platform, wherein interpreting the test script comprises interpreting the at least one human-readable testing step and causing an implementation of the at least one human-readable testing step on the software platform; and
generating a test report based on the test outcome and the expected outcome, wherein the test report is a human-readable report comprising an evaluation of the test scenario on the software platform from the at least one human-readable testing step.
